(19) United States
(12) Patent Application Publication
(10) Pub. No.: US 2013/0260346 A1
(43) Pub. Date: Oct. 3, 2013

(54) INTERACTIVE LEARNING METHOD, APPARATUS, AND SYSTEM

(71) Applicants: Michael C. Wood, Ross, CA (US); Edward E. Annunziata, Montara, CA (US); Maria Callahan, Walnut Creek, CA (US)

(72) Inventors: Michael C. Wood, Ross, CA (US); Edward E. Annunziata, Montara, CA (US); Maria Callahan, Walnut Creek, CA (US)

(73) Assignee: Smarty Ants Inc.

(21) Appl. No.: 13/817,529

(22) PCT Filed: Dec. 29, 2010
(86) PCT No.: PCT/US10/62441

§ 371 Date: Jun. 17, 2013

Related U.S. Application Data
(60) Provisional application No. 61/375,792, filed on Aug. 20, 2010.
(60) Provisional application No. 61/375,795, filed on Aug. 20, 2010.

(51) Int. Cl. G09B 19/00

(52) U.S. Cl. CPC G09B 19/00
USPC 434/156

(57) ABSTRACT

A computer-implemented method of interactive learning, a system and a computer-readable medium therefor are disclosed. The computer include a processor, a memory, a storage device, a display device for displaying information to a user, an audio device for communicating audio information to the user, and an input device for receiving information and commands from the user. The computer provides an interactive learning environment. The method includes presenting a structured curriculum to a user via the display device. The structured curriculum includes a linear progression of educational topics divided into a plurality of levels. Each of the plurality of levels represents a specific topic of educational content. Each of the plurality of levels is further divided into the plurality of lessons. The method also includes presenting a lesson to the user via the display device in a current mode selected from a plurality of modes. Each of the plurality of lessons represents a sub portion of the specific topic of the educational content and each of the plurality of modes includes specific challenges to accomplish. The method further includes receiving feedback from the user via the input device in an interactive manner until a challenge associated with the current mode is accomplished and advancing to a subsequent mode when the challenge of the current mode is accomplished by the user.

### TECHNICAL FIELD

The present disclosure pertains to improvements in the arts of computer-implemented learning environments, namely an interactive method for learning using virtual activities, an optional interactive apparatus such as a plush appliance, as well as a system comprised thereof.

### BRIEF DESCRIPTION OF THE DRAWINGS

FIG. 1 is an illustration of a user using one aspect of a computer-implemented method for learning and a plush learning appliance coupled to the computer-implemented method.

FIG. 2 is an illustration of one embodiment of a plush learning appliance that may be employed in conjunction with one aspect of the computer-implemented method.

FIG. 3 is an illustration of a start screen according to one aspect of the computer-implemented method.

FIG. 4 is an illustration of an avatar selection screen according to one aspect of the computer-implemented method.

FIG. 5 is an illustration of an activities board screen according to one aspect of the computer-implemented method.

FIG. 6 is an illustration of an avatar home screen according to one aspect of the computer-implemented method.

FIG. 7 is an illustration of an avatar home screen with an inventory window according to one aspect of the computer-implemented method.

FIG. 8 is an illustration of a level selection screen of an activity according to one aspect of the computer-implemented method.

FIG. 9 is an illustration of a treadmill activity screen according to one aspect of the computer-implemented method.

FIG. 10 is an illustration of an achievement of an activity screen according to one aspect of the computer-implemented method.

FIG. 11 is an illustration of a climbing wall activity screen according to one aspect of the computer-implemented method.

FIG. 12 is an illustration of a swimming pool activity screen according to one aspect of the computer-implemented method.

FIG. 13 is an illustration of a playground activity screen according to one aspect of the computer-implemented method.

FIG. 14 is an illustration of a matching activity screen according to one aspect of the computer-implemented method.

FIG. 15 is an illustration of a letter trail activity screen according to one aspect of the computer-implemented method.

FIG. 16 is an illustration of an alternate letter trail activity screen according to one aspect of the computer-implemented method.

FIG. 17 is an illustration of a quest activity screen according to one aspect of the computer-implemented method.

FIG. 18 is an illustration of a recording studio screen according to one aspect of the computer-implemented method.

FIG. 19 is an illustration of a game show activity screen according to one aspect of the computer-implemented method.

FIG. 20 is an illustration of an alternate game show activity screen according to one aspect of the computer-implemented method.

FIG. 21 is an illustration of a dogtop computer activity screen according to one aspect of the computer-implemented method.

FIG. 22 is an illustration of a videobot activity screen according to one aspect of the computer-implemented method.

FIG. 23 is an illustration of an alternate videobot activity screen according to one aspect of the computer-implemented method.

FIG. 24 is an illustration of an alternate videobot activity screen according to one aspect of the computer-implemented method.

FIG. 25 is an illustration of a newspaper activity screen according to one aspect of the computer-implemented method.

FIG. 26 is an illustration of a shopping activity screen according to one aspect of the computer-implemented method.

FIG. 27 is an illustration of a trophy wall reward screen according to one aspect of the computer-implemented method.

FIG. 28 is an illustration of a debit card reward screen according to one aspect of the computer-implemented method.

FIG. 29 is a block diagram of a computer system upon which one aspect of the computer-implemented method may be implemented.

FIG. 30 is a diagram of a curriculum structure comprising a progression of educational topics grouped into numbered levels.

FIG. 31 is a diagram of a lesson comprising a plurality of modes.

### SUMMARY

A computer-implemented method of interactive learning, a system and computer-readable medium therefore. The computer comprises a processor, a memory, a storage device, a display device for displaying information to a user, an audio device for communicating audio information to the user, and an input device for receiving information and commands from the user. The computer provides an interactive learning environment. A structured curriculum is presented to a user via the display device. The structured curriculum comprises a linear progression of educational topics divided into a plurality of levels, wherein each of the plurality of levels represents a specific topic of educational content. Each of the plurality of levels is further divided into the plurality of lessons. A lesson is presented to the user via the display device in a current mode selected from a plurality of modes. Each of the plurality of lessons represents a sub portion of the specific topic of the educational content. Each of the plurality of modes comprises specific challenges to accomplish. Feedback is received from the user via the input device in an interactive manner until a challenge associated with the current mode is accomplished. The user is advanced to a subsequent mode when the challenge of the current mode is accomplished by the user.

### DESCRIPTION

In the following description, for the purposes of explanation, specific details are set forth in order to provide a thorough understanding of the various aspects of the computer-implemented method. It will be apparent, however, that other aspects of the computer-implemented method may be practiced without these specific details disclosed herein. In other instances, well-known structures and devices are depicted in block diagram form for conciseness and clarity and in order to avoid disclosing unnecessary details relating to the corresponding discussion; and similarly, the operation of the disclosed computer-implemented method are depicted in flow diagram form. Section titles and references appearing within the following paragraphs are intended for the convenience of the reader and not to restrict the scope of the information presented at any given location.

The unique learning experiences and learning enhancements described herein comprise a plurality of advancements within various scopes in the educational and technological arts. Accordingly, each of the respective groupings of advancements and enhancements are described in more detail hereinafter in the following sections: Functional Overview, Plush Appliance, Curriculum Structure (including Terminology and Description of Levels), Avatars & Characters, Peer Learning, Activity Board, Avatar Home, Virtual Activities To Learn Educational Content, Story Creation, Rewards, Fan Club, Computer Implementation, Instruction Methodology, and Conclusion.

### Functional Overview

In one aspect, a computer-implemented method for assisting a user in learning is provided. The user may be a child, adolescent, or an adult. Notwithstanding the present disclosure being directed primarily to a user having an age range of between 2 and 10 years of age, the various aspects of the computer-implemented method disclosed herein, the curriculum, activities, learning objectives, and presentation thereof, may be specifically tailored and adjusted for any particular age of the user. In addition, the user may represent any student or any human being of any gender, any ethnic background and any age that desires to utilize the disclosed computer-implemented interactive learning environment or other aspects thereof.

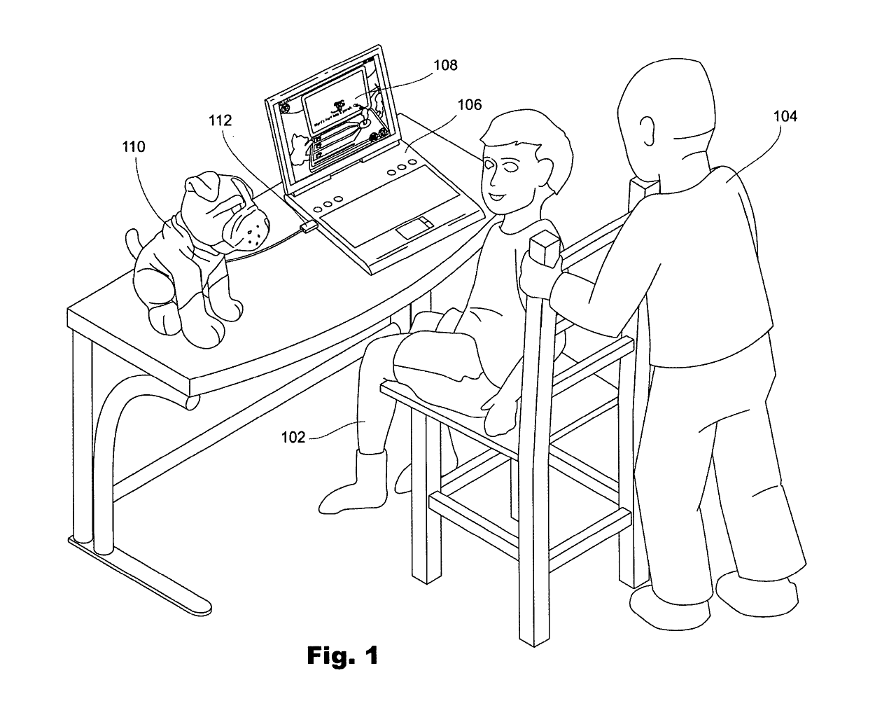

FIG. 1 is an illustration of a user using one aspect of a computer-implemented method for learning and a plush learning appliance coupled to the computer-implemented method. More particularly, a child 102 is being supervised by a parent 104, while using an application 108 according to an aspect of the computer-implemented method being executed by a computer 106.

Note that the child 102, as disclosed herein by way of example, can represent any student or any human being of any gender, any ethnic background and any age that desires to utilize the disclosed interactive learning environment or other aspects thereof. As disclosed herein, however, by way of example and not limitation, the child typically may be 2-10 years old, which is consistent with the age when a typical child learns to read a given language in a contemporary household.

Similarly, note that the parent 104, as disclosed herein by way of example, can represent any person or any human being of any gender, any ethnic background and any age that desires to supervise the user, e.g., the child 102, while using the disclosed interactive learning environment.

The computer 106 comprises a typical contemporary computer capable of allowing one or more specialized software applications, such as that contemplated by the present disclosure, to be loaded onto the computer via a machine-readable medium such as a removable medium (not shown) or a network (not shown, e.g., an Internet connection). Some aspects of the computer-implemented method may be implemented, for example, using a machine-readable medium or article which may store an instruction or a set of instructions that, if executed by a machine, such as the computer 106 for example, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium. storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The application 108 will be addressed in further detail in subsequent sections of this disclosure. At a top level, however, the application 108 is comprised of computer instructions designed to provide an interactive learning environment beyond the ordinary software or features offered by even the most sophisticated computer 106 available in the computer markets.

In one aspect, a plush appliance 110 in the likeness of a dog, as illustrated, is provided. The plush appliance 110 is intended as an enhancement to the interactive learning experience provided by the application 108, although the plush appliance 110 also can be utilized separately and apart from the application 108 and computer 106. By way of example, the plush appliance 110 may provide the ability to sing songs or recite stories to the child 102, while physically away from the computer 106 or alternatively while also using the application 108.

The plush appliance 110, preferably, further comprises a means to communicate 112 with the application 108, such as utilizing a conventional Universal Serial Bus (USB) connection as illustrated. Note that as anticipated by the present disclosure, the means to communicate 112 can be accommodated by either a hard wired connection (as illustrated) or a wireless technology (not shown, e.g. conventional Wi-Fi or Bluetooth), or both.

### Plush Appliance

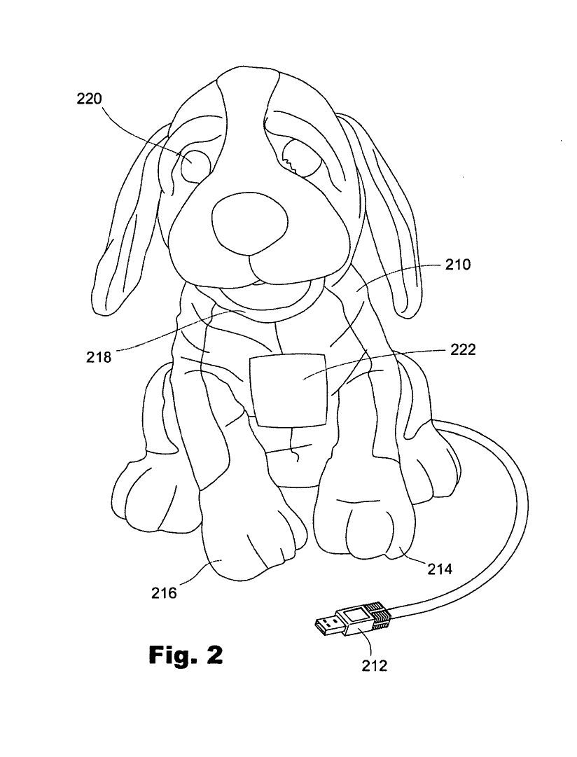

Turning to FIG. 2, a closer illustration of a plush learning appliance 210 according to one aspect of the computer-implemented method is provided. The plush appliance 210 may be implemented as an interactive toy that enhances the interactive learning experience of the child 102 by bringing to life the songs and stories typically provided by the application 108 from FIG. 1. For example, content developed by the child 102, such as stories and/or music videos, as described in more detail below, may be downloaded to the plush appliance 110. It is preferable that the plush appliance 210 have the capability of storing at least one story or at least one song for teaching a particular portion of educational content.

By way of example, the plush appliance 210 can store and recite a story comprising phoneme such as “at.” A first switch (not shown) located inside the plush appliance 210 paw (or other location as desirable) can control the initiation of certain features such as to initiate a first interactive learning session. In one aspect, the first interactive learning session comprises storytelling by the plush appliance 210. Thus, in the illustrated embodiment, by way of example, pushing a right paw 216 of the plush appliance 210 causes the plush appliance 210 to recite a story stored within the memory (not shown) of the plush appliance 210 that relates to the phoneme “at,” such as a story about a person named “Pat.”

Similarly, by way of example, a second switch (not shown) also may be configured to cause the plush appliance 210 to initiate a second interactive learning session. In one aspect, the second interactive learning session comprises singing a song by the plush appliance 210 directed to the corresponding phoneme “at.” Thus, by way of example, pushing a left paw 214 of the plush appliance 210 causes the plush appliance 210 to sing a song associated with the story of “Pat.”

Such stories and songs can be natively stored in the memory (not shown) located within the plush appliance 210 or loaded by a means of connection 212 (e.g., such as an external USB connection) from the computer 106. It is further anticipated by the present disclosure, that the plush appliance 210 also may utilize contemporary technologies relating to removable storage mediums (not shown, e.g., removable memory card) for stories or songs. A removable storage medium may be located on a chest 222 portion of the plush appliance 210 or any other convenient location on the plush appliance 210.

In one aspect, the plush appliance 210 may store at least one story, at least one song, or combinations thereof. In other aspects, the plush appliance 210 may recite at least one story, at least one song, or combinations thereof. Selection of the particular story or song desired can be accommodated by repeated pushing of the right paw 216 and the left paw 214, respectively.

To further enhance the realistic nature of the plush appliance 210 and the experience, it is preferable that certain physical features of the plush appliance 210 move or agitate in a manner similar to that of a real object represented by the plush appliance 210 (e.g., a real dog). Thus, as illustrated, it is preferable that the plush appliance 210 comprise a mouth 218 and a pair of eyes 220 that move as the plush appliance 210 recites a story or sings a song. Similarly, the left paw 214 and right paw 216, or other plush appliance parts (e.g., neck, legs) can be preferably configured to move in a predefined action.

In manufacturing and configuring the plush appliance 210, it is advisable to include certain pre-set phrases and actions that cannot be changed. It is further advisable that at least one story, at least one song, or combinations thereof, be permanently stored in the plush appliance 210 for demonstration purposes before new content is loaded onto it via the means of communication 212.

Our discussion will now turn to one aspect of a curriculum and content that can be utilized in conjunction with the application 108 of FIG. 1 and the plush appliance of FIG. 2.

### Curriculum Structure

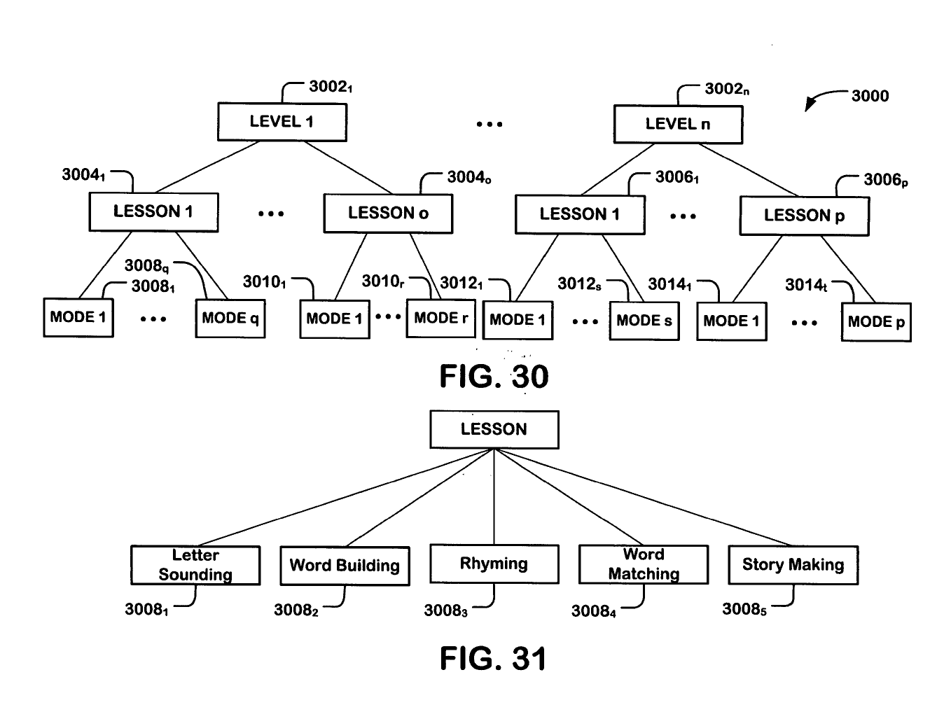

Turning now to FIG. 30, in one aspect, the computer-implemented method described herein provides an interactive learning environment with a curriculum structure 3000 comprising a progression of educational topics grouped into numbered levels 3002₁ to 3002ₙ. Each level 3002₁-3002ₙ may be further divided into a plurality of lessons 3004₁ to 3004ₒ, which are sub-topics of the level 3002₁, and a plurality of lessons 3006₁ to 3006ₚ, which are sub-topics of the level 3002ₙ. Although each level 3002₁-3002ₙ may comprise a unique lesson set, it will be appreciated that in some aspects, certain lessons may be duplicated from level to level, without limitation. Each lesson 3004₁-3004ₒ and 3006₁ to 3006ₚ may be further presented with a plurality of modes. In the diagram illustrated in FIG. 30, for example, lesson 3004₁ may comprise modes 3008₁-3008_{q} and lesson 3004ₒ may comprise modes 3010₁ to 3010ᵣ. Similarly, lesson 3006₁ may comprise modes 3012₁-3008ₛ and lesson 3006ₚ may comprise modes 3014₁ to 3014ₜ. It will be appreciated that suffixes n, o, p, q, r, s, and t are used to represent any positive integer. It will be further appreciated that a particular level 3002₁ may include at least one lesson 3004₁ and that lesson 3004₁ may include at least one mode 3008₁. In one aspect, a particular combination of a level-lesson-mode, may enable at least one module. These modules provide certain functionality that assist in the learning process and may include, without limitation, assessment modules based on predetermined assumptions of the level of knowledge of the user, building modules, compilation modules, and miscellaneous modules. These modules and certain levels 3002₁-3002ₙ, lessons 3004₁-3004ₒ and 3006₁-3006ₚ, and modes 3008₁-3008_{q}, 3010₁-3010ᵣ, 3012₁-3012ₛ, and 3014₁-3014ₜ will now be described in the context of one aspect of a computer-implemented method directed to learning a language, such as the English language, for example.

In one aspect, the computer-implemented method described herein may be directed to learning a language, such as the English language, for example. In the context of learning a language, the following terminology is provided for clarity of disclosure. It is to be understood, however, that such terminology is not intended to limit the scope of the appended claims in any manner.

### TERMINOLOGY

“Level” refers to one of eleven main steps in teaching reading (each “level” may include three levels of difficulty).

“Lesson” refers to a particular subject matter to be taught in a given sitting.

“Mode” refers to a particular activity that may be engaged in teaching reading, for example, letter sounding, word building, rhyming, word matching, story making.

“Module” refers to one of 11 learning modules, four common to all levels across top of selectable modules. All lessons may be learned in a single module.

“Story” refers to one of 67 compilations of words incorporated into one aspect of the computer-implemented method. What stories are available depend on the level.

“Phoneme” refers to one of a small set of speech sounds that are distinguished by the speakers of a particular language; in a language or dialect, a phoneme (“a sound uttered”) is the smallest segmental unit of sound employed to form meaningful contrasts between utterances.

“Vowel” and “vowel sounds” refers to the vowels a, e, i, o, u and the associated sounds.

“Vowel/consonant” refers to words containing a vowel grouped with a consonant such as cu, ce, for example.

“Consonant/vowel” refers to words containing a consonant grouped with a vowel such as cu, ce, for example.

“Consonant/vowel/consonant” refers to words containing a vowel between two consonants such as cat, beg, dig, cog, mud, for example.

“Consonant blends” refers to words containing two or three consonants grouped together with no intervening vowels where each sound is retained (heard) and produce a blended sound such as br, st, cr, for example.

“Consonant digraphs” refers to two or more consonants grouped together in which the consonants produce one sound such as sh, ch, ph, tch (new sound not expected from combination of letters), for example.

“r-controlled vowels” refers to words containing an r following a vowel, such as ar, or, ir, er, for example.

“Letter combination endings” refers to word endings such as ing, onk, and alternate c and g sounds, for example.

“Complex vowels” refers to vowels grouped together such as ee in feet, ai in rain, oa in boat, for example.

“Polysyllabic words” refers to words having multiple syllables such as cupcake, for example.

“Suffixes” refers to word endings such as ed, for example.

“Prefixes” refers to word such as un, re, dis, for example.

“Contractions” and “possessives” refers to words such as can't, won't, Ed's, Mike's, for example.

In one aspect, the interactive learning computer-implemented method (interactive learning environment) disclosed herein provides multiple educational levels, where each level is directed to a particular topic of educational content. A level may constitute at least one main concept as well as additional concepts. In the context of learning a language, the initial levels (e.g., first and second) may be directed to learning the alphabet associated with the language. A first level may be directed to learning the consonants associated with the language whereas the second level may be directed to learning the vowels associated with the language. Subsequent numeric levels, by way of example, may be directed to learning specific groupings of letters (e.g., consonants and vowels), their associated phonemes (e.g., the sounds made by the specific groupings of letters), and how to form certain words based on the specific groupings of letters and associated phonemes. In one aspect, the interactive learning environment incorporates a version of educational theory known loosely as “whole language” that provide the child with awareness of phonetics and also surrounds the child with beautiful literature so kids listen for plot, theme, and in the process the child learns to appreciate what good literature sounds like.

In general, each of the levels following the very basic levels provide an interactive manner for story building using the words learned in a particular level. For example, at the story building levels, the interactive learning environment introduces phonemes that are necessary for the interactive story building activity. Once the phonemes are introduced, words using the specific phonemes are introduced for the child to learn. Rhyme endings with words that the child learned are then introduced for reinforcing the learning process. Once the child has learned the words associated with a particular level, the child then builds a story using the words learned. The interactive learning environment guides the child to select various words to build a pre-programmed story. Once the story is built, the story may be published as a virtual book, printed, and/or converted to a music video for sing along.

The stories may be downloaded to the plush appliance. The plush appliance can recite the story for the child or can sing the story. The stories downloaded to the plush appliance include songs about words that are the object of the lessons in the story.

Although not mandatory for all contexts that are anticipated by the present disclosure, in accordance with various aspects of the interactive learning environment disclosed herein, it is preferable that a user, such as a child, complete a current level before advancing to the next level. Again, by way of example, before proceeding to learning the vowels of the alphabet, a child would complete the level associated with learning the consonants of the alphabet. Similarly, before proceeding to more complex levels such as learning phonemes or words as discussed in further detail below, the child would complete previous relatively easier levels. Each level generally requires learning predetermined letter sounds or phonemes, all words associated with the phonemes, and creating a story that is selected from a predetermined set of stories based on the words learned at a particular level. Throughout the specification, the terms “story” and “book” may be used interchangeably in the context of creating a story while at a particular level based on the phonemes and words learned at that level. In general, a book may be created once a story is completed.

Preferably, each level is further divided into a plurality of lessons, which are sub topics of the level. By way of example, two lessons derived from a first level addressing the English alphabet would be a first lesson directed to learning uppercase letters, followed by a second lesson directed to learning lowercase letters. Structuring the educational content in a linear progression as described typically results in increased focus and quicker learning for a given content.

In one aspect, it is further preferable to provide that a story is composed of the content of the sub topic learned in the lesson (e.g., words learned in the lesson). Such a story typically has a closed set of words and a child merely needs to arrange the words in a sequence so that a story makes sense. Such a story can be created using a story making or story building activity, which is further described later in the disclosure.

In one aspect, it also is preferable to provide that a song can be composed of the content of the sub topic learned in the lesson (e.g., words learned in the lesson). Such a song typically has pre-defined music and a child merely needs to arrange the words in a sequence so that a song can be sung either on the computer or on a plush appliance. Such a song can be created using a recording studio activity, which is further described later in the present disclosure. Ultimately, it is a goal for the child to be capable of reading the newly created story and singing (or at least understanding) the newly created song.

By way of example, educational content structured for learning the English language can be accommodated in approximately eight logical levels (e.g., story building levels), with each level having a varying number of lessons depending upon the topic presented, (e.g., consonant-vowel-consonant (CVC) words, or r-controlled vowels), as described in further detail below. Once a child completes all lessons within a given level, the child is ready to proceed to the next level.

As shown in FIG. 31, it is further preferable that each lesson 3004₁ be presented with a plurality of modes 3008₁-3008_{q}. As shown in FIG. 31 by way of example, for educational content directed to learning the English language, each lesson associated with each level may comprise at least one mode selected from the following five modes, namely: (i) learning the phonemes of the lesson (e.g., letter sounding 3008₁), (ii) building words using the phonemes of the lesson (e.g., word building 3008₂), (iii) rhyming the words built in (ii) and other words having the phonemes of the lesson (e.g., rhyming 3008₃), (iv) identifying by sight words containing the phonemes of the lesson (e.g., word matching 3008₄), and (v) building a story using the words learned in the lesson (e.g., story making 3008₅). As it can be appreciated, each mode builds upon the previous mode of the lesson. Accordingly, each mode should be completed before the next mode is attempted. In the present example, there is a strong focus to learn a phoneme and a set of words associated with the phoneme, then build upon that foundation to rhyme the words and ultimately identify them so they can be read by the child.

Each mode can have its own set of appropriate themes, storylines and content to make the interactive learning environment interesting. Once all modes of the lesson are completed, a player is invited to create the story and create the song for the lesson. Once the story and song are created, the player proceeds to the next lesson. Once all stories and songs within a level are created, the player proceeds to the next level.

In order that the interactive environment is age appropriate and interesting to the child, it is recommended that various approaches and activities be configured to accommodate the progression of modes and presentation of educational content. Various aspects of the present disclosure preferably utilize virtual (e.g., on computer screen) activities that are engaging and interactive, therein containing lesson appropriate material. For example, rather than teaching children with conventional textual narrative or audible instruction, the child participates in various engaging activities on the computer screen such as: scaling a climbing wall, running on a treadmill, diving into a swimming pool or other physical activities to collect the requested letters. Such activities, while virtual on a computer, nonetheless create a more active approach to learning letters and words than presentation of the alphabet and sight words. Other activities can be utilized for presentation of the educational content where there is a perception by the child that peers also are participating with the child in learning the educational content. The activities summarily identified above will be detailed further in the disclosure below.

Educational content that has been completed by a child will no longer be presented to the child as the primary portion of regular progression, but it is recommended to still be presented in future story building phases. Thus a child will be asked to re-identify the educational content in a different activity or context. Repeating the gist of a lesson in a latter level or lesson thus serves as both reinforcement and a metric of retention of the learning process.

For clarity of disclosure, eleven educational levels associated with one aspect of the interactive learning environment will now be described in the context of learning the English language by a child. Nevertheless, as previously discussed, the interactive learning environment may be modified for the purpose of teaching any language to any age user, without limitation. Each level is directed to a particular topic of educational content and is cumulative in the sense that the levels may increase in difficulty and require the completion of a previous level.

### Description of Levels

### Level 1

According to one aspect, the particular topic of educational content associated with Level 1 is consonants. Accordingly, the interactive learning environment provides a method for learning all simple consonants: b c d f g h j k l m n p r s t v w x y z. Once all simple consonants are learned at this level (e.g., Level 1), the child may advance to the next level (e.g., Level 2).

### Level 2

According to one aspect, the particular topic of educational content associated with Level 2 is short vowels. Accordingly, the interactive learning environment provides a method for learning all short vowels: a e i o u. Once all short vowels are learned at this level (e.g., Level 2), the child may advance to the next level (e.g., Level 3).

### Level 3

According to one aspect, the particular topic of educational content associated with Level 3 is regular three letter words having the form consonant-short vowel-consonant (CVC). Accordingly, the interactive learning environment provides a method for learning all regular three letter words having the form CVC. In accordance with the present disclosure, phonemes associated with the vowels and words having the form CVC may be introduced in a predetermined order. For example, in one aspect, the short vowels may be introduced in the following order: /a/, /i/, /o/, /e/, /u/.

After the introduction of a short vowel and its associated phoneme, all regular words associated with the vowel having the form CVC may be introduced to the child. As discussed in more detail below in connection with the lessons and modes portion of the interactive learning environment, activities such as rhyming, among others, may be employed as part of the learning process to reinforce a particular vowel or word.

In one aspect, after the introduction of least two vowels, e.g., /a/ and /i/, the interactive learning environment may introduce words having the form CVC for both vowels. The words associated with each vowel are then repeated for reinforcing the learning process.

By way of example, after the introduction of the short vowel /a/ and its phoneme, a plurality of three letter words having the form CVC “consonant-/a/-consonant,” where the short vowel /a/ is always located between the consonants and is introduced to the child phonetically according to the techniques described herein.

All regular CVC words containing the short vowel /a/ located between two consonants (C-/a/-C), such as, cam, can, cap, and so on, are presented to the child. When the child learns all the words having the form C-/a/-C, the child may advance to the next vowel, its associated phoneme, and words. In accordance with the present example, the next vowel presented would be the short vowel /i/ and its associated phoneme. All words having the form C-/b/-C, such as dig, dim, din, and so on, are presented to the child for learning. As the child progresses and learns all the three letter words associated with the short vowels /a/ and /i/, in one aspect, the interactive learning environment may present all the words from both the /a/ and /i/ vowel groups to reinforce learning. In another aspect, a subset of the words from both the /a/ and /i/ vowel groups is presented to the child. This process is repeated in a progressive manner until all short vowels, associated phonemes, and words are learned by the child in this segment.

As discussed in more detail below in connection with the lessons and mode associated with Level 1, activities such as rhyming, among others, may be employed as part of the learning process. The rhyming process includes presenting the two letter endings of the words learned as part of Level 1 such that the child can repeat them. The two letter endings for rhyming may include words ending in an, ig, ob, ed, ub, among others, for example.

Level 3 provides additional interactive learning techniques to assist the child in the learning process. For example, the child may engage in interactive activities such as letter sounding, word building, rhyming, word matching, and story building associated with the short vowels /a/, /e/, /i/, /o/, /u/ and all the three letter CVC words associated with each vowel.

Additional Level 3 topics of educational content may include, for example, learning words having an “s” at the end of a word such as cams, cans, caps, digs, dims, dins, among others, for example. Additional concepts also may include learning words ending in the double consonants ff, ll, ss, zz, tt such as buff, fell, mess, buzz, putt, among others, for example.

Story building is an activity in which the interactive learning environment assists the child in creating one or more stories, that are selected from a predetermined number of stories (e.g., 67 in one aspect), using just the words learned in Level 3. The child may be required to build one or multiple stories prior to advancing to the next level. In one aspect, the child may be required to build up to 18 stories or books before completing Level 3 and advancing to Level 4

### Level 4

According to one aspect, the particular topic of educational content associated with Level 4 is regular four letter words having the form consonant-short vowel-consonant (CVC) ending with an “e” (CVCe). To participate at Level 4, the child requires knowledge of the simple consonants: b c d f g h j k l m n p r s t v w x y z; and short vowels: a e i o u previously learned at Levels 1 and 2 and completed Level 3. Additional Level 4 concepts may include learning words having the form CVCe in a particular order of phoneme introduction and generating books (or stories) based on the words learned at this level.

In one aspect, the order of CVCe phoneme introduction may be employed, without limitation, as shown below, where the numbers 1-5 represent the order of introduction and the “_” represents the missing consonant that would be used to make up particular words having the specified form. In one example, the CVCe phonemes may be introduced based on the particular vowel located between the consonants in the word.

1. _a_e

2. _i_e

3. _o_e

4. _u_e

5. _e_e

The interactive learning environment provides techniques for learning all regular CVCe words according to a predetermined order of phoneme introduction. According to one example, the CVCe words and associated phonemes of all regular four letter words containing _a_e , _i_e, _o_e, _u_e, _e_e may be introduced in the following order:

1. _a_e (e.g., bade, bake, bale);

2. _i_e (e.g., bide, bike, bile);

3. _o_e (e.g., bode, bone, bore);

4. _u_e (e.g., Duke, dune, dupe);

5. _e_e (e.g., here, meme, mere);

It will be appreciated that the list of words having the form CVCe is not an exhaustive list and is provided merely as a representative sample of such words.

As previously discussed, the interactive learning environment provides rhyming activities including words ending in: -abe, -ide, -ode, -uke, -ere, among others, to reinforce learning of the words being learned in Level 4. The rhymes may be presented to the child in the following order:

1. _a_e (e.g., -ade, -ake, -bale);

2. _i_e (e.g., -ide, -ike, -ile);

3. _o_e (e.g., -ode, -one, -ore);

4. _u_e (e.g., -uke, -une, -upe);

5. _e_e (e.g., -ere, -eme, -ere);

It will be appreciated that the list of rhyming words having the form CVCe is not an exhaustive list and is provided merely as a representative sample of such words.

Other topics of educational content associated with Level 4 may include, for example, learning all the four letter CVCe words containing each of the short vowels /a/, /e/, /i/, /o/, /u/ and ending in “e” using techniques such as letter sounding, word building, rhyming, word matching, and story building associated with particular interactive activities provided by the lessons and modes aspects of the computer-implemented interactive learning environment described herein. When the child has learned the entire group of four letter CVCe words, the interactive learning environment assists the child in building one or more stories selected from a predetermined number of stories (e.g., 67 in one aspect) using just the words learned in Level 4. In one aspect, the child may be required to build up to eight stories or books before completing Level 4 and advancing to Level 5.

### Level 5

According to one aspect, the particular topic of educational content associated with Level 5 is words with consonant blends, which refers to words containing two or three consonants grouped together with no intervening vowels where each sound is retained (heard) and produce a blended sound. In one aspect, a strategy for words with consonant blends includes introducing and learning all words beginning with consonant blends, then introducing and learning all words ending in consonant blends, and finally introducing and learning all words beginning and ending in consonant blends.

According to one aspect, the interactive process first provides all regular words beginning with consonant blends having the form CVC to be learned by the child in this segment. This group of CVC words may include words beginning with br-, cr-, dr-, bl-, cl-, fl-, tw-, sc-, sk-, scr-, squ-, among others, for example. In another aspect, optionally, the interactive process provides all regular words beginning with consonant blends having the form CVCe for the child to learn.

The interactive learning environment then provides all regular words ending with consonant blends having the form CVC to be learned by the child in this segment. This group of CVC words may include words ending with -ct, -ld, -mp, -nd, -st, among others, for example.

Finally, the interactive learning environment provides all regular words beginning and ending with consonant blends having the form CCVCC to be learned by the child in this segment. This group of words may include words such as brand, brisk, craft, flint, stump, among others, for example.

At the completion of each of the above steps, the child may be required to build a story or book using the words learned during that step of the process. For example, at the end of the first step, the child may be required to build a story using the regular words beginning with consonant blends having the form CVC and/or, optionally, having the form CVCe. At the end of the second step, the child may be required to build a story using the regular words ending with consonant blends having the form CVC. Finally, at the end of the third step, the child may be required to build [symbol] having the form CCVCC. Accordingly, in one aspect, the child may be required to build up to three stories or books before completing Level 5 and advancing to Level 6.

### Level 6

According to one aspect, the particular topic of educational content associated with Level 6 is words with consonant digraph blends using a predetermined order of phoneme introduction and rules about when to use -ck, -dge, -tch, for example. As previously discussed, a consonant digraph refers to two or more consonants grouped together in which the consonants produce one sound such as sh, ch, ph, th, ch (new sound not expected from combination of letters), for example. It will be appreciated that the list of words formed using the consonant digraphs blends: sh, ch, th, wh, ph, -ck, -tch, and -dge provided in the description of Level 6 is not an exhaustive list and is provided merely as a representative sample of such words.

In one aspect, the interactive learning environment provides techniques for learning words containing consonant digraphs, where the phonemes may be introduced according to a predetermined order.
1. sh (e.g., bash, cash, shift, shrink);
2. ch (e.g., chap, chat, bunch, rich);
3. th (e.g., voiced as in “this” than, that, bathe, lathe); (e.g., unvoiced as in “think” thin, thud, moth, path);
4. wh (e.g., when, whim, while, which);
5. ph (e.g., phase, phone, graph, staph);
6. -ck (e.g., dock, hack, check, shock);
7. -tch (e.g., catch, ditch, fetch, scratch); and
8. -dge (e.g., budge, fudge, wedge, pledge).

The “sh” consonant digraph words are provided to the user by the interactive learning environment for story building using the words with the “sh” consonant digraph learned by the child in this segment.

1. All regular CVC words with any consonant blends at the beginning and end of words;

2. All regular CVCe words with any consonant blends;

3. All regular “sh” words;

4. Rhymes;

5. Story building using the above words.

The “ch” consonant digraph words are provided to the user by the interactive learning environment for story building using the “ch” consonant digraph words learned by the child in this segment.

1. All regular CVC words with any consonant blends at the beginning and at the end of words;

2. All regular CVCe words with any consonant blends;

3. All regular “sh” words with any consonant blends;

4. All regular “ch” words with any consonant blends;

5. Rhymes;

6. Story building using the above words.

The “th” consonant digraph words are provided to the user by the interactive learning environment for story building using the “th” consonant digraph words learned by the child in this segment.

1. All regular CVC words with any consonant blends at the beginning and end of words;

2. All regular CVCe words with any consonant blends;

3. All regular “sh” words with any consonant blends;

4. All regular “ch” words with any consonant blends;

5. All regular “th” words with any consonant blends;

6. Rhymes;

7. Story building using the above words.

The “wh” consonant digraph words are provided to the user for story building using the “wh” consonant digraph words learned by the child in this segment.

1. All regular CVC words with any consonant blends at the beginning and end of words;

2. All regular CVCe words with any consonant blends;

3. All regular “sh” words with any consonant blends;

4. All regular “ch” words with any consonant blends;

5. All regular “th” words with any consonant blends;

6. All regular “wh” words with any consonant blends;

7. Rhymes;

8. Story building using the above words.

The “ph” consonant digraph words are provided to the user by the interactive learning environment for story building using the “ph” consonant digraph words learned by the child in this segment.

1. All regular CVC words with any consonant blends at the beginning and end of words;

2. All regular CVCe words with any consonant blends;

3. All regular “sh” words with any consonant blends;

4. All regular “ch” words with any consonant blends;

5. All regular “th” words with any consonant blends;

6. All regular “wh” words with any consonant blends;

7. All regular “ph” words with any consonant blends;

8. Rhymes;

9. Story building using the above words.

The “-ck” consonant digraph words are provided to the user by the interactive learning environment for story building using the “-ck” consonant digraph words learned by the child in this segment.

1. All regular CVC words with any consonant blends at the beginning and end of words;

2. All regular “sh” words;

3. All regular “ch” words;

4. All regular “th” words;

5. All regular “wh” words;

6. All regular “ph” words;

7. All regular “-ck” words with any consonant blends;

8. Rhymes;

9. Story building using the above words.

The “-tch” consonant digraph words are provided to the user by the interactive learning environment for story building using the “-tch” consonant digraph words learned by the child in this segment.

1. All regular CVC words with any consonant blends at the beginning and end of words;

2. All regular “sh” words;

3. All regular “ch” words;

4. All regular “th” words;

5. All regular “wh” words;

6. All regular “ph” words;

7. All regular “-ck” words;

8. All regular “-tch” words with any consonant blends;

9. Rhymes;

10.

[symbol]

The “-dge” consonant digraph words are provided to the user by the interactive learning environment for story building using the “-dge” consonant digraph words learned by the child in this segment.

1. All regular CVC words with any consonant blends at the beginning and end of words;

2. All regular “sh” words;

3. All regular “ch” words;

4. All regular “th” words;

5. All regular “wh” words;

6. All regular “ph” words;

7. All regular “-ck” words;

8. All regular “-tch” words;

9. All regular “-tch” words with any consonant blends;

10. Rhymes;

11. Story building using the above words.

The level culminates in the child building up to eight stories or books before advancing to Level 7.

### Level 7

According to one aspect, the particular topic of educational content associated with Level 7 is r-controlled vowels, which refers to words containing an r following a vowel, such as ar, or, ir, er, for example. The vowel /y/ in one syllable words also is introduced as an additional concept. It will be appreciated that the list of words formed using the r-controlled vowels: ar, or, ir, er provided in the description of Level 7 is not an exhaustive list and is provided merely as a representative sample of such words.

In one aspect, the interactive learning environment provides techniques for learning words containing r-controlled vowels where the phonemes associated with the r-controlled vowels may be introduced according to a predetermined order and where the last three (ir, er, ur) are introduced together.

1. ar

2. or

3. er

4. ir

5. ur

The “ar” r-controlled vowel words are provided to the user by the interactive learning environment for story building using the r-controlled vowel words learned by the child in this segment.

1. Any consonant blends at the beginning and end of words;

2. The consonant digraphs (sh, ch, th, wh, ph);

3. Single-syllable, open-syllable words with vowel /y/ (by, cry, dry, fly);

4. New phonemes (second sounds for c, g, s)
For the letter c: /s/ as in city;
For the letter g: /j/ as in gem;
For the letter s: /z/ as in has;

5. All regular “ar” words (e.g., bar, bark, card, chart);

6. Rhymes.

7. Story building using the above words.

The “or” r-controlled vowel words are provided to the user by the interactive learning environment for story building using r-controlled vowel words learned by the child in this segment.

1. Any consonant blends at the beginning and end of words;

2. The consonant digraphs (sh, ch, th, wh, ph);

3. Single-syllable, open-syllable words with vowel /y/ (by, cry, dry, fly);

4. New phonemes (second sounds for c, g, s)
For the letter c: /s/ as in city;
For the letter g: /j/ as in gem;
For the letter s: /z/ as in has;

5. All regular “ar” words;

6. All regular “or” words (e.g., born, cord, corn, dork);

7. Rhymes.

8. Story building using the above words.

The “er” “ir” “ur” r-controlled vowel words are provided to the user by the interactive learning environment for story building using the r-controlled vowel words learned by the child in this segment.

1. Any consonant blends at the beginning and end of words;

2. The consonant digraphs (sh, ch, th, wh, ph);

3. Single-syllable, open-syllable words with vowel /y/: by, cry, dry, fly;

4. New phonemes (second sounds for c, g, s)
For the letter c: /s/ as in city;
For the letter g: /j/ as in gem;
For the letter s: /z/ as in has;

5. All regular “ar” words;

6. All regular “or” words;

7. All regular “er” words (e.g., berg, berm, fern, herb);

8. All regular “ir” words (e.g., dirt, firm, fir, stir);

9. All regular “ur” words (e.g., fur, blur, slur, burn);

10. Rhymes.

11. Story building using the above words.

This level culminates in the child building up to three stories or books before advancing to Level 8.

### Level 8

According to one aspect, the particular topic of educational content associated with Level 8 is (1) letter combinations ing, ang, ong, ung; (2) letter combinations ink, ank, onk, unk; (3) alternate sound of c; and (4) alternate sound of g. It will be appreciated that the list of words formed using the letter combinations and alternate sounds provided in the description of Level 8 is not an exhaustive list and is provided merely as a representative sample of such words.

In one aspect, the interactive learning environment provides techniques for learning words containing the letter combinations and alternate sounds, where the associated phonemes may be introduced according to a predetermined order.

1. “ing, ang, ong, ung” (e.g., bing, bang, bong, hung);

2. “ink, ank, onk, unk” (e.g., fink, bank, bonk, bunk);

3. “Alternate sound for c” (e.g., cell, cent, cinch, face);

4. “Alternate sound for g” (e.g., gem, age, cage, forge);

5. Rhymes.

The process culminates in building a story using the words learned for each of the (1) letter combinations ing, ang, ong, ung; (2) letter combinations ink, ank, onk, unk; (3) alternate sound of c; and (4) alternate sound of g. Accordingly, the child may be required to build up to four stories or books before advancing to Level 9.

### Level 9

According to one aspect, the particular topic of educational content associated with Level 9 is complex vowels. Additional concepts associated with Level 9 include (1) the concept that “ay” is the most common way to make the long sound of /a/ at the end of a syllable word (e.g., day, hay, say); (2) the concept that “oy” is the most common way to make the /oi/ sound at the end of a one-syllable word (e.g., boy, toy, ploy); (3) the concept that “ea” has one sound when used in words such as “meat” and another sound when used in words such as “breath,” “lead,” “dead.” It will be appreciated that the list of words formed using the complex vowels and additional concepts provided in the description of Level 9 is not an exhaustive list and is provided merely as a representative sample of such words.

In one aspect, the interactive learning environment provides techniques for learning words containing the letter combinations and alternate sounds, where the associated phonemes may be introduced according to a predetermined order.

1. ee as in feet;

2. ea as in eat;

3. ai as in rain;

4. ay as in day;

5. oa as in boat;

6. ou as in ouch;

7. oo as in moon;

8. oo as in book;

9. of as in coin;

10. oy as in boy;

11. ow as in cow;

12. ow as in low.

The “ee” complex vowel words are provided to the user by the interactive learning environment for story building using the complex vowel words learned by the child in this segment.

All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words (e.g., beef, beep, sheen, breed);

6. Rhymes.

7. Story building using the above words.

The “ea” complex vowel words are provided to the user by the interactive learning environment for story building using the complex vowel words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words (e.g., beak, bean, shear, dream);

7. Rhymes.

8. Story building using the above words.

The “ai” complex vowel words are provided to the user by the interactive learning environment for story building using the complex vowel words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words (e.g., bay, day, gay, hay);

9. Rhymes.

10. Story building using the above words.

The “oa” complex vowel words are provided to the user by the interactive learning environment for story building using the complex vowel words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words (e.g., oat, oak, loaf, throat);

10. Rhymes.

11. Story building using the above words.

The “ou” complex vowel words are provided to the user by the interactive learning environment for story building using the complex vowel words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words (e.g., our, out, bout, loud);

11. Rhymes.

12. Story building using the above words.

The “oo” complex vowel words for two sounds, as in moon and as in book, are provided to the user by the interactive learning environment for story building using the complex vowel words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” words as in moon (e.g., boom, boot, cool, food);

12. All regular “oo” words as in book (cook, foot, good, look);

13. Rhymes.

14. Story building using the above words.

The “oi” complex vowel words are provided to the user by the interactive learning environment for story building using the complex vowel words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” (words as in moon);

12. All regular “oo” (words as in book);

13. All regular “oi” words (e.g., boil, oil, coil, coin);

14. Rhymes.

15. Story building using the above words.

The “oy” complex vowel words are provided to the user by the interactive learning environment for story building using the complex vowel words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” (words as in moon);

12. All regular “oo” (words as in book);

13. All regular “oi” words;

14. All regular “oy” words (e.g., boy, joy, soy, toy);

15. Rhymes.

16. Story building using the above words.

The “ow” complex vowel words for two sounds, as in cow and as in tow, are provided to the user by the interactive learning environment for story building using the words complex vowels learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” (words as in moon);

12. All regular “oo” (words as in book);

13. All regular “oi” words;

14. All regular “oy” words;

15. All regular “ow” words as in cow (e.g., bow, down, fowl, town);

16. All regular “ow” words as in tow (e.g., bow, low, mow, sown);

17. Rhymes.

18. Story building using the above words.

The process culminates in building a story using the complex vowel words learned in this level. Accordingly, the child may be required to build up to 12 stories or books before advancing to Level 10.

### Level 10

According to one aspect, the particular topic of educational content associated with Level 10 is polysyllabic words. Additional concepts associated with Level 10 include:

1. Compound words;

2. Suffixes (e.g., -ed, -ing, -ful);

3. Rules for adding suffixes that begin with a vowel (CVCe words, e.g., shake to shaking; CVC words, e.g., tap to tapping);

4. Prefixes (e.g., un-, re-, dis-);

5. Vowel “y” in polysyllabic words (e.g., candy);

6. Consonant “-le” vowels (e.g., -ple, -dle, -fle).

It will be appreciated that the list of words formed using the complex vowels and additional concepts provided in the description of Level 10 is not an exhaustive list and is provided merely as a representative sample of such words.

The compound words are provided to the user by the interactive learning environment for story building using the compound words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” (words as in moon);

12. All regular compound words (e.g., lifetime, fireworks, railroad, schoolhouse);

13. Story building using the above words.

Words having a suffix -ed/-ing form are provided to the user by the interactive learning environment for story building using the suffix -ed/-ing words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” (words as in moon);

12. All regular compound words;

13. All words previously introduced that can take the form of suffix -ed/-ing;

14. Story building using the above words.

Words having a suffix -es/-s form are provided to the user by the interactive learning environment for story building using the suffix -es/-s words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” (words as in moon);

12. All regular compound words;

13. All words previously introduced that can take the form of suffix -ed/-ing;

14. All words previously introduced that can take the form of suffix -es/-s;

15. Story building using the above words.

Words having a suffix -er/-est form are provided to the user by the interactive learning environment for story building using the suffix -er/-est words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” (words as in moon);

12. All regular compound words;

13. All words previously introduced that can take the form of suffix -ed/-ing;

14. All words previously introduced that can take the form of suffix -es/-s;

15. All words previously introduced that can take the form of suffix -er/-est;

16. Story building using the above words.

Words having a suffix -ly/-less/-ful form are provided to the user by the interactive learning environment for story building using the suffix -ly/-less/-ful words learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” (words as in moon);

12. All regular compound words;

13. All words previously introduced that can take the form of suffix -ed/-ing;

14. All words previously introduced that can take the form of suffix -es/-s;

15. All words previously introduced that can take the form of suffix -er/-est;

16. All words previously introduced that can take the form of suffix -ly/-less/-ful;

17. Story building using the above words.

Words that follow a vowel suffix rule are provided to the user by the interactive learning environment for story building using the words that follow a vowel suffix rule learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” (words as in moon);

12. All regular compound words;

13. All vowel suffix rules words;

14. Story building using the above words.

Words having a “un, mis, dis, re” prefix are provided to the user by the interactive learning environment for story building using the words with the “un, mis, dis, re” prefix learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” (words as in moon);

12. All regular compound words;

13. All prefix (un, mis, dis, re) words;

14. Story building using the above words.

Words having the consonant -le form are provided to the user by the interactive learning environment for story building using the words with the consonant -le learned by the child in this segment.

1. All phonemes (including second sounds for c, g, s);

2. Digraphs (sh, ch, th, wh, ph, -ck, -tch, -dge);

3. All consonants blend at the beginning and end of words;

4. All r-controlled vowels (ar, or, er, ir, ur);

5. All regular “ee” words;

6. All regular “ea” words;

7. All regular “ai” words;

8. All regular “ay” words;

9. All regular “oa” words;

10. All regular “ou” words;

11. All regular “oo” (words as in moon);

12. All regular compound words;

13. All consonant -le words;

14. Story building using the above words.

The process culminates in building a story using polysyllabic and compound words and the special prefix, suffix, and consonant words learned in this level. Accordingly, the child may be required to build up to 8 stories or books before advancing to Level 11.

### Level 11

According to one aspect, the particular topics of educational content associated with Level 11 are the two main reasons for using the apostrophe, contractions and possessives. The process culminates in building a story using contractions, a story using the possessive “'s,” and a story using possessive pronouns. Accordingly, the child may be required to build up to three stories or books before successfully finishing the interactive learning environment.

For a more comprehensive and detailed description of the story building levels numbered 3-11, reference is made to the section of this specification under the heading “INSTRUCTION METHODOLOGY,” hereinbelow.

The discussion will now turn to specific features and enhancements of the specially developed software application.

### Avatars & Characters

To further increase the attention and investment of a child in the interactive learning environment, in various aspects, the child is portrayed on screen as an avatar preferably taking the form of an everyday living organism. For purposes of the present disclosure the avatar of the child is recited in the present disclosure and the attached drawings as that of an ant. This arbitrary selection appearing in the present disclosure and drawings, however, in no way is intended to limit such an avatar to that of an ant, an insect or even a living organism. Other examples of suitable avatar appearances can be fictional or non-fictional objects, such as a pet, a robot, a vehicle or practically any identifiable object to a child.

Whatever avatar is configured for the interactive learning experience, it is preferable that the avatar remain the representation of the child throughout all levels, all lessons and all activities. Further, the avatar in preferred embodiments will appear in nearly all videos and also can occasionally speak. However, speaking of the avatar on screen should be kept to a minimum, as it can be disruptive to the desired illusion that the avatar “is” the player.

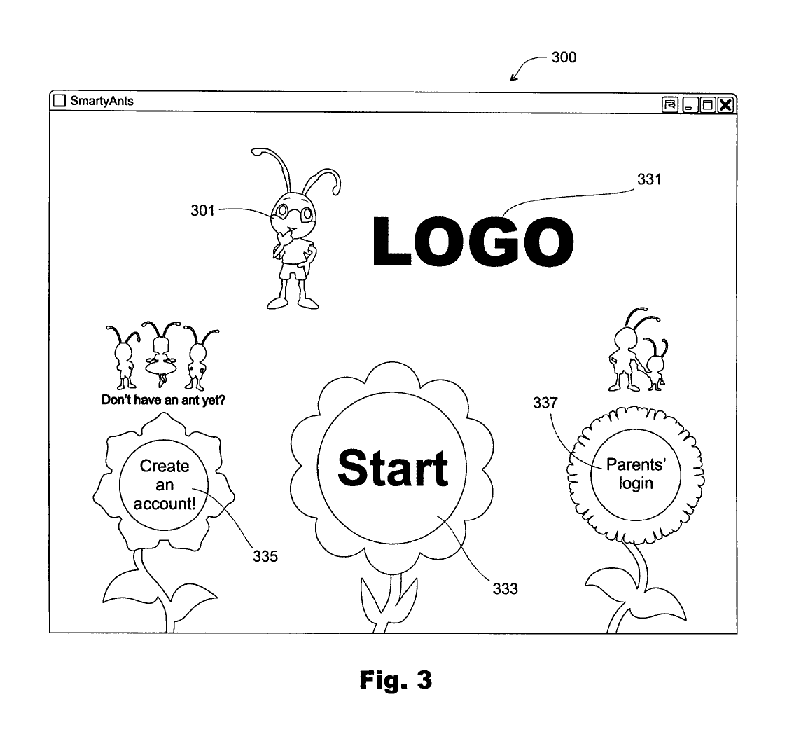

Turning now to FIG. 3, a typical login screen 300 is illustrated according to one aspect of the computer-implemented method. A generic avatar 301 can be presented on the screen 300, together with a name or logo 331 of the application and a start button 333. Preferably, a second button 335 is provided to create an account if no account exists, and a third button 337 is provided for a parent (not shown) to supervise the progress of the child (not shown).

To proceed, the child or parent would press the start button 333 and proceed to selection of the child's avatar.

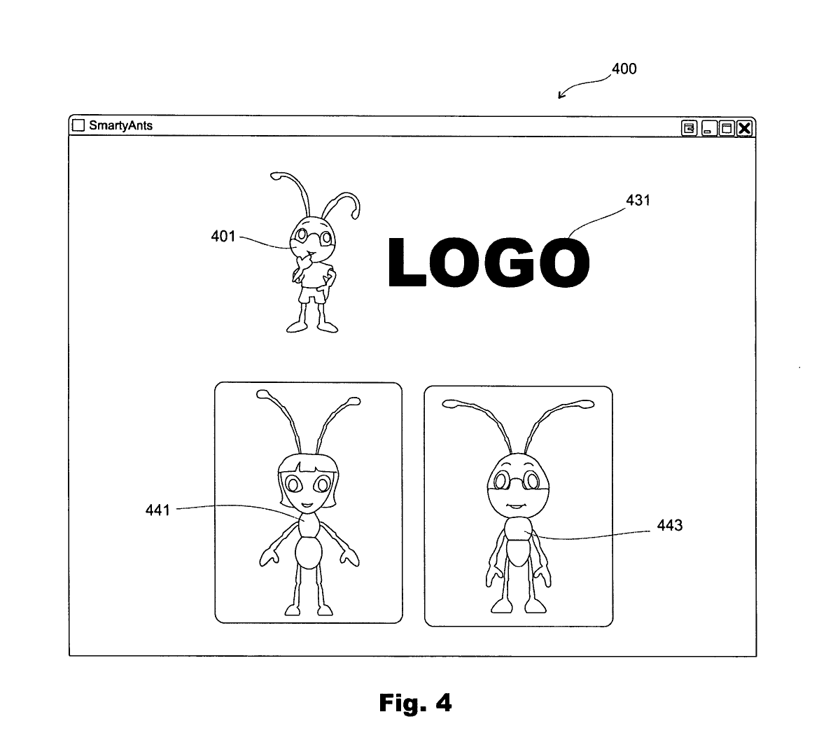

FIG. 4 is an illustration of an avatar selection screen 400 according to one aspect of the computer-implemented method. A generic avatar 401 can be presented on the screen 400, together with a name or logo 431 of the application. As illustrated, the child or parent could select a female ant 441 or a male ant 443 to proceed forward into the interactive learning environment as the selected avatar.

In various aspects, the avatar can be customized to suit the desires of the child, providing selections of outfits, head items (hats, glasses), shoes and a backpack. Preferably, all items are available and can be worn by both genders of ants, although some items may appear to be gender-specific. The child begins the interactive learning experience with a selection of each of these items and, in alternate embodiments, can purchase additional or optional items from a currency earned through the various activities. For purposes of the present disclosure, the interactive learning environment is similar in nature to a game, and references to the “game” herein should be construed as synonymous with the interactive learning environment. Thus, when a child achieves an object of the game, such as completing a lesson or an activity, the game renders tangible rewards such as congratulatory videos, quantities of virtual currency or points, or other rewards providing positive reinforcement of the achievement.

A variety of non-player characters also can occur throughout the game. These characters serve to make the world feel more alive and to play functional roles in the interactive learning environment. For example, a coach, such as a larger ant wearing a sports jersey, can be implemented to serve as the child's guide through various game activities. Such a coach character can appropriately be specially configured by the software application to greet a child on their first experience with the game and on returning visits to the game. As needed, the coach character can explain activities, provide tips and encourage the child to engage in the activities and complete the lessons.

Similarly, a dog character can be configured into the application and selected by a child to serve as a companion of the child through the activities and lessons. The dog character, in various aspects, can be configured on screen to resemble a plush appliance 210 of FIG. 2, such that the physical appearance of the plush appliance 210 resembles the on-screen dog character (not shown) of the child within the software application.

Preferably, a child immediately acquires a dog character as a companion early in the game, acquiring the dog character in a virtual location in the software such as a dog park. Once a child has met and acquired his/her dog character companion, the dog character is preferably visible in all game screens. As referred herein throughout the remaining disclosure, the dog character shall be referred to herein as a “dog” and such term shall be synonymous with a dog character on the screen of the application unless specifically referring to a plush appliance.

In most activities, the dog sits near the avatar of the child during an activity, cheering the player ant on when they are successful. In various aspects, however, the dog can take on a more active role during the game play. For example, during a story building activity, it can be preferable to have the dog compete against the child to build a story. Or in other aspects, during a recording studio activity the dog can sing along with the song being created. In still yet another aspect, it can be fun for a child to watch their avatar ride their dog around on the screen within a dog park.

Also, it is preferable that, like the child, the child's dog is shown receiving rewards for achievements, along with the child, when the child completes a letter or a word challenge. The dog award can be given in the form of a dog biscuit in the shape of a word or letter on the screen.

By way of example and furthering the theme of a dog companion character, a flea character also can appear in exemplary embodiments as a small insect providing insight to demonstrate how to successfully perform activities within the game. For example, the flea character can perform an activity for the child the first time the child arrives at the new activity, or any time the child or parent request help. Also, it is preferable to include the flea character in the proximate area on the screen of other characters such as the coach character and the dog, encouraging the child to complete the activity or task at hand.

### Peer Learning

In certain alternate aspects, it can be advantageous to also have friend characters appear in the game as other, non-player avatars who participate with the child in certain activities. Such friend avatars can appear as identical in form to the child avatar, with the appropriately chosen outfits, head wear, shoes and backpack. The camaraderie of other children's involvement can help be a motivation for the child to achieve and try hard to play with their friends, whether such friends are children that they know in the real physical world or not.

In order to accommodate such a multi-player environment, a wide area network is required such that the application 108 and computer 106 of FIG. 1 can communicate with other computers (not shown) hosting the friend avatars playing with the child.

In various aspects, however, it can be further advantageous for the child 102 to play against virtual friends, or friend characters generated by the application 108 to play cooperatively or compete against the child 102. To further create the reality and persona of such friend avatars, the parent 104 can input the names of real-life friends of the child. The gender and appearance of such friend ants can either be chosen by the parent or alternatively randomly chosen by the application 108.

In certain multiplayer activities (discussed later in this disclosure), friend avatars or computer-generated friend characters can serve as the player's teammates. In other activities such as free exploration based activities, can explore the virtual areas alongside the child's avatar. It is advisable that whenever friend characters are shown interacting with each other and with the child, they are polite and encouraging, demonstrating real-world principles of good sportsmanship and teamwork for kids who engage in team play activities.

In various aspects where such friends are computer-generated characters, this behavior can be controlled by the special programming of the friend characters in the application 108. In a real-life multiplayer environment across a wide area network, however, if friend avatars represent real-life children who are communicating with one another through the application 108, then there is the potential for inappropriate behavior and communication that can arise. Accordingly, it is generally preferable, and particularly for younger audiences, that the friends playing with a child in the game be virtual characters rather than real-life persons.

For certain other computer-generated characters, more details on their appearance and functionality will be discussed subsequently in connection with specific activities.

### Activity Board

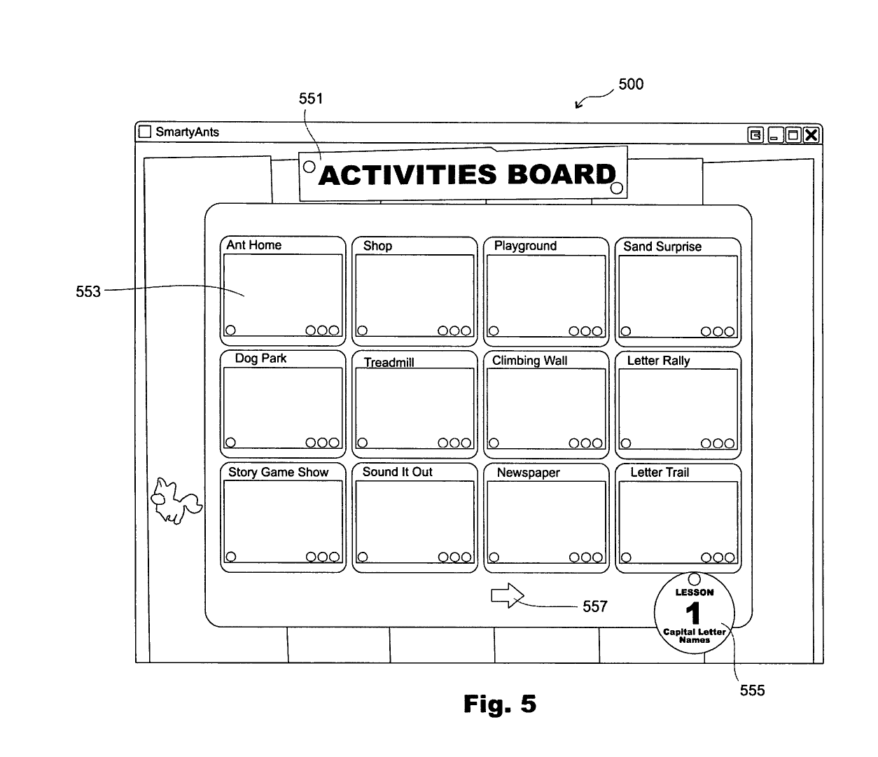

FIG. 5 is an illustration of an activities board screen 500 according to one aspect of the computer-implemented method. The activities board screen 500 is the primary navigation interface for the child and serves as a central location for the child's progress through the game. The child will frequently interact with the activity board screen 500. The child is presented with the activity board screen upon his/her initial introduction to the game, and also it is the default return point after exiting any lesson or activity. A banner 551 prominently identifying the activity board screen 500 is preferably located conspicuously on the activity board screen 500.

The primary structure of the activity board screen 500 is a grid displaying one or more activities 553 that the child can access. In each of the one or more activities 553, a thumbnail (not shown) representing an activity is preferably displayed. When one of the one or more activities 553 is chosen, the child is transported to the corresponding activity. Those one or more activities 553 which are available are preferably illustrated in full color, with those one or more activities 553 not available being depicted in grayscale. If additional one or more activities 553 do not fit on the activity board screen 500, they can be presented on a subsequent screen (not shown) which can be accessed by clicking the next page button 557. In connection with the present disclosure, reference to “click,” “clicking,” “clicking on,” and the like, refers to “selecting” the item that a user clicks on using an input device such as a mouse, generally speaking.

A module will appear in grayscale if either: (a) the child is at a juncture where that activity cannot be used, or (b) the activity is not yet available or has not yet been downloaded into the application 108. Preferably, the not-yet-downloaded activity icons will also include a symbol indicating some form of activity or construction to distinguish them from the unavailable activities. In preferred aspects, where a wide area network is available to the application 108, activities and updates are frequently downloaded in the background until all activities have been acquired. In this way, a child is likely to see new activities available on each of the first few logins. This approach and architecture also allows new content or activities to be introduced in the future.

Also, it is preferable to have an indication 555 on the activities board screen 500 to indicate the current lesson that the child has achieved.

### Avatar Home

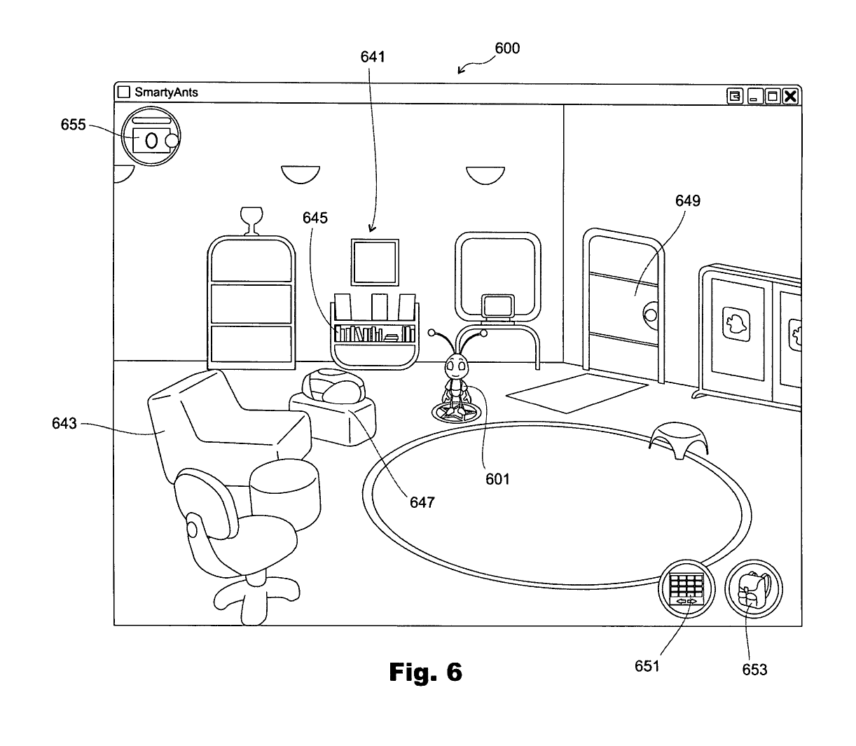

FIG. 6 is an illustration of an avatar home screen 600 according to one aspect of the computer-implemented method. The avatar home screen 600 also is a central location where the avatar can perform housekeeping tasks. An avatar 601 is preferably shown in their living room 641 with various decorations such as a chair 643, a bookcase 645, a radio 647, a door 649, as well as other decorative features. The child avatar's virtual home is a personalized space in the game world. The home's primary purpose is to provide a space for the child to decorate with home items purchased from the shopping area of the application 108, discussed subsequently within this disclosure.

In preferred aspects, home items come in two categories, wall items and floor items. Once the item has been placed, the child can click it again in the room to move it to another arbitrary fixed spot in the room. Clicking the item repeatedly will cycle through all fixed spots in the room appropriate to this item. In addition to home items placed in the room being movable, mousing over an item in the room will also provide an option to remove the item from the room.

As illustrated by a thumbnail of button 651, a child (not shown) also may return to the activities board screen 500 discussed above by pressing button 651. Similarly, the child can retrieve an inventory of the child's backpack by pushing button 653 or determine the present status of the child's virtual currency by pressing the debit card button 655.

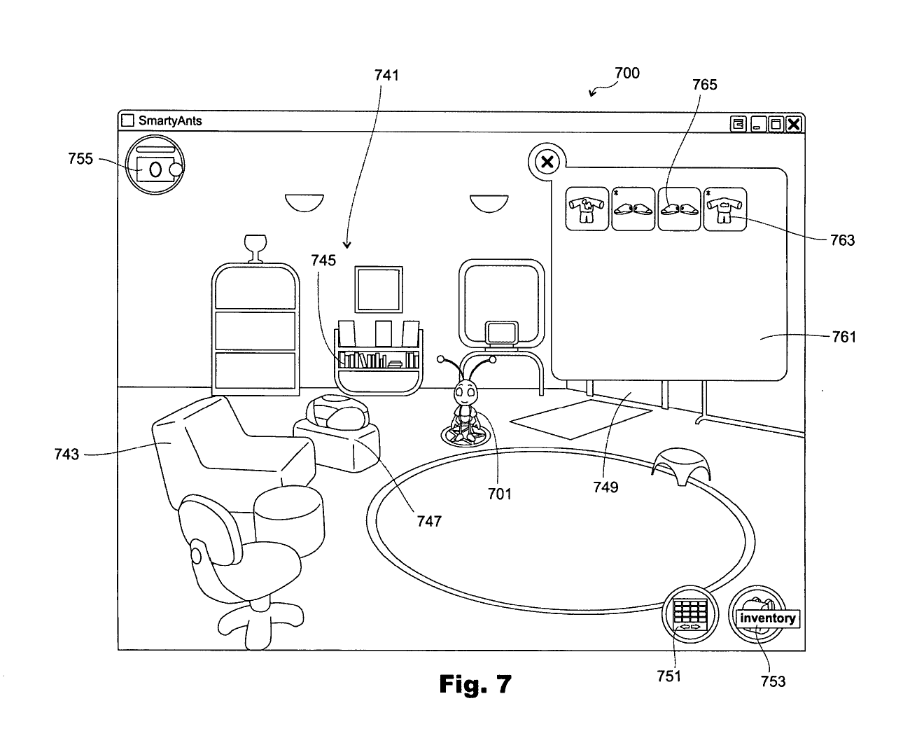

Turning to FIG. 7, an avatar home screen 700 according to one aspect of the computer-implemented method is shown with identical features of an avatar 701, a living room 741, a chair 743, a bookcase 745, a radio 747 and button 751. Note that an inventory button 753 is shown with the above corresponding inventory window 761. Inventory window 761 comprises of one or more shirts 763 and one or more shoes 765, in case the child wishes to change the shirt or shoes of the child's avatar 701.

### Virtual Activities to Learn Educational Content

Virtual activities within the context of the interactive learning environment are activities performed by a child's avatar on a computer screen which have been specially programmed to replicate physical activity in real-life. Typically, such activities, if successfully accomplished, serve as a vehicle for learning content and allow the child to proceed forward through the modes, lessons and ultimately levels of the game associated with the interactive learning environment. Activities and the content presented in the activities to a child are specially chosen to be reflective of the child's current curriculum status. When a child completes an activity and earns the next activity or lesson, (by getting it right a certain number of times, overall or consecutively), new activities or new content will be presented to the child along with positive reinforcement.

Preferably, activities also may have a difficulty setting (e.g., from 0 to 3) which can be set at the beginning of the activity. This difficulty setting affects the speed of play and challenge posed by the other characters, where appropriate. Typically, the difficulty setting does not affect the content presented during the activity. Setting a higher difficulty level allows a child to tune the fun to their own tastes, but it does not result in any change to the content or virtual currency associated with the activity.

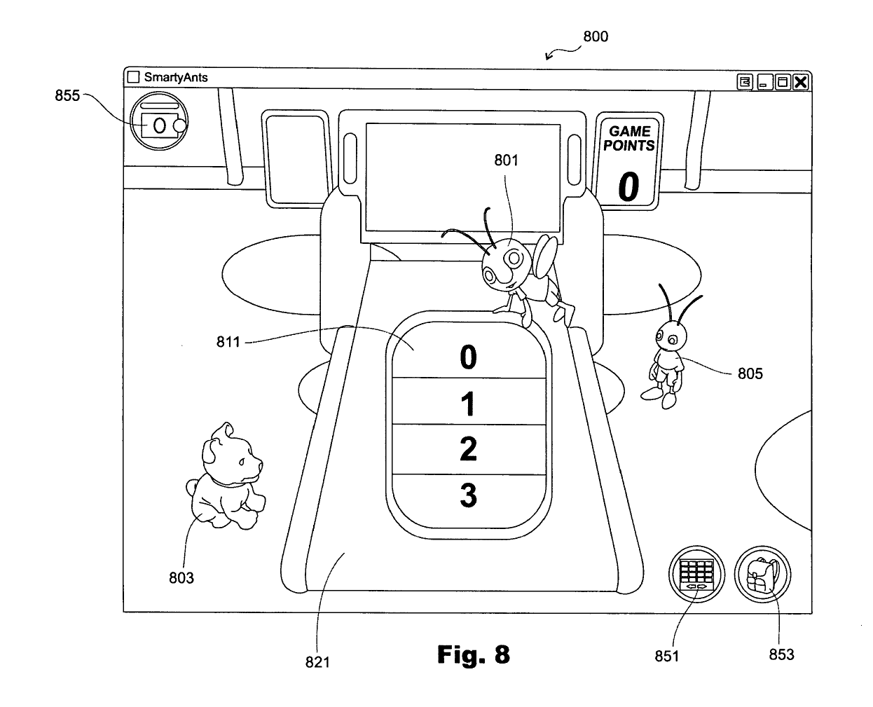

FIG. 8 is an illustration of a difficulty setting screen 800 for a treadmill activity according to one aspect of the computer-implemented method. Note that a coach character 801 is presenting the choices of a difficulty of 0 to 3 upon a difficulty setting dialog 811. Nearby, a child's avatar 805 and a dog 803 wait for the selection to be made on the difficulty setting dialog 811 which appears near a treadmill 821. Accordingly, a button 851 is provided to allow the child to return to the activities board screen 500, a button 853 is provided to invoke an inventory window 761 to view the inventory of the child's backpack, and a button 855 is provided to review the value of the child's virtual debit card.

Once a selection within the difficulty setting dialog 811 is made, the child will proceed to play the corresponding activity, (in this case operate a treadmill).

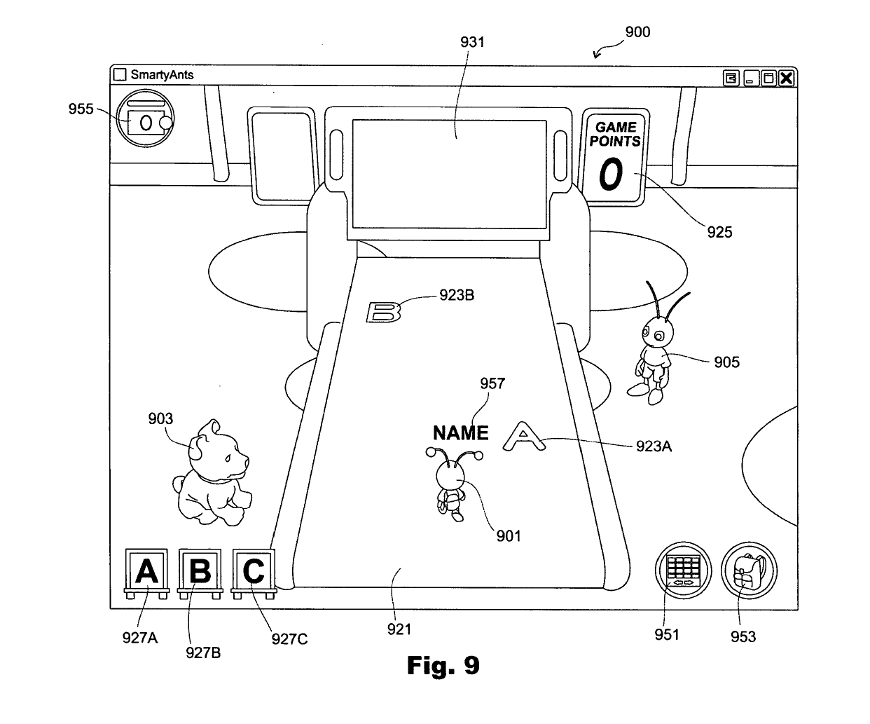

FIG. 9 is an illustration of a treadmill activity screen 900 according to one aspect of the computer-implemented method. More particularly, a child's avatar 901 runs forward along a treadmill 921 as letters, phonemes, or words move towards the child's avatar 901 from the front of the treadmill 921. Such letters, phonemes, or words are illustrated as a letter 923A and a letter 923B. The appropriate recognition cue for a letter, phoneme, or word is preferably called out by a coach avatar 905 and the child can use the mouse to steer the child's avatar 901 to catch the letter 923A or the letter 923B or other piece of content described.

Optionally, in one aspect, the interactive learning environment provides a method of providing hints and clues for assisting the child when the child makes a wrong selection in a positive manner. This concept may be referred to as scaffolding and comprises at least one level and in one aspect comprises four levels of assistance to the child. At a first level, if the child misses a letter, phoneme, or word after the appropriate recognition cue for a letter, phoneme, or word is called out by a coach avatar 905, the coach avatar 905 merely repeats the letter, phoneme, or word to give the child another opportunity to make the right selection and also provides visual clues to remind the child of the appropriate selection by illuminating the appropriate letter, phoneme, or word. If additional clues are required, e.g., if the child still fails to make the appropriate selection, at a second level, the coach avatar 905 will call out the wrong selection and remind the child of the appropriate letter, phoneme, or word that should be selected. If the child still fails to make the appropriate selection, at a third level, the right letter, phoneme, or word is shown on a message area 931 to provide further feedback to the child. Finally, in one aspect, if the child fails again, at a fourth level some form of interaction with the appropriate letter, phoneme, or word is provided. For example, a video may be presented that allows the child to interact with the appropriate letter, phoneme, or word or the child may be allowed to paint the appropriate letter, phoneme, or word. The scaffolding levels, however, are not limited to those presented herein and additional levels or methods or providing clues are envisioned within the scope of the present disclosure. For example, optionally, if the child needs further help or clues, in one aspect a letter 927A, a letter 927B or a letter 927C can be illuminated on the screen 900 to help the child make the correct identification of the recognition cue given by the coach 905.

Scaffolding may be employed to place the child in a zone of proximate learning, where the child is able to identify concepts in their zone. The interactive learning environment, moves the child at a pace at which they master the concepts (quickly or slowly). Challenges may be detected for an individual (e.g., did not get three in a row right or got cumulatively five right in a lesson) and applies the “scaffolding” concept. As previously discussed, interactive videos may be employed to help the child learn the information that the child finds particularly challenging.

The screen 900 also can be configured with a points counter 925 to show the progress of the child in correctly identifying letters, phonemes, or words. Similarly, the screen 900 also can be configured with a message area 931 to provide further feedback to the child.

A button 951 is provided to allow the child to return to the activities board screen 500, a button 953 is provided to invoke an inventory window 761 to view the inventory of the child's backpack, and a button 955 is provided to review the value of the child's virtual debit card.

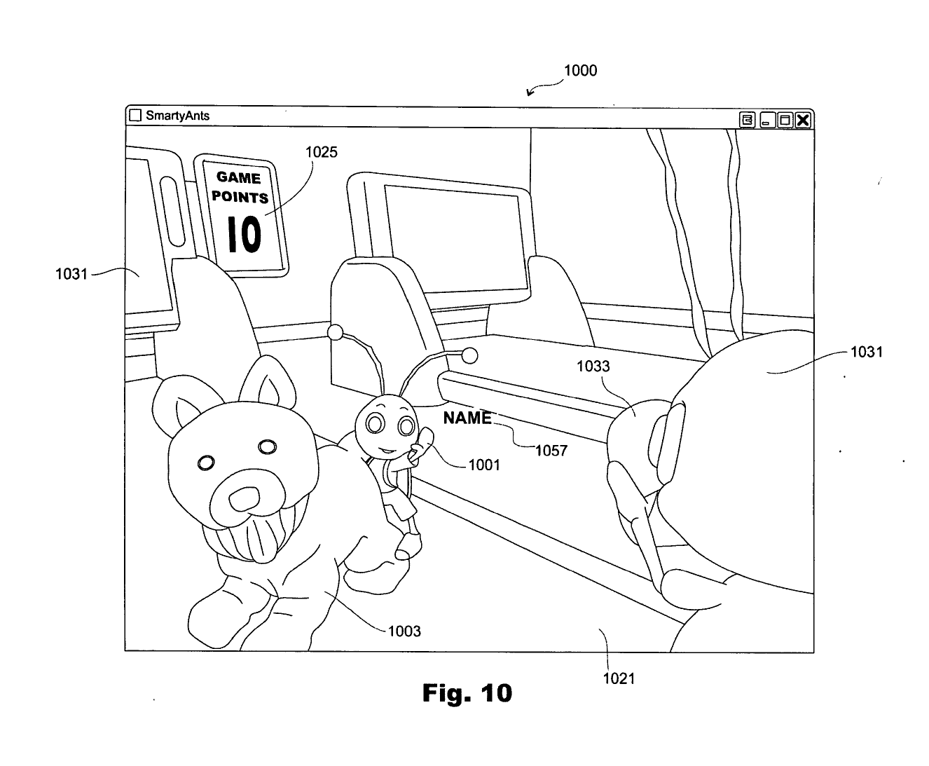

Once a pre-determined number (e.g., 10) of correct letters, phonemes, or words have been collected then the activity ends. In preferred aspects, an incentive such as a virtual currency amount is provided to the child if he/she successfully identified all the correct content, or alternatively was able to identify a pre-determined number (e.g., 5) of consecutive pieces of content correctly. For example, an illustration of an achievement of an activity according to one aspect of the computer-implemented method is illustrated in FIG. 10.

FIG. 10 is an illustration of an achievement of an activity according to one aspect of the computer-implemented method. More particularly, a reward screen 1000 portrays a photographer 1031 taking photos of a child's avatar 1001 and a dog 1003 with its camera 1033 as they excitedly celebrate an achievement on a treadmill 1021. Similar to the previously described treadmill activity screen 900 (FIG. 9), the reward screen 1000 also contains the environmental items of the previous activity such as a points counter 1025 (e.g., showing 10 points) and a message area 1031. For further clarification so that a child can readily recognize their avatar 1001, it is helpful for a name 1157 of the child's avatar 1001 to be displayed close to the avatar 1001.

Optimally, to correspond to the example theme of the content for the game, the photographer 1031 is a bee character which can be observed in various activities. The photos taken (not shown) by the photographer 1031 can appear in a virtual newspaper (not shown) which is available throughout the game highlighting the achievements of the child.

So that a child can readily recognize their avatar 1001 amongst the movement on the treadmill screen 1000, it is helpful for a name 1057 of the child's avatar 1001 to be displayed close to the avatar 1001. A button 1051 is provided to allow the child to return to the activities board screen 500, a button 1053 is provided to invoke an inventory window 761 to view the inventory of the child's backpack, and a button 1055 is provided to review the value of the child's virtual debit card.

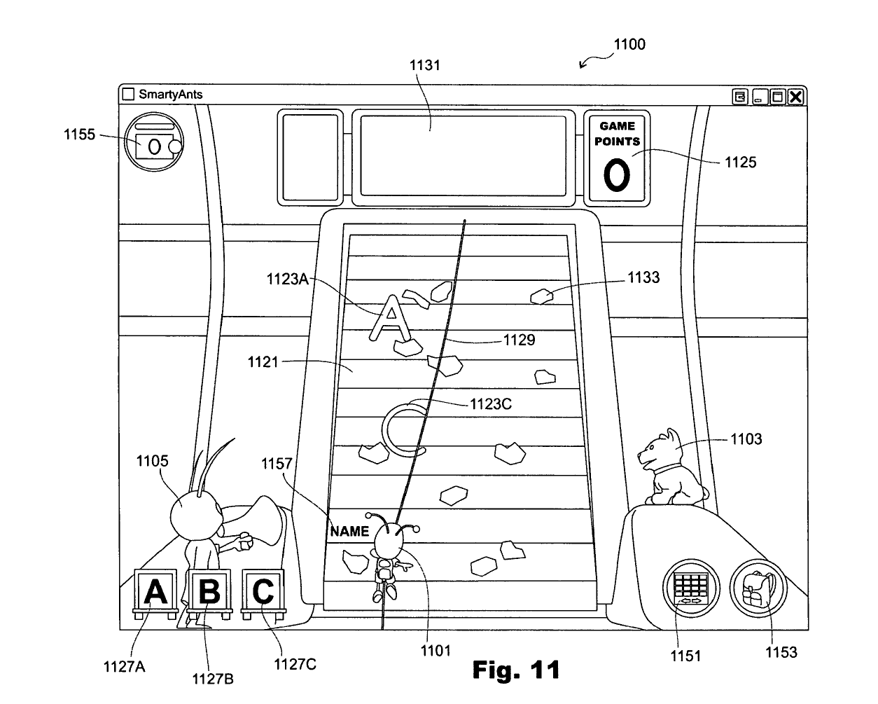

FIG. 11 is an illustration of a climbing wall activity screen 1100 according to one aspect of the computer-implemented method. Similar to the treadmill activity screen 1000 (FIG. 10), the climbing wall activity screen 1100 provides a virtual activity to learn the educational content provided in the game, with a points counter 1125 and message area 1131 provided to convey the status of the activity to the child.

As illustrated, a child's avatar 1101 is suspended from a rope 1129 and climbs along a climbing wall 1121, as letters, phonemes, or words and one or more rocks 1133 move down towards the ant from the top of the climbing wall. Similar to the treadmill activity previously described in connection with FIG. 10, a child can identify letters, phonemes, or words called out by a coach 1105 and maneuver the avatar 1101 to grab the correct letters, phonemes, or words, namely a letter 1123A or a letter 1123C as illustrated. Similar to the treadmill activity, the climbing wall activity lasts until a pre-determined (e.g., 10) correct letters, phonemes, or words are correctly identified by the child. As previously described in connection with FIG. 9, a scaffolding process of providing hints and clues for assisting the child in making the appropriate selection of phoneme, letter, or word also is available as part of the climbing wall activity.

Preferably, such that a child can readily recognize its avatar 1101 amongst the movement on the climbing wall screen 1100, it is helpful for a name 1157 of the child's avatar 1101 to be displayed close to the avatar 1101. A button 1151 is provided to allow the child to return to the activities board screen 500 (FIG. 5), a button 1153 is provided to invoke an inventory window 761 (FIG. 7) to view the inventory of the child's backpack, and a button 1155 is provided to review the value of the child's virtual debit card.

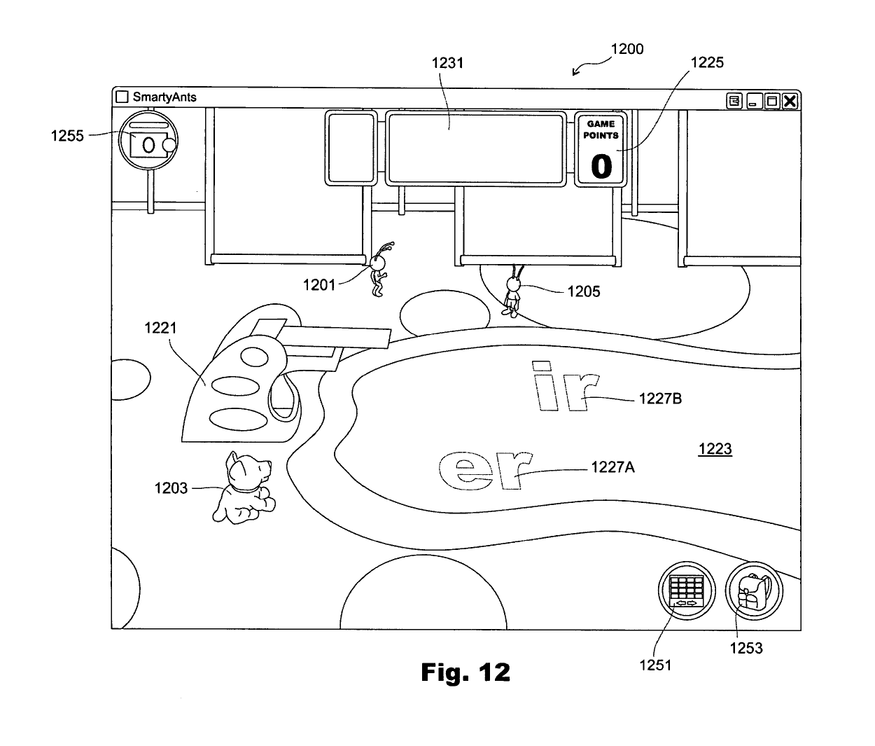

FIG. 12 is an illustration of a swimming pool activity screen 1200 according to one aspect of the computer-implemented method. Similar to the treadmill activity screen 1000 (FIG. 10) and the climbing wall activity screen 1100 (FIG. 11), the swimming pool activity screen 1200 provides a virtual activity to learn the educational content provided in the game, with a points counter 1225 and message area 1231 provided to convey the status of the activity to the child.

In various aspects, the swimming pool activity screen 1200 may be employed as an assessment module to assess the level of a given child based on assumptions of where a child of the age should be placed in the context of the interactive learning environment. As a result of the scores obtained at the assessment stage, the child may be placed at a predetermined level of the game. The placement may be either ahead or behind a current level.

As illustrated, a child's avatar 1201 is preparing to mount a diving board 1221 to dive into (and thereby identify) one or more letters, phonemes, or words, namely a phoneme 1227A and a phoneme 1227B, which are floating in the pool 1223. The child can identify letters, phonemes, or words called out by a coach 1205 and maneuver the avatar 1201 to select into the correct phoneme, namely either the phoneme 1227A or the phoneme 1227B as illustrated. Similar to the treadmill and climbing wall activities, the swimming pool activity lasts until a pre-determined (e.g., 10) correct letters, phonemes, or words are correctly identified by the child. Progress toward this pre-determined amount is displayed on a points counter 1225. Consistent with other activity screens such as the treadmill activity screen 1000 (FIG. 10) and climbing wall activity screen 1100 (FIG. 11), a dog 1203 encourages the child's avatar 1201 to pick the right selections.

Alternatively and in other aspects, when the child's avatar 1201 identifies all the correct letters or phonemes, a word is generated and is displayed in a message area 1231. Thereafter, the child's avatar 1201 dives into the pool to celebrate.

It is further preferable on the swimming pool activity screen that a button 1251 is provided to allow the child to return to the activities board screen 500 (FIG. 5), a button 1253 is provided to invoke an inventory window 761 (FIG. 7) to view the inventory of the child's backpack, and a button 1255 is provided to review the value of the child's virtual debit card.

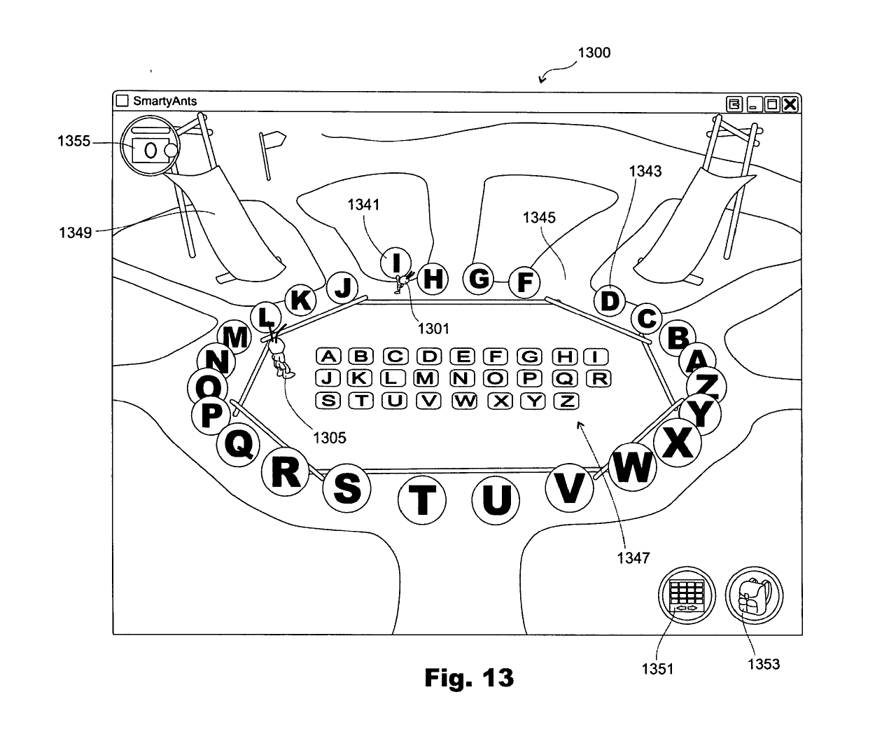

On the occasion that a child desires to freely explore the educational content without being challenged such as in the treadmill, climbing wall and swimming pool activities, other free exploration virtual activities can be provided. Free exploration activities are areas of the game where the child is free to explore and have fun, without a well-defined test or challenge. For example, FIG. 13 illustrates such a free exploration activity.

FIG. 13 is an illustration of a playground activity screen 1300 according to one aspect of the computer-implemented method. A child's avatar 1301 as well as one or more friend characters 1305 can walk around and explore a large playground area, populated with other characters and items of interest. In one aspect, within the playground are interactive objects such as a slide 1349 and swings (not shown) that the child can virtually use by clicking on them. Further, within the playground it can be helpful for various treasure chests containing educational content (e.g., letters, phonemes, or words) to be intentionally found by the child's avatar 1301, with the impression that such find is a fortuitous and unexpected event.

Various adaptations of the playground activity theme are possible. For example, as illustrated in the playground activity screen 1300, the child's avatar 1301 can pickup one or more virtual letters 1341 and arrange the one or more virtual letters 1343 to form words in a creative fashion. If more of a structured approach is desirable, the child's avatar 1301 can collect one or more letters 1343 and use them to complete words written within the sandbox (not shown).

In other aspects, an entire alphabet 1347 can be displayed for reference for the child. In yet other aspects, the child's avatar 1301 can carry a virtual letter ball 1341 to various locations on the playground activity screen 1300 or drop the virtual letter ball 1341 on a corresponding letter of the alphabet 1347. For a twist on the above themes, certain letters can be omitted, such as the missing letter “E” depicted by a vacant space 1345.

Similar to other activity screens, it is helpful to provide a button 1351 to allow the child to return to the activities board screen 500 (FIG. 5), a button 1353 to invoke an inventory window 761 (FIG. 7) to view the inventory of the child's backpack, and a button 1355 to review the value of the child's virtual debit card.

In another free exploration activity, (not illustrated), a dog park activity can be depicted on the game screen. By way of example, an avatar can be allowed to walk or ride their dog around a large, fun park and observe other avatars or characters walking or riding their dogs. Optimally, letters, phonemes, or words can be randomly displayed around the dog park, such that when the child's avatar passes by them the letter, phoneme, or word is audibly emitted.

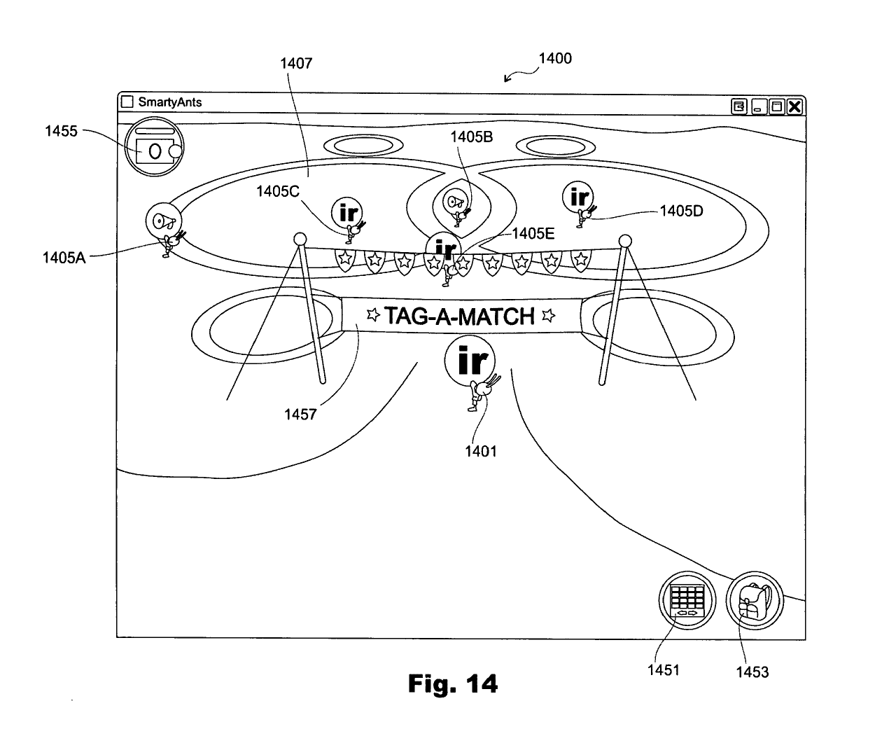

Turning to FIG. 14, a similar activity in a playground setting can accommodate multiple avatars (e.g., multiple players) to identify letters, phonemes, or words. FIG. 14 is an illustration of a matching activity screen 1400 with a corresponding title 1401 according to one aspect of the computer-implemented method. In this multiplayer activity, designed to teach letter, phoneme, or word matching, a child's avatar 1401 and one or more friend avatars or friend characters, depicted as a friend avatar 1405A, a friend avatar 1405B, a friend avatar 1405C and a friend avatar 1405D run around a field with an object 1407. To succeed, the child's avatar 1401 can pick up the appropriate object 1407 and tag another one of the avatars 1405A, 1405B, 1405C or 1405D that are picking up a corresponding object 1407. A child endeavors to match a pre-determined number (e.g., 10) of matches in a specified time frame (e.g., 5 minutes).

Similar to other activity screens, it is helpful to provide a button 1451 to allow the child to return to the activities board screen 500 (FIG. 5), a button 1453 to invoke an inventory window 761 (FIG. 7) to view the inventory of the child's backpack, and a button 1455 to review the value of the child's virtual debit card.

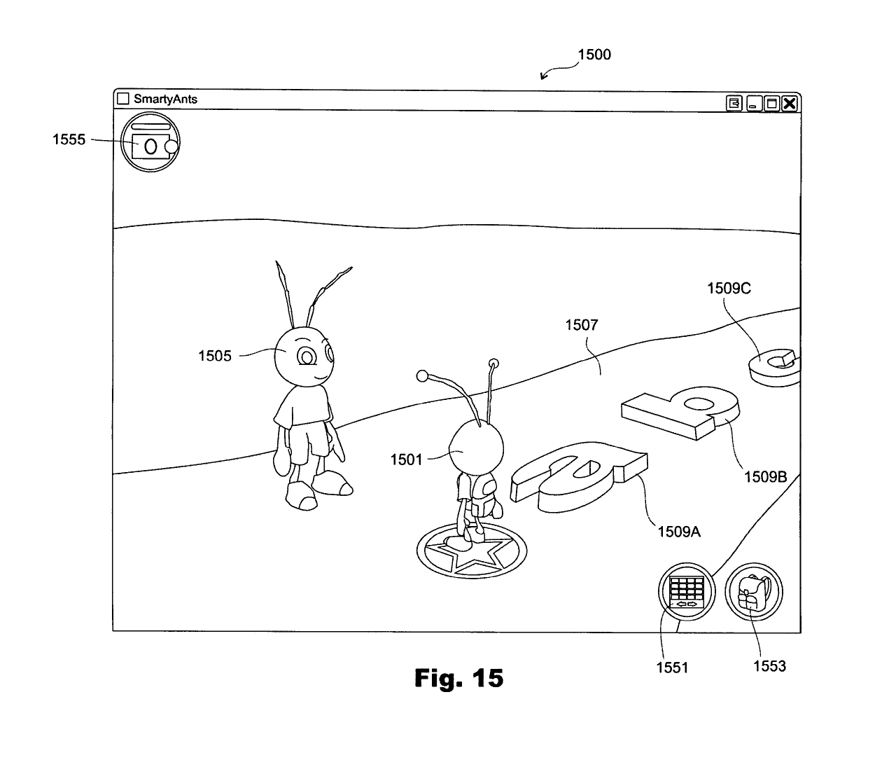

FIG. 15 is an illustration of another free exploration activity, such as a letter trail activity screen 1500 according to one aspect of the computer-implemented method. As illustrated, a trail of letters such as a letter 1509A, a letter 1509B and a letter 1509C, are arranged in a linear fashion for a child's avatar 1501 to explore. A coach character 1505 encourages the child's avatar 1501 to proceed to hop on various letters.

Like other activity screens, it is helpful to provide a button 1551 to allow the child to return to the activities board screen 500 (FIG. 5), a button 1553 to invoke an inventory window 761 (FIG. 7) to view the inventory of the child's backpack, and a button 1555 to review the value of the child's virtual debit card.

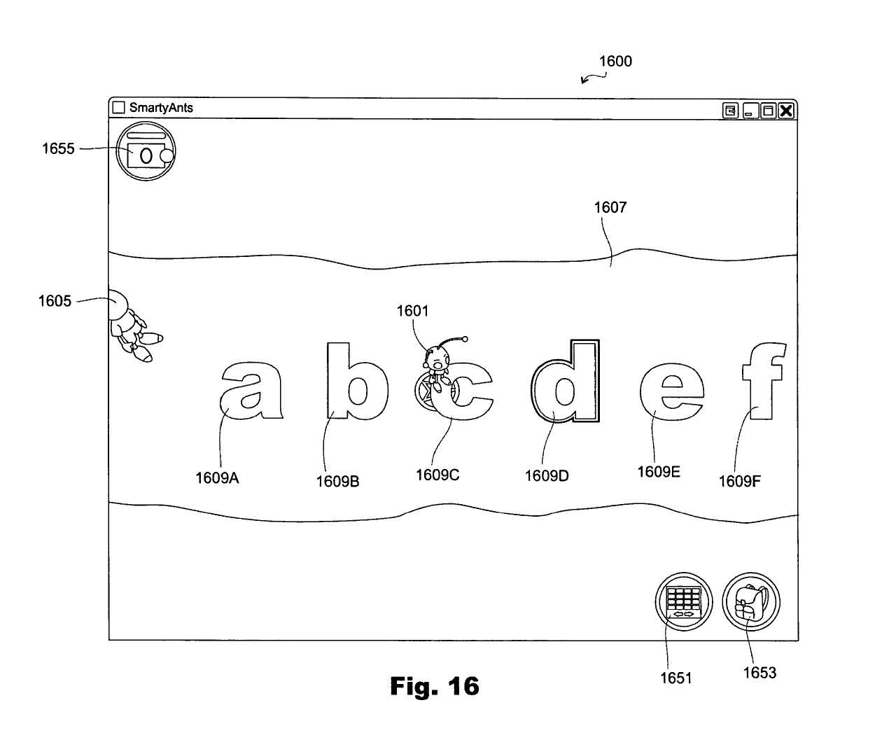

FIG. 16 is an illustration of an alternate letter trail activity screen 1600 according to one aspect of the computer-implemented method. More particularly, a child's avatar 1601 hops along several letters, namely a letter 1609A, a letter 1609B, a letter 1609C (where the child's avatar 1601 is presently located for illustration purposes), a letter 1609D, a letter 1609E and a letter 1609F along a trail 1607. Clicking on one of the letters such as letter 1609D, which is highlighted by the click, causes the child's avatar 1601 to jump (not shown) to that respective letter and say out loud either the letter's name or its sound. In exemplary embodiments, clicking on the given letter that the child's avatar is standing upon, if any, will toggle whether the letter's name or its sound is said.

Similar to other activity screens, it is helpful for a coach character 1605 to be present to encourage the child's avatar, as well as to provide a button 1651 to allow the child to return to the activities board screen 500 (FIG. 5), a button 1653 to invoke an inventory window 761 (FIG. 7) to view the inventory of the child's backpack, and a button 1655 to review the value of the child's virtual debit card.

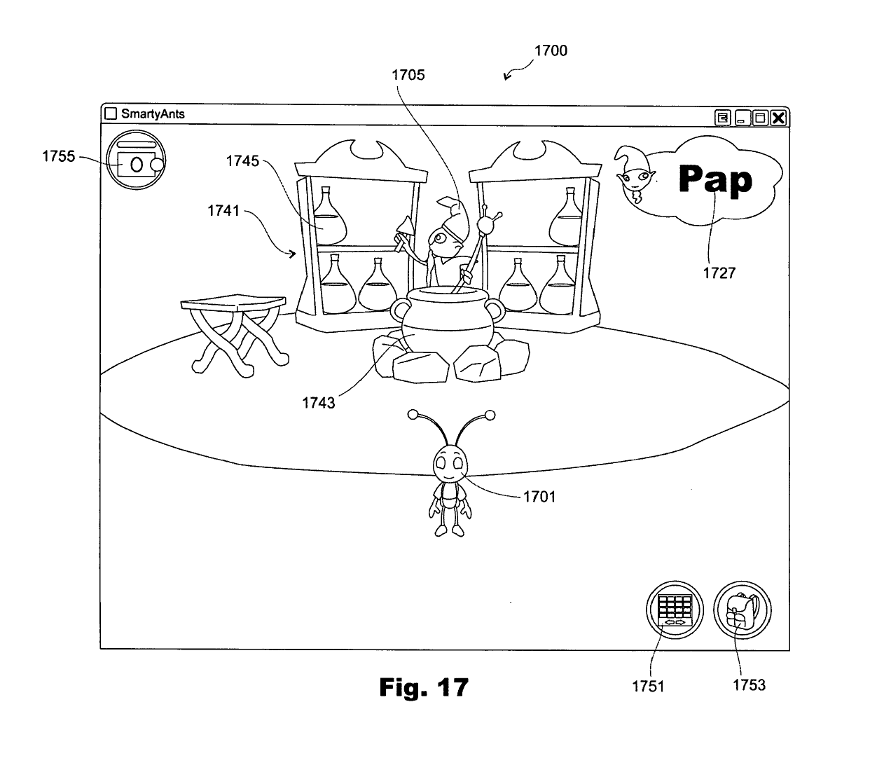

FIG. 17 is an illustration of a quest activity screen 1700 according to one aspect of the computer-implemented method. As shown, a wizard character 1705 is mixing a potion in a large pot 1743. In the background, one or more potions 1745 are situated on a set of bookshelves 1741. In the foreground, a child's avatar 1701 receives one or more instructions both visually and audibly to acquire a certain letter, phoneme, or word from a pre-determined area such as a playground area (not shown). In one aspect, and following the theme of the presented content, the wizard character 1705 is requesting that the child's avatar 1701 go on a quest and find an ingredient 1727 (which is the short word “pap”). Preferably, if the child's avatar does not find the object within a set period of time, the child will be shown a magic arrow (not illustrated) which would provide a tip or suggestion to accomplish the task at hand.

As included on other activity screens, it is preferable to provide a button 1751 to allow the child to return to the activities board screen 500 (FIG. 5), a button 1753 to invoke an inventory window 761 (FIG. 7) to view the inventory of the child's backpack, and a button 1755 to review the value of the child's virtual debit card.

In yet other activities (not illustrated), a child can push or throw letters and in an individual setting or in a multiplayer setting form letters or phonemes, scattered about a field, into buckets to consecutively spell words. When enough of the correct letters/phonemes have been added to a bucket, the bucket is completed and another bucket opens. In exemplary embodiments following the presently disclosed ant theme, other insects such as beetle characters can attempt to challenge and block the child's avatar or friend characters from throwing their letters and phonemes into the correct buckets.

Any of the foregoing activities also can be portrayed in the context of a large arena or sports facility (e.g., hoops or end zone module), complete with one or more sportscaster characters. Such a sportscaster character can serve as an announcer (in conjunction or without a coach character), introducing the child's avatar and friend avatars (if present) and articulating the objects of the activity. Such a portrayal in a large arena and the presence of a sportscaster character can make the child feel as if they are participating in an exciting live event.

In various aspects, the virtual activities may be referred to as learning modules. In one aspect, multiple modules (e.g., 10 or more) may be referred to as learning modules, with some (e.g., 4 or more) being common to all levels. Modules may provide alternate ways of learning the same information. In one aspect, a child may learn all lessons for a particular level within a single module. Also, the interactive learning environment tracks where the child left off within a particular module and returns the child there at a later time. For example, if the child is learning letters and stops at the letter “F,” the next time the child enters the module, it picks up and begins with the letter “G.” Within a module, vowels may be presented in one color (e.g., red) whereas consonants may be presented in another color (e.g., blue) to provide visual distinction. The child also is taught how to form or write letters—has start/stop points to fill in colors when painting letters. Some modules may be available only when certain levels are reached.

### Story Creation

In various aspects disclosed herein, once all modes for a lesson have been completed a child is shown a brief video that requests that the child play one of the available story creation activities. The story creation activities provide for the child, via their child avatar, to build a story with the words that the child has just learned.

Once a child has created a story for the lesson on one of the story creation activities, preferably the following events occur: (a) the child receives another video congratulating them for creating the story, and showing them a video relating to that newly created story; (b) the child receives a quantity of virtual currency added to their debit card for creating the story; (c) the child is given the option to print a copy of the story; (d) a trophy is awarded, or alternatively the child's trophy collection is updated to reflect the newly earned story; (e) if the child has also completed a curricular level, a longer video is played congratulating the child and introducing the child to the next curricular level. Additionally, if the child is utilizing a plush appliance, an internal notification is generated to update the content stored on the plush appliance. Lastly, the child is returned to an updated activity board screen 500 (FIG. 5), wherein the activities board screen now reflects those updated activities for the next lesson.

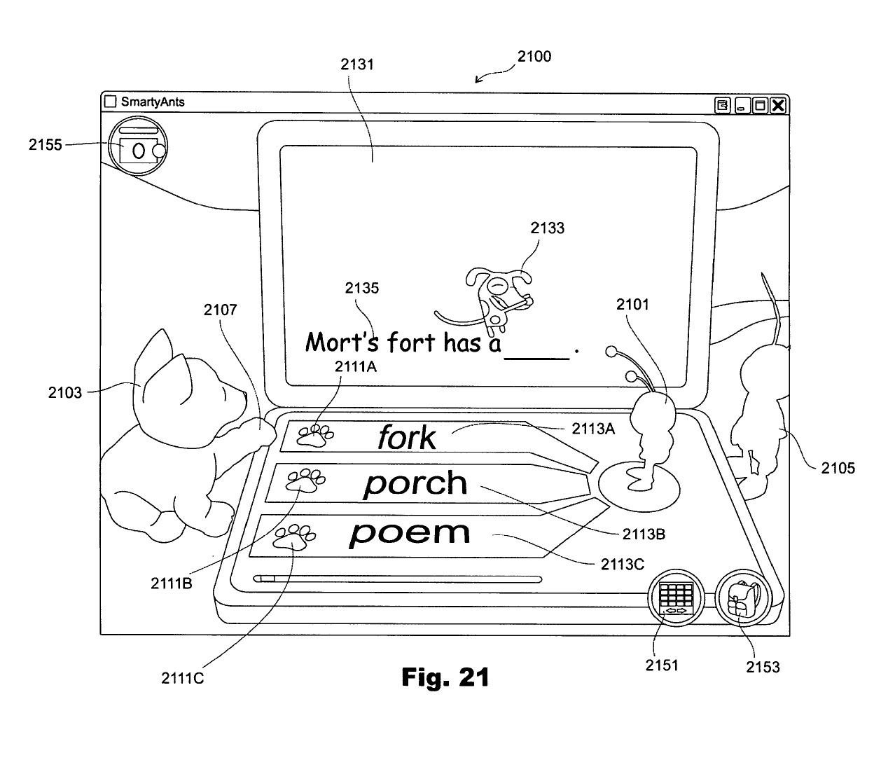

Further to story creation activities, the present disclosure contemplates two different story creation activities although other creative options are available. FIG. 21 is an illustration of a first story creation activity screen 2100 according to one aspect of the computer-implemented method. A child's avatar 2101 races against a dog 2103 to read and select words to a new story. A child's avatar 2101 earns a point each time it clicks the correct word of the story before the dog 2103 does. Once the child's avatar 2101 has played through the story, the child's avatar 2101 has the option to replay and try to beat the previous score. When the child is done replaying, the child has completed the creation of the story and can move on to the next lesson.

More particularly, in the example provided, the query 2135 “Mort's fort has a ______” is presented on a virtual computer screen 2131 suggesting a particular word that should be selected through a first button 2113A, a second button 2113B or a third button 2113C. At the same moment in time, the dog 2103 is trying to touch the correct button of a first dog button 2111A, a second dog button 2111B or a third dog button 2111C. Therefore, in the example provided, if the child avatar 2101 touches the second button 2113B before the dog touches a paw 2107 to the second dog button 2111B, then the child avatar celebrates. Similar to other activities, it is helpful to include additional characters on the first story creation activity screen 2100 such as the coach character 2105 and a virtual screen helper character 2133. As additional queries (not shown) are presented, ultimately a story is built with the multiple sentences that are formed by the combination of the child's avatar 2101 and the dog 2103 answering with the correct words.

Similar to other activity screens, it is preferable to provide a button 2151 to allow the child to return to the activities board screen 500 (FIG. 5), a button 2153 to invoke an inventory window 761 (FIG. 7) to view the inventory of the child's backpack, and a button 2155 to review the value of the child's virtual debit card.

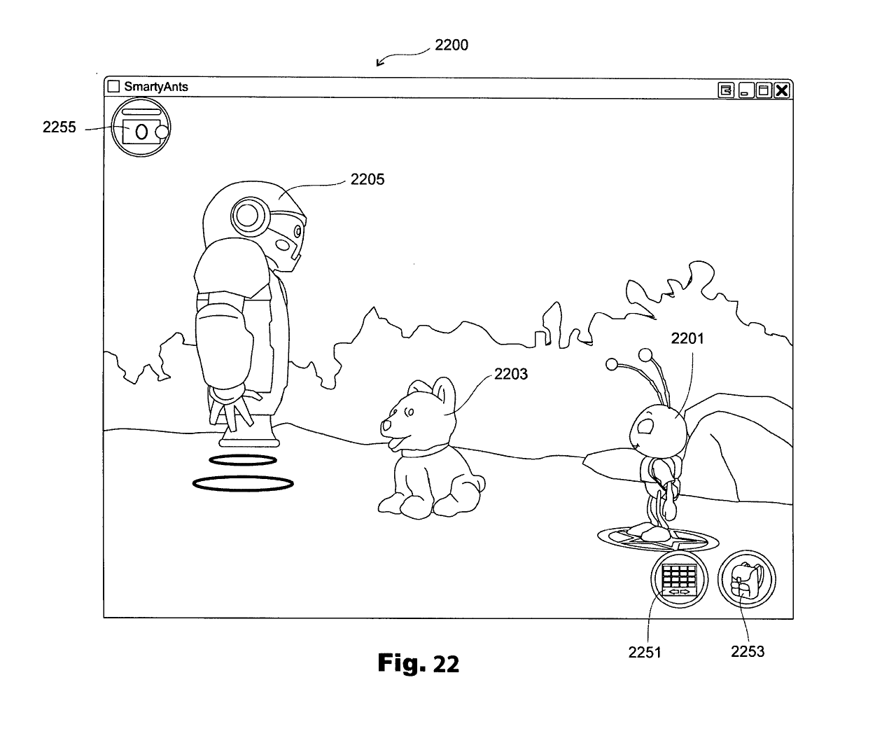

The second story creation activity is similar in process to the first story creation activity screen 2100, with a different presentation. FIG. 22 is an illustration of a second story creation activity screen 2200 according to one aspect of the computer-implemented method. The activity begins with a child's avatar 2201 and a dog 2203 standing in front of a robot 2205. Similar to other activity screens, it is preferable to provide a button 2251 to allow the child to return to the activities board screen 500 (FIG. 5), a button 2253 to invoke an inventory window 761 (FIG. 7) to view the inventory of the child's backpack, and a button 2255 to review the value of the child's virtual debit card.

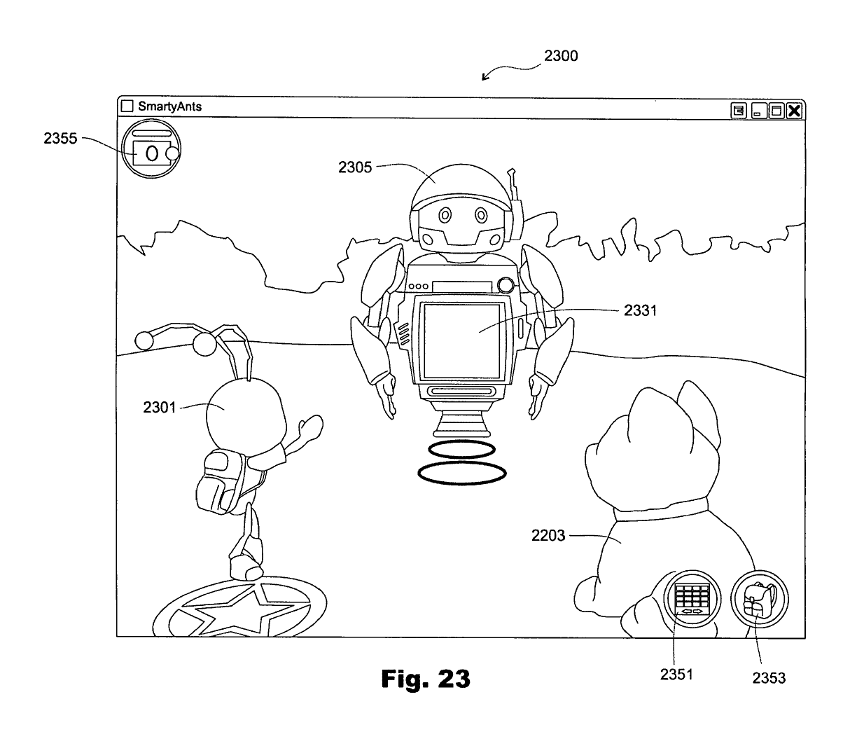

Turning to FIG. 23, an alternate illustration of the second story creation activity screen 2300 is shown with a child avatar 2301 and a dog 2303 facing a robot 2305. In the chest area of the robot 2305 is a video monitor 2331 similar to the virtual computer screen 2131. Similar to other activity screens, it is preferable to provide a button 2351 to allow the child to return to the activities board screen 500, a button 2353 to invoke an inventory window 761 (FIG. 7) to view the inventory of the child's backpack, and a button 2355 to review the value of the child's virtual debit card.

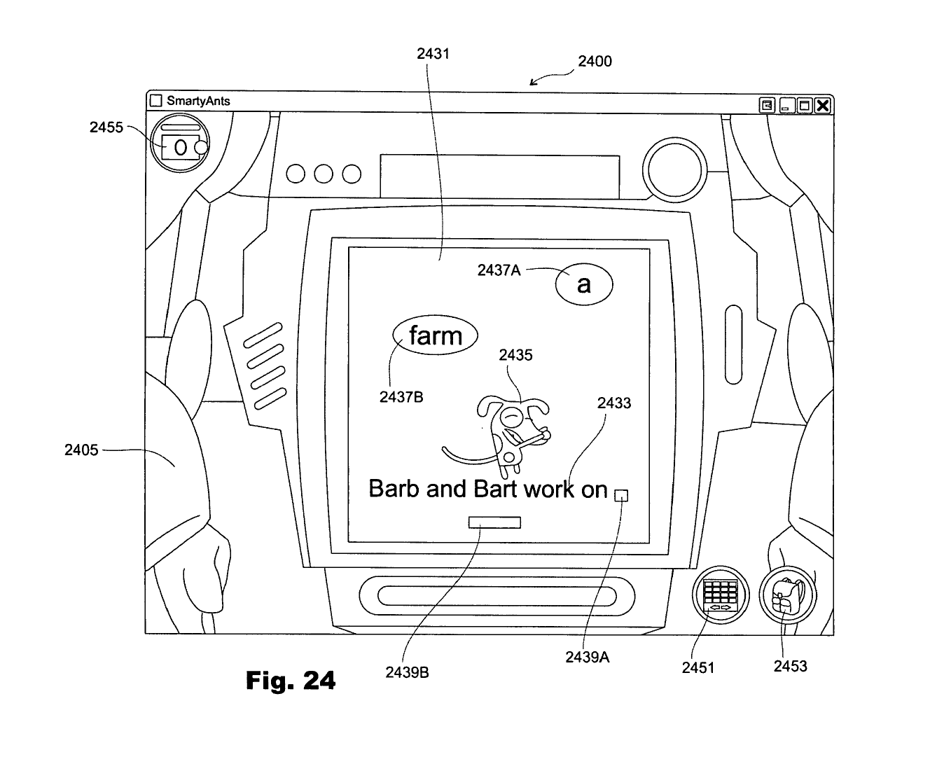

FIG. 24 is a close-up illustration of a second story creation activity screen 2400 of the chest area of the robot 2405 and video monitor 2431, which are the corresponding items 2300, 2305 and 2431, respectively, found on FIG. 23. As shown in the example provided, a query 2433 is provided (“Barb and Bart work on ______” with a first blank space 2439A and a second blank space 2439B awaiting an answer. The child is therefore prompted to select the appropriate words from a first word 2437A and a second word 2437B. Similar to other activity screens, it is preferable to provide a button 2451 to allow the child to return to the activities board screen 500, a button 2453 to invoke an inventory window 761 to view the inventory of the child's backpack, and a button 2455 to review the value of the child's virtual debit card.

When the child completes a plurality of sentences and a story is formed, the child moves forward having completed a story for the lesson.

Once a story is formed through either of the above described story creation activities, or given a story that is provided by the educational content, a story can be read, sung or manipulated by a child in a variety of ways to more fully understand the words that make up the story.

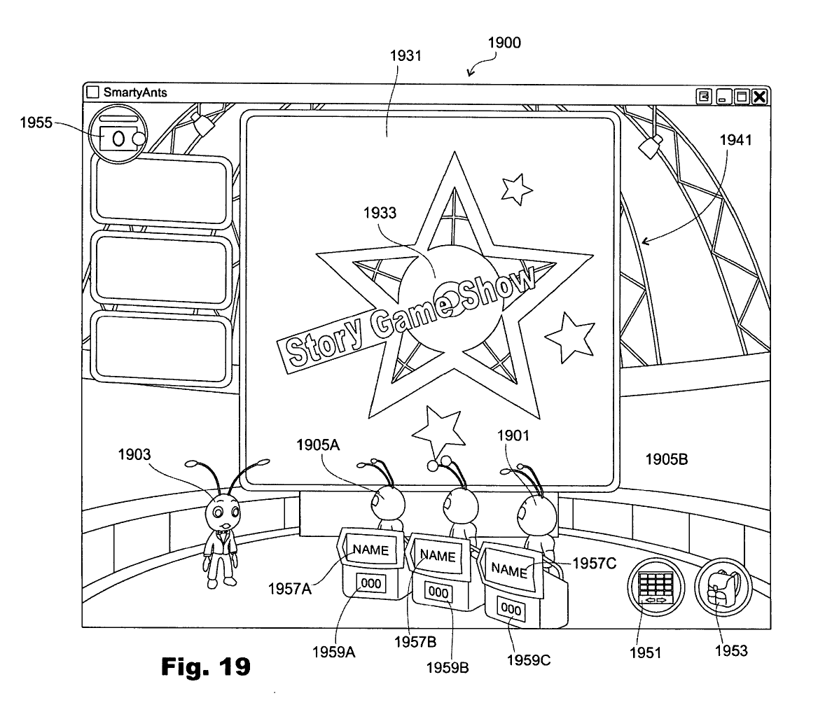

For example, FIG. 19 is an illustration of a game show activity screen 1900 according to one aspect of the computer-implemented method. A story is read out loud to the child's avatar 1901 during a virtual game show 1941 which is hosted by a game show host character 1903. Preferably, the child's avatar 1901 is accompanied and is competing against a first friend character 1905A and a second friend character 1905B. To create a more realistic virtual activity, the game show 1941 stage should be complete with a first name 1957A of the first friend character 1905A, a second name 1957B of the second friend character 19056, and the avatar name 1957C of the child's avatar 1901. It is further helpful to show a first points counter 1959A, a second points counter 19598 and a third points counter 1959C to keep track of the respective scores of the child's avatar 1901 and friend characters 1905A and 1905B.

Like other activity screens, it is preferable to provide a button 1951 to allow the child to return to the activities board screen 500 (FIG. 5), a button 1953 to invoke an inventory window 761 (FIG. 7) to view the inventory of the child's backpack, and a button 1955 to review the value of the child's virtual debit card.

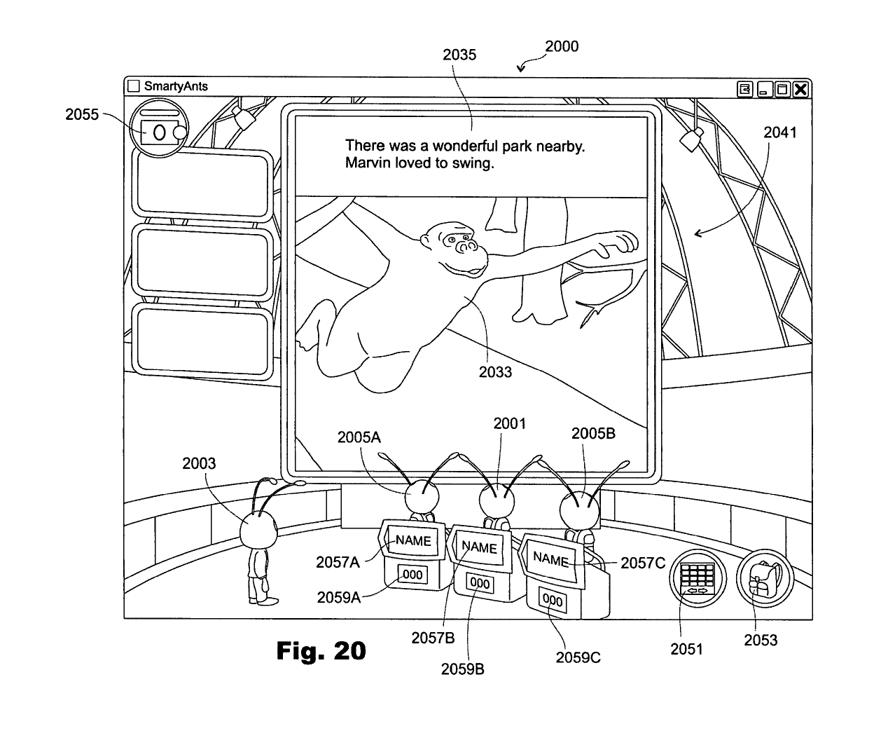

Turning to FIG. 20, a similar but alternate game show activity screen 2000 according to one aspect of the computer-implemented method is illustrated, which is portraying a specific story about an ape named Marvin. As illustrated, a game show 2041, a child's avatar 2001, a first friend character 2005A, a second friend character 2005B, a first name 2057A, a child's avatar name 2057B, a second name 2057C, a first points counter 2059A, a second points counter 2059B, a third points counter 2059C and a game show host 2003, a button 2051, a button 2053 and a button 2055 are depicted similar to that of FIG. 19. Further, the story is both being provided in one or more words 2035 as well as in one or more pictures 2033.

In various aspects, the words of the story are displayed and jiggle as the story is read. Some of the stories may be aspirational and well beyond the child's level. The child may be asked questions to identify words, characters, theme, and demonstrate a plot in a contest environment to win coins that can be added to the child's virtual debit card as a reward for comprehension tests.

After reading the story, the child's avatar 2001 competes against the first friend character 2005A and the second friend character 2005B to answer questions about the story's words and pictures.

In various aspects, after a story has been created for a lesson, given the activities above, another option preferably provided is for the child to enter into a virtual recording studio and record a song about the story.

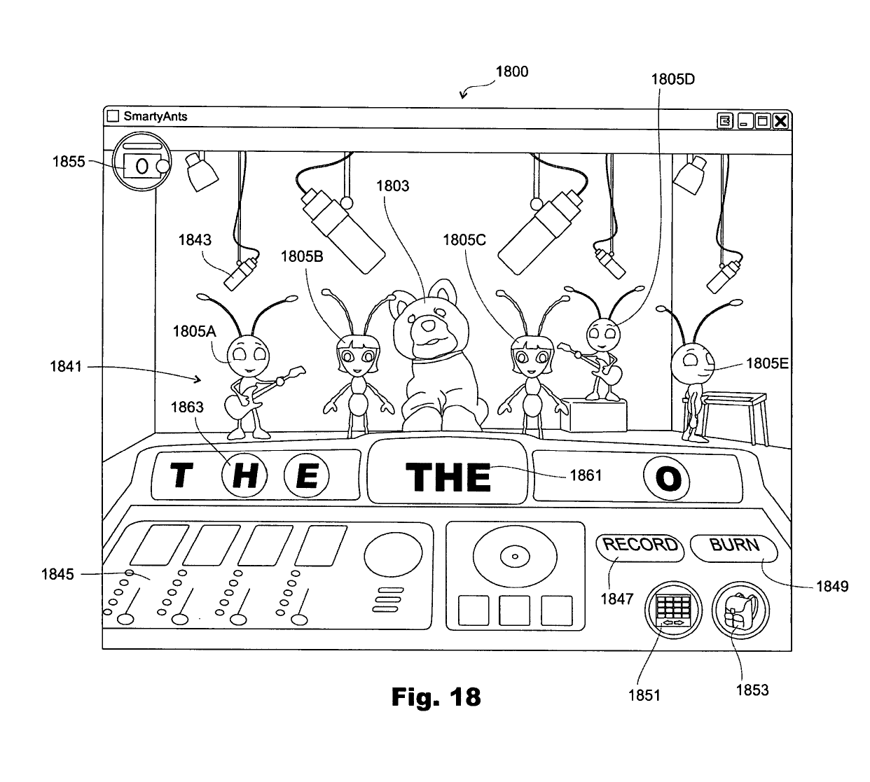

FIG. 18 is an illustration of such a recording studio activity screen 1800 according to one aspect of the computer-implemented method. This activity is played with either the words of the child's latest lesson story being sung as a vocal track, or alternatively a vocal track is provided by the educational content. The song is played, initially with vocals only, and the child is asked to click the words of the song at the right time within the flow of the song. Every time the child's avatar clicks the words correctly, points are earned towards activating an instrument, and when that instrument is fully activated, it starts to play along with the song. The instruments the child can earn are drums, bass, guitar, and keyboard. Once all four instruments are earned, the child is allowed to create a ‘remix’ of the song, where the child can choose which instruments can play at which points, and add scratches using a turntable. In one aspect, the child puts letters and/or words together to form a song as guided by the interactive learning environment. In one aspect, when the child performs correctly, the child is permitted to switch musical instruments as a reward. Also, in one aspect, the dog character may sing with a back-up band.

More particularly, as shown in a recording studio activity screen 1800, a mixing board 1845 controls the various instruments that can be added to the track. Various lights and decorations, such as a record light 1847 and a burn light 1849 that can light at appropriate times to create a realistic portrayal of a recording session. A central space 1861 in the control panel provides a location for the current word being sung to be shown, as well as a secondary space 1863 where letters of the word or other information can be provided. Various band members and singers are preferably animated on the screen depicting a live take of the song, such as a guitarist character 1805A, a bass guitarist character 1805D, a keyboard character 1805E, a first backup singer 1805B, a second backup singer 1805C and a singing dog 1803. Other assorted decorations such as a one or more overhead lights and microphones 1843 are preferable to include in the live studio.

Similar to other activity screens, it is preferable to provide a button 1851 to allow the child to return to the activities board screen 500 (FIG. 5), a button 1853 to invoke an inventory window 761 (FIG. 7) to view the inventory of the child's backpack, and a button 1855 to review the value of the child's virtual debit card.

Only a small selection of potential activities has been disclosed herein with respect to specific novel approaches to teaching educational content through virtual activities on a computer. A great number of other sporting, recreational, entertainment and cultural activities, however, also are contemplated as being suitable for virtual activities within the novel interactive learning environment disclosed herein, and such other activities can serve as equally useful and entertaining contexts as those disclosed in the present disclosure.

In various aspects, the interactive learning environment provides a self navigation feature where the child may decide which stories to hear and which activities to engage in. This enables a child to quit when he or she perceives that the only way to get out when stuck is to quit.

Also, alternative stories may be provided to teach the same lessons in order to keep child engaged in learning. Thus, children who like to learn alone may gravitate to certain modules whereas children who like to learn together as a team in a social environment may gravitate to other modules customized for them, e.g., the dog park to play with dogs and friends. Further, children who like competition may gravitate to other modules, e.g., stadium (cheering fans, dogs, etc.), and obstacles to achieve team goals. In one aspect, the child is always a winner. Even though the child may choose where to go, the interactive learning environment controls the pace of the curriculum.

### Rewards

In various aspects, rewards are preferable to include as they are positive reinforcement for the completion of activities and provide incentive for a child to succeed in the game and ultimately the educational process. Further, a diversity of ongoing forms of rewards is a major factor that serves to motivate the player to continue to play through the games and work through the structured curriculum. Some rewards are specifically tied to achievements within the curriculum, while others can be earned simply by continuing to play and participate in the activities described above.

In one aspect of the computer-implemented method, rewards may be provided in the various forms of: (a) congratulatory videos, (b) awarding the child a trophy for addition to a trophy collection, (c) virtual currency to shop for virtual items for the child's avatar to purchase, and (d) flattering news articles written about the child's avatar in the virtual newspaper.

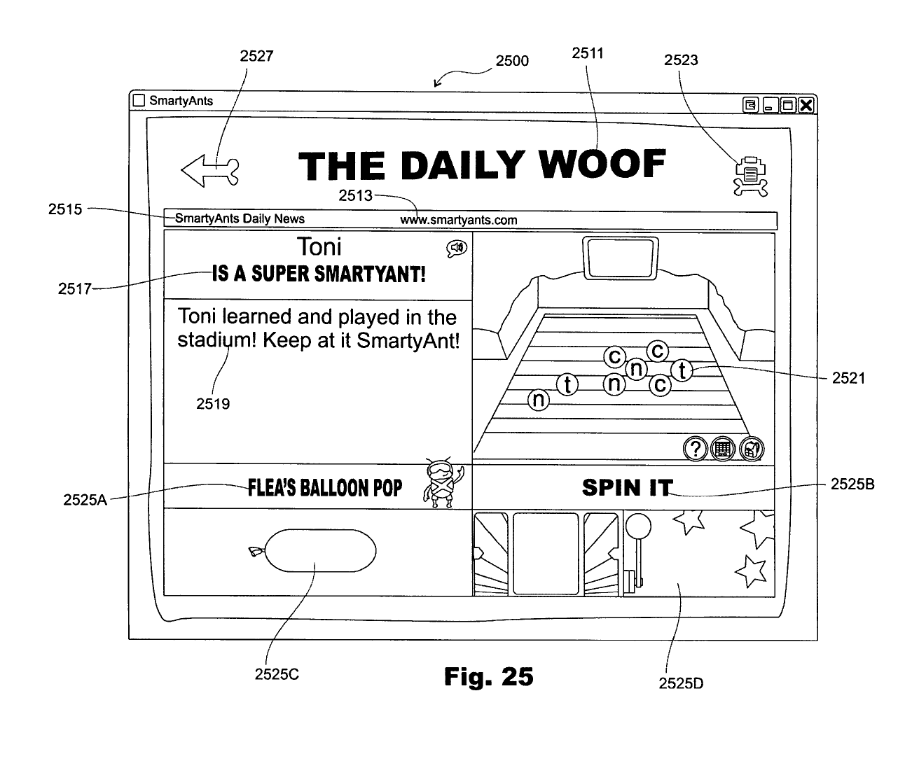

FIG. 25 is an illustration of such a virtual newspaper screen 2500 according to one aspect of the computer-implemented method. “The Daily Woof” is a newspaper that a child perceives as a newspaper sharing recent news. Every issue of the newspaper serves as a visual acknowledgment of the child's achievements. Preferably, an issue of newspaper is generated daily based on a child's activities and is available within various locations of the interactive learning experience, including the activity board screen 500 (FIG. 5). In one aspect, the newspaper may assist to reinforce the previous day's lesson.

More particularly, such a virtual newspaper screen 2500 preferably includes a bold newspaper title 2511, a button 2527 to return to the previous activity, a button 2523 to print the newspaper in hardcopy, a secondary title 2515, a website location 2513, a headline 2517, an accompanying story 2519 and an accompanying photograph 2521 about the child's recent achievement. Preferably, the newspaper also includes a first button 2525A leading to a first game, a second button 2525B leading to a second game, a first illustration 2525C depicting the nature of the first game and a second illustration 2525D depicting the nature of the second game. In preferred embodiments, clicking on the headline 2517, the story 2519 or the photograph 2521 will cause the text of the article to be read out loud, including details about the letters, phonemes, or words learned, as well as the activity successfully completed.

It is further preferable, to the extent feasible, that the news article from the newspaper be sent to friends and family of the child via email or other messaging means, sharing the news article and accomplishments of the child.

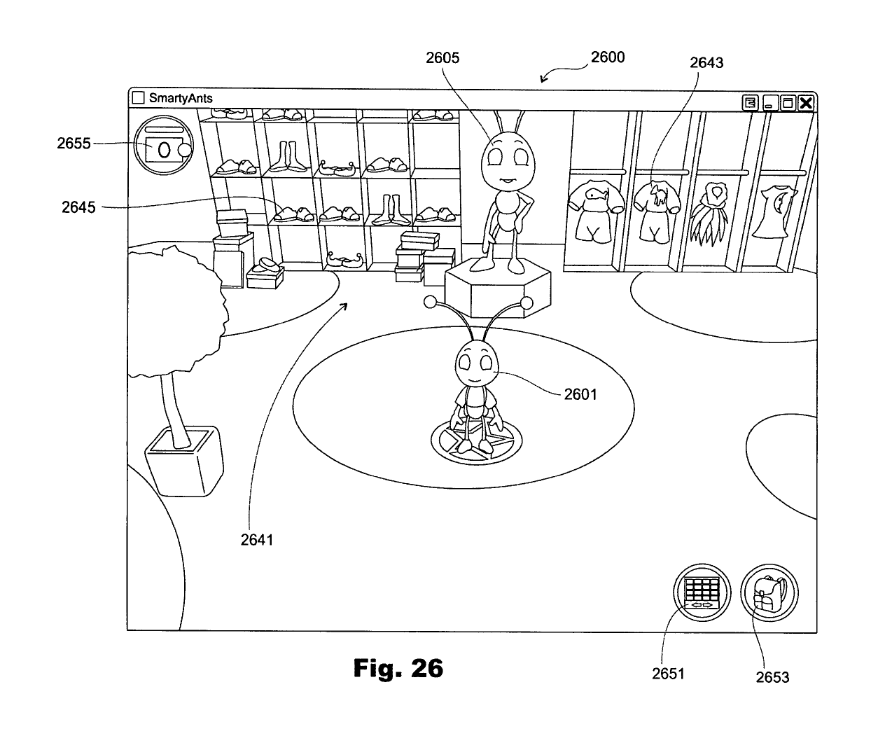

FIG. 26 is an illustration of a shopping screen 2600 according to one aspect of the computer-implemented method. Assuming that a child's avatar 2601 has sufficient virtual currency, one or more articles for purchase 2641 such as a shirt 2643 or shoes 2645 can be purchased from the virtual store. It is further preferable to have a coach 2605 to assist the child avatar 2601 with purchases. The child's avatar 2601 will immediately wear any purchased items or be available in the child's avatar 2601 inventory window 761 (FIG. 7). Items at the virtual store can be purchased for the child, for friends of the child, of the child's dog, for example.

Like other screens within the virtual world, it is preferable to provide a button 2651 to allow the child to return to the activities board screen 500 (FIG. 5), a button 2653 to invoke an inventory window 761 to view the inventory of the child's backpack and current belongings, and a button 2655 to review the value of the child's virtual debit card.

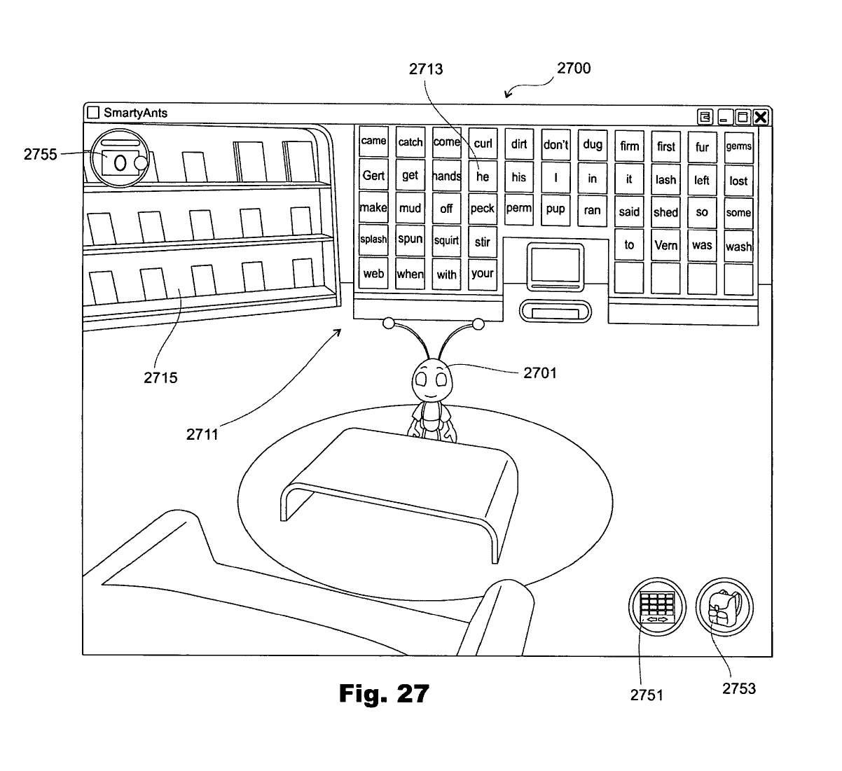

FIG. 27 is an illustration of a trophy wall screen 2700 according to one aspect of the computer-implemented method. The main purpose of such a trophy wall 2711 is to provide the child with an ongoing, fun, and visual picture of the progress of a child avatar 2701 through the structured curriculum. The virtual trophy wall 2711 is a multi-level structure, preferably with a plurality of shelves and compartments 2715 corresponding to the levels and lessons of the structured curriculum.

In preferred embodiments, a second set of shelves and compartments 2713 are provided to provide quick access to congratulatory videos that have been earned and previously viewed by the child's avatar 2701.

Similar to other activity and reward screens, it is preferable to provide a button 2751 to allow the child to return to the activities board screen 500 (FIG. 5), a button 2753 to invoke an inventory window 761 (FIG. 7) to view the inventory of the child's backpack, and a button 2755 to review the value of the child's virtual debit card.

In one aspect, a trophy tower with 11 stories may be presented, where the 11 stories correspond to the 11 levels of the curriculum structure. Upon successful completion of a level, the child may receive a trophy in a virtual graduation ceremony. Multiple trophies may be awarded for each level. As various trophies are earned by successful completion of a level, they are added to the trophy tower at the appropriate level. In one aspect, the child can access a particular level of the trophy tower by way of an elevator and thus may reach various levels from 1 to 11 based on successful completion of the level.

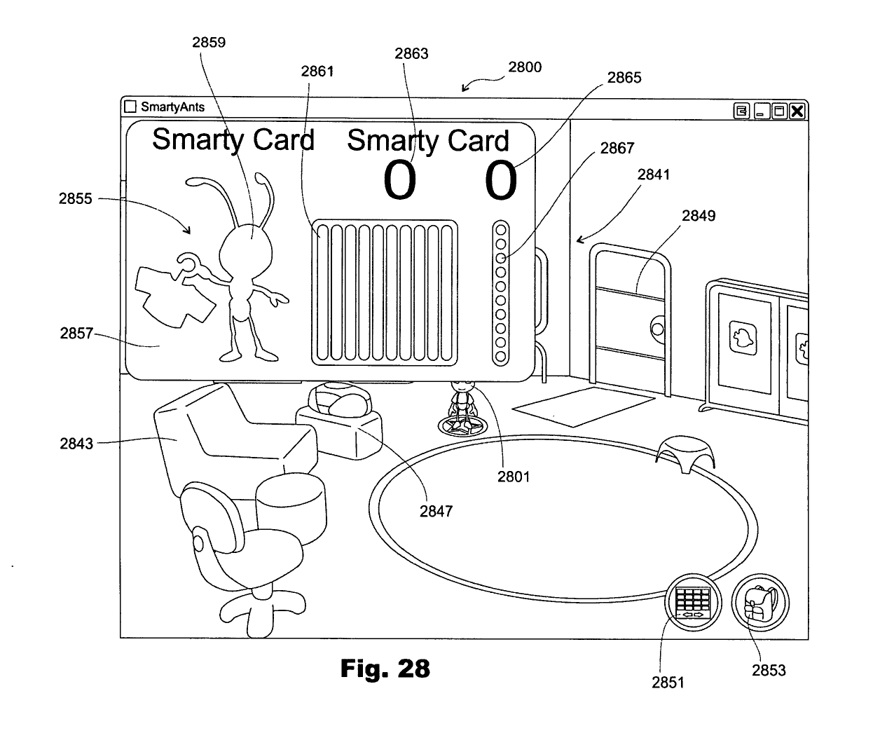

FIG. 28 is an illustration of a debit card screen 2800 according to one aspect of the computer-implemented method. As illustrated with an avatar home 2841 in the background containing a child avatar 2801, a chair 2843, a radio 2847, and a door 2849, the debit card information 2855 is displayed in a debit card window 2857. Cumulatively, the debit card window 2857 displays a representation of the child avatar's current currency. The currency is shown divided into a tens count 2863 and a ones count 2865, with a tens columns 2861 and a ones column 2867 arranged as a visual representation. This method of representation is designed to be both transparent and educational for children with limited understanding of concepts of numbers.

Preferably, when coins are paid to a child's debit card, an animation can illustrate via animation the amount of coins earned and placed into the debit card (not shown). When the ones count 2865 and ones column 2867 fills up, an animation shows the transition of an entry in the tens count 2863 and tens columns 2861.

It is further preferable, similar to other activity and reward screens, to provide a button 2851 to allow the child to return to the activities board screen 500 (FIG. 5) and a button 2853 to invoke an inventory window 761 (FIG.) to view the inventory of the child's backpack.

### Fan Club

In preferred embodiments, it can be further motivating to a child to have a “fan club” or a selection of family members and friends that can receive regular updates of the achievements of the child. Such a fan club can be managed from administrative areas of the software by a parent. By way of example, a copy of the newspaper can be provided to the fan club on a regular basis (e.g., once a week) to report the recent achievements of the child. Preferably, depending upon the practical nature of the messaging architecture, the newspaper also can provide screenshots, audio or video files (or links to such files) such that members of the fan club can become more familiar in the achievements made by the child. Friends and relatives that receive a copy of the “Daily Woof” newspaper, which contains a virtual book can view and hear video associated with the virtual book.

### Computer Implementation

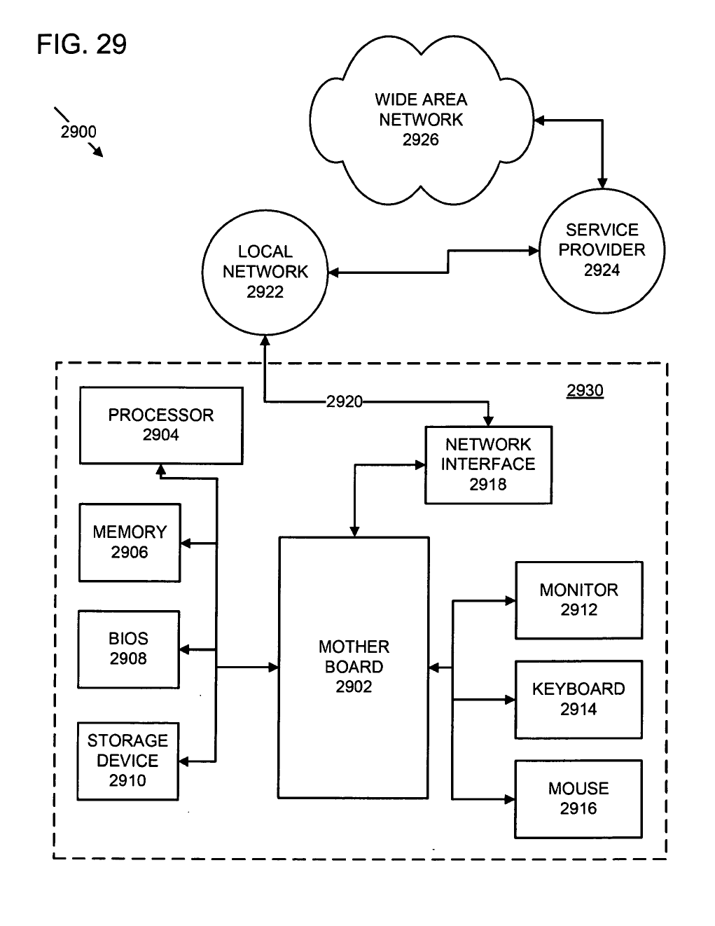

Turning to FIG. 29, a block diagram illustrates a computer 2900 upon which one aspect of the computer-implemented method may be implemented. Computer 2900 includes a motherboard 2902 or other communication mechanism for communicating information, and a processor 2904 coupled with motherboard 2902 for processing information. Computer 2900 also includes a memory 2906, such as a random access memory (RAM) or other dynamic storage device, coupled to motherboard 2902 for storing information and instructions to be executed by the processor 2904. Memory 2906 also may be used for storing temporary variables or other intermediate information during execution of instructions to be executed by processor 904. Computer 2900 further includes a basic input output system (BIOS) 2908 or other static storage device coupled to motherboard 2902 for storing static information and instructions for processor 2904. A storage device 2910, such as a magnetic disk or optical disk, is provided and coupled to bus 2902 for storing information and instructions.

The computer 2900 may be coupled via motherboard 2902 to a monitor 2912, such as a cathode ray tube (CRT) or liquid crystal display (LCD) for displaying information to a computer user. The computer 2900 may be coupled via the motherboard 2902 to a multimedia device to control a combination of text, audio, still images, animation, video, and interactivity content forms. The motherboard 2902 may be coupled to at least one speaker for communicating audio information to the user. A keyboard 2914, including alphanumeric and other keys is coupled to motherboard 2902 for communicating information and command selections to processor 2904. Another type of user input device is a mouse 2916, such as a mouse, a trackball, or cursor direction keys for communicating direction information and command selections to processor 2904 and for controlling cursor movement on monitor 2912. This input device typically has degrees of freedom in two axes, a first axis (e.g., x) and a second axis (e.g., y), that allows the device to specify positions in a plane. In one aspect, the capability of the mouse 2916 control can be tested by the user by throwing a ball to a dog. Another input device may be a microphone fro receiving audio information and commands from the user. Yet another input device may be a hand held pen-like device that can recognize text by way of optical character recognition, or which may be used as a pointing device in conjuction with a touch sensitive screen, pad, or the like. In other aspects, the user may use a finger or other anatomical element to enter information or commands into the computer 2900 via touch-sensitive (capative or otherwise) display devices, pads, and the like.

The interactive learning environment is related to the use of computer 2900 as a conduit for information transmission with a server 2930. Such information may, by way of example, include information regarding the selection of specific digital content to be purchased, payment information, delivery information or other information necessary to successfully perform the transaction. According to one embodiment of the invention, the information is provided by computer 2900 in response to processor 2904 executing one or more sequences of one or more instructions contained in memory 2906. Such instructions may be read into memory 2906 from another computer-readable medium, such as storage device 2910.

Execution of the sequences of instructions contained in memory 2906 causes processor 2904 to perform the process steps described herein. One or more processors in a multi-processing arrangement may also be employed to execute the sequences of instructions contained in memory 2906. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 2904 for execution. Such a medium may take many forms, including but not limited to, non-volatile media, volatile media, and transmission media. Non-volatile media includes, for example, optical or magnetic disks, such as storage device 2910. Volatile media includes dynamic memory, such as memory 2906. Transmission media includes coaxial cables, copper wire, and fiber optics, including the wires that comprise motherboard 2902. Transmission media also can take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable storage media may be involved in carrying one or more sequences of one or more instructions to processor 2904 for execution. For example, the instructions may initially be carried on a magnetic disk of a remote computer. Motherboard 2902 carries the data to and from memory 2906, from which processor 2904 retrieves and executes the instructions. The instructions received by memory 2906 may optionally be stored on storage device 2910 either before or after execution by processor 2904.

Computer 900 also includes a network interface 2918 coupled to motherboard 2902. Network interface 2918 provides a two-way data communication coupling to a network link 2920 that is connected to a local network 2922. For example, network interface 918 may be a digital subscriber line (DSL) modem, satellite dish, an integrated services digital network (ISDN) card or other data communication connection to a corresponding type of telephone line. As another example, communication interface 2918 may be a local area network (LAN) card effecting a data communication connection to a compatible LAN. Wireless communication means such as internal or external wireless modems may also be implemented.

In any such implementation, network interface 2918 sends and receives electrical, electromagnetic or optical signals that carry digital data streams representing various types of information, such as the selection of goods to be purchased, the information for payment of the purchase, or the address for delivery of the goods. Network link 2920 typically provides data communication through one or more networks to other data devices. For example, network link 2920 may effect a connection through local network 2922 to an Internet Host Provider (ISP) 2924 or to data equipment operated by ISP 2924. ISP 2924 in turn provides data communication services through the world wide packet data communication network now commonly referred to as the “Internet” 2926. Local network 2922 and Internet 2926 both use electrical, electromagnetic or optical signals that carry digital data streams. The signals through the various networks and the signals on network link 2920 and through network interface 2918, which carry the digital data to and from computer system 2900, are exemplary forms of carrier waves transporting the information.

Computer 2900 can send messages and receive data, including program code, through the network(s), network link 2920 and network interface 2918. In the Internet example, a server 2928 might transmit a requested code for an application program through Internet 2926, ISP 2924, local network 2922 and network interface 2918. In accordance with the invention, one such downloaded application provides for the selection, transaction, payment and delivery of goods as described herein. The received code may be executed by processor 2904 as it is received, and/or stored in storage device 2910, or other non-volatile storage for later execution. In this manner, computer 2900 may obtain application code in the form of a carrier wave.

### Instruction Methodology

The following is a description of one aspect of the instruction methodology that may be implemented in whole or in part as computer readable instructions (software) executable by the computer 2900 upon which one aspect of the computer-implemented method may be implemented. The instruction methodology as implemented by the computer 2900 may utilize the input device, the output device, among other elements of the computer 2900 previously explained in the present specification.

### LEVEL 3 (18 Books)

### Main Concept: CVC Words

Additional concepts: (1) “s” at end of word;

(2) ff, ll, ss, zz

Order of Phoneme Introduction

| | | | | | | | | | | | | | | | | | | | | | | | | | |
|---|---|---|---|---|---|---|---|---|---|---|---|---|---|---|---|---|---|---|---|---|---|---|---|---|---|
| A | B | C | D | E | F | G | H | I | J | K | L | M | N | O | P | Q* | R | S | T | U | V | W | X | Y | Z |

| | | | | | | | | | | | | | | | | | | | | | | | | | |
|---|---|---|---|---|---|---|---|---|---|---|---|---|---|---|---|---|---|---|---|---|---|---|---|---|---|
| Short /a/ | A¹ | | C¹ | | | F¹ | | | | | | | M¹ | N¹ | | P¹ | R¹ | | T¹ | | | | | | |
| (4 stories) | | | | | | | | | | | | | | | | | | | | | | | | | |
| Short /i/ | | | C | D¹ | | F | G¹ | H¹ | I¹ | | | | M | N | | P | R | | T | | | | | | |
| (4 stories) | | | | | | | | | | | | | | | | | | | | | | | | | |
| Cumulative | A | | C | D | | F | G | H | I | | | | M | N | | P | R | | T | | | | | | |
| (2-4 stories) | | | | | | | | | | | | | | | | | | | | | | | | | |
| Short /o/ | | B¹ | C | D | | F | G | H | | | | L¹ | M | N | O¹ | P | R | S¹ | T | | | | | | |
| (4 stories) | | | | | | | | | | | | | | | | | | | | | | | | | |
| Cumulative | A | B | C | D | | F | G | H | I | | | L | M | N | O | P | R | S | T | | | | | | |
| (2-4 stories) | | | | | | | | | | | | | | | | | | | | | | | | | |
| Short /e/ | | B | C | D | E¹ | F | G | H | | J¹ | K¹ | L | M | N | | P | R | S | T | | | | X¹ | Y¹ | |
| (4 stories) | | | | | | | | | | | | | | | | | | | | | | | | | |
| Cumulative | A | B | C | D | E | F | G | H | I | J | K | L | M | N | O | P | R | S | T | | | | X | Y | |
| (2-4 stories) | | | | | | | | | | | | | | | | | | | | | | | | | |
| Short /u/ | | B | C | D | | F | G | H | | J | K | L | M | N | | P | R | S | T | U¹ | V¹ | W¹ | X | Y | Z¹ |
| (4 stories) | | | | | | | | | | | | | | | | | | | | | | | | | |
| Cumulative | A | B | C | D | E | F | G | H | I | J | K | L | M | N | O | P | R | S | T | U | V | W | X | Y | Z |
| (2-4 stories) | | | | | | | | | | | | | | | | | | | | | | | | | |

¹Items marked with superscript ¹ indicate the initial use of a phoneme
Cumulative stories include all vowels and consonants learned up to that point
*There are no regular CVC words that use “q” (only qu . . . which make them 4-letter words)

### Word Banks

Short /a/ stories
All regular CVC words
   cam, can, cap, cat, fan, fat, man, map, mat, mam, nap, Nan, Nat, Pam, pan, pap, pat, ram, ran, rap, rat, tam, tan, tap, tat
Rimes
   an: tan, Nan, an, man, fan, can, ran
   ap: tap, nap, map, cap, rap, Pap
   am: tam, Pam, cam, ram
   at: tat, Nat, mat, fat, cat, rat
      Short /i/ stories
All regular CVC words
   Dig, dim, din, dip, fig, fin, fit, hid, him, hip, hit, mitt, nip, Tim, tin, tip, pig, pin, rid, rig, rim, rip
Rimes
   ig: dig, fig, pig, rig
   im: dim, him, rim
   in: din, fin, tin, pin
   ip: dip, hip, nip, tip, rip
   id: hid, rid
   it(t): fit, hit, mitt
      Cumulative stories (a, i)
All regular CVC words
   cam, can, cap, cat, fan, fat, man, map, mat, mam, nap, Nan, Nat, Pam, pan, pap, pat, ram, ran, rap, rat, tam, tan, tap, tat, dig, dim, din, dip, fig, fin, fit, hid, him, hip, hit, mitt, nip, Tim, tin, tip, pig, pin, rid, rig, rim, rip, dam, mad, cad, fad, pad, nag, Dan, dad, gam, gap, gag, had, hag, ham, hat
Rimes
   an: tan, Nan, an, man, fan, can, ran
   ap: tap, nap, map, cap, rap, Pap
   am: tam, Pam, cam, ram, dam, gam, ham
   at: tat, Nat, mat, fat, cat, rat, hat
   ad: dad, had, cad, mad, fad, pad
   ag: gag, hag, nag
   ig: dig, fig, pig, rig
   im: dim, him, rim
   in: din, fin, tin, pin
   ip: dip, hip, nip, tip, rip
   id: hid, rid
   it(t): fit, hit, mitt
      Short /o/ stories
All regular CVC words
   Bob, bog, bop, boss, bot, cob, cod, cog, con, cop, cot, dog, Don, dot, fob, fog, gob, got, hog, hop, hot, lob, log, lop, loss, lot, mob, mod, mom, mop, moss, nod, nog, not, pod, pop, pot, rob, rod, Ron, Ross, rot, sob, sod, Todd, odd, Tom, top, toss, tot
Rimes
   ob: Bob, cob, fob, bog, lob, mob, rob, sob
   og: bog, cog, dog, hog, log, nog
   op: bop, cop, hop, lop, mop, pop, top
   oss: boss, loss, toss, moss, Ross
   od(d): cod, mod, nod, pod, rod, sod, odd, Todd
   ot: bot, cot, dot, got, hot, lot, not, pot, rot, tot
   on: Don, Ron
   om: mom, Tom
      Cumulative stories (a, i, o)
All regular CVC words
   cam, can, cap, cat, fan, fat, man, map, mat, mam, nap, Nan, Nat, Pam, pan, pap, pat, ram, ran, rap, rat, tam, tan, tap, tat, dig, dim, din, dip, fig, fin, fit, hid, him, hip, hit, mitt, nip, Tim, tin, tip, pig, pin, rid, rig, rim, rip, dam, mad, cad, fad, pad, nag Dan, dad, gam, gap, gag, had, hag, ham, hat, Bob, bog, bop, boss, bot, cob, cod, cog, con, cop, cot, dog, Don, dot, fob, fog, gob, got, hog, hop, hot, lob, log, lop, loss, lot, mob, mod, mom, mop, moss, nod, nog, not, pod, pop, pot, rob, rod, Ron, Ross, rot, sob, sod, Todd, odd, Tom, top, toss, tot, bad, bag, barn, ban, bap, lab, lad, lag, lap, sad, sag, Sam, sap, cab, dab, fab, gab, nab, lass, mass, pass, gas, bib, bid, big, bin, lid, lip, Sid, sip, sis, dib, fib, hiss, miss, fill, Bill, mill, pill, nil, dill, gill, hill, sill, Lil
Rimes
   an: tan, Nan, an, man, fan, can, ran, ban
   ap: tap, nap, map, cap, rap, Pap, bap, lap, sap
   am: tam, Pam, cam, ram, dam, gam, ham, bam, Sam
   at: tat, Nat, mat, fat, cat, rat, hat
   ad: dad, had, bad, lad, sad, mad, cad, fad, pad
   ab: lab, cab, dab, fab, gab, nab
   as(s): lass, mass, pass, gas
   ag: gag, hag, bag, lag, sag
   ig: dig, fig, pig, rig, big
   ib: bib, dib, fib
   ill: fill, Bill, mill, pill, nil, dill, gill, hill, sill, Lil
   im: dim, him, rim
   in: din, fin, tin, pin, bin
   ip: dip, hip, nip, tip, rip, lip, sip
   id: hid, rid, bid, Sid, lid
   it(t): fit, hit, mitt
   is(s): miss, hiss, sis
   ob: Bob, cob, fob, bog, lob, mob, rob, sob
   og: bog, cog, dog, hog, log, nog
   op: bop, cop, hop, lop, mop, pop, top
   oss: boss, loss, toss, moss, Ross
   od(d): cod, mod, nod, pod, rod, sod, odd, Todd
   ot: bot, cot, dot, got, hot, lot, not, pot, rot, tot
   on: Don, Ron
   om: mom, Tom
      Short /e/ stories
All regular CVC words
   Bed, beg, Ben, Bess, bet, Deb, Del, den, Dex, fed, fell, fen, get, hem, hen, hep, hex, Jeb, Jed, Jeff, jell, Jen, jet, keg, Ken, led, leg, Len, Les, let, Meg, Mel, men, mess, met, Ned, Nel, net, Peg, pen, pep pet, red, rep, Rex, sell, set, Ted, tell, ten, Tess, tet, Tex, yell, yen, yep, yes, yet, ebb, Ed, egg
Rimes
   Ed: bed, fed, Jed, led, Ned, red, Ed
   Eg: beg, keg, leg, Meg, egg
   En: Ben, den, fen, hen, Jen, Ken, Len, men, pen, ten, yen
   Es(s): Bess, mess, Tess, Les
   Et: bet, get, jet, let, met, net, pet, set, tet
   Eb: ebb, Deb, Jeb
   El(l): Del, fell, jell, Mel, Nel, sell, tell, yell
   Ex: Dex, Rex, Tex
   Em: hem
   Ep: hep, pep, rep, yep
   Eff: Jeff
      Cumulative stories (a, i, o, e)
All regular CVC words
   cam, can, cap, cat, fan, fat, man, map, mat, mam, nap, Nan, Nat, Pam, pan, pap, pat, ram, ran, rap, rat, tam, tan, tap, tat, dig, dim, din, dip, fig, fin, fit, hid, him, hip, hit, mitt, nip, Tim, tin, tip, pig, pin, rid, rig, rim, rip, dam, mad, cad, fad, pad, nag Dan, dad, gam, gap, gag, had, hag, ham, hat, Bob, bog, bop, boss, bot, cob, cod, cog, con, cop, cot, dog, Don, dot, fob, fog, gob, got, hog, hop, hot, lob, log, lop, loss, lot, mob, mod, mom, mop, moss, nod, nog, not, pod, pop, pot, rob, rod, Ron, Ross, rot, sob, sod, Todd, odd, Tom, top, toss, tot, bad, bag, barn, ban, bap, lab, lad, lag, lap, sad, sag, Sam, sap, cab, dab, fab, gab, nab, lass, mass, pass, gas, bib, bid, big, bin, lid, lip, Sid, sip, sis, dib, fib, hiss, miss, fill, Bill, mill, pill, nil, dill, gill, hill, sill, Lil, Bed, beg, Ben, Bess, bet, Deb, Del, den, Dex, fed, fell, fen, get, hem, hen, hep, hex, Jed, Jeff, jell, Jen, jet, keg, Ken, led, leg, Len, Les, let, Meg, Mel, men, mess, met, Ned, Nel, net, Peg, pen, pep pet, red, rep, Rex, sell, set, Ted, tell, ten, Tess, tet, Tex, yell, yen, yep, yes, yet, ebb, Ed, egg, jab, jam, Jag, Jan, job, jog, Jon, jot, jiff, jig, Jill, Jim, kid, kill, Kim, kin, kip, kiss, kit, yak, box, fax, fix, fox, lax, lox, Max, mix, nix, pox, sax, six, tax, yam, yap, yip
Rimes
   an: tan, Nan, an, man, fan, can, ran, ban, Jan
   ap: tap, nap, map, cap, rap, Pap, bap, lap, sap, yap
   am: tam, Pam, cam, ram, dam, gam, ham, barn, Sam, jam, yam
   at: tat, Nat, mat, fat, cat, rat, hat
   ad: dad, had, bad, lad, sad, mad, cad, fad, pad
   ab: lab, cab, dab, fab, gab, nab, jab
   as(s): lass, mass, pass, gas
   ag: gag, hag, bag, lag, sag, Jag
   ax: fax, las, Max, sax, tax
   ak: yak
   iff: Jiff
   ig: dig, fig, pig, rig, big, jig
   ib: bib, dib, fib
   ill: fill, Bill, mill, pill, nil, dill, gill, hill, sill, Lil, Jill, kill
   im: dim, him, rim, Jim, Kim
   in: din, fin, tin, pin, bin, kin
   ip: dip, hip, nip, tip, rip, lip, sip, kip, yip
   id: hid, rid, bid, Sid, lid, kid
   ill: Jill,
   it(t): fit, hit, mitt, kit
   is(s): miss, hiss, sis, kiss
   ix: fix, mix, nix, six
   ob: Bob, cob, fob, bog, lob, mob, rob, sob, job
   og: bog, cog, dog, hog, log, nog, jog
   op: bop, cop, hop, lop, mop, pop, top
   oss: boss, loss, toss, moss, Ross
   od(d): cod, mod, nod, pod, rod, sod, odd, Todd
   ot: bot, cot, dot, got, hot, lot, not, pot, rot, tot, jot
   on: Don, Ron, Jon
   om: mom, Tom
   ox: box, fox, lox, pox
   Ed: bed, fed, Jed, led, Ned, red, Ed
   Eg: beg, keg, leg, Meg, egg
   En: Ben, den, fen, hen, Jen, Ken, Len, men, pen, ten, yen
   Es(s): Bess, mess, Tess, Les
   Et: bet, get, jet, let, met, net, pet, set, tet
   Eb: ebb, Deb, Jeb
   El(l): Del, fell, jell, Mel, Nel, sell, tell, yell
   Ex: Dex, Rex, Tex
   Em: hem
   Ep: hep, pep, rep, yep
   Eff: Jeff
      Short /u/ stories
All regular CVC words
   Bub, bud, buff, bug, burn, bun, bus, but, buzz, dub, dud, dug, dull, fuzz, gull, gum, gun, Gus, gut, hub, huff, hug, hull, hum, hut, jug, jut, lug, lull, mud, muff, mug, mull, mum, muss, mutt, nub, null, nun, nut, pub, puff, pug, pun, pup, pus, putt, rub, ruff, rug, rum, run, Russ, rut, sub, sum, sun, sup, tub, tug, turn, Tut, yum, yup
Rimes
   Ub: Bub, dub, hub, nub, pub, rub, sub, tub
   Ud: bud, dud, mud
   Uff: buff, huff, muff, puff, ruff
   Ug: bug, dug, jug, lub, mug, pug, rug, tug
   Urn: bum, gum, hum, mum, rum, sum, turn, yum
   Un: bun, gun, nun, pun, run, sun
   Us(s): bus, Gus, muss, pus, Russ
   Ut(t): but, gut, hut, jut, mutt, nut, putt, rut, Tut
   Ull: dull, gull, hull, lull, mull
   Up: up, pup, sup, yup
   Uz: buzz, fuzz
      Cumulative stories (a, i, o, e, u)
All regular CVC words
   cam, can, cap, cat, fan, fat, man, map, mat, mam, nap, Nan, Nat, Pam, pan, pap, pat, ram, ran, rap, rat, tam, tan, tap, tat, dig, dim, din, dip, fig, fin, fit, hid, him, hip, hit, mitt, nip, Tim, tin, tip, pig, pin, rid, rig, rim, rip, dam, mad, cad, fad, pad, nag Dan, dad, gam, gap, gag, had, hag, ham, hat, Bob, bog, bop, boss, bot, cob, cod, cog, con, cop, cot, dog, Don, dot, fob, fog, gob, got, hog, hop, hot, lob, log, lop, loss, lot, mob, mod, mom, mop, moss, nod, nog, not, pod, pop, pot, rob, rod, Ron, Ross, rot, sob, sod, Todd, odd, Tom, top, toss, tot, bad, bag, barn, ban, bap, lab, lad, lag, lap, sad, sag, Sam, sap, cab, dab, fab, gab, nab, lass, mass, pass, gas, bib, bid, big, bin, lid, lip, Sid, sip, sis, dib, fib, hiss, miss, fill, Bill, mill, pill, nil, dill, gill, hill, sill, Lil, Bed, beg, Ben, Bess, bet, Deb, Del, den, Dex, fed, fell, fen, get, hem, hen, hep, hex, Jed, Jeff, jell, Jen, jet, keg, Ken, led, leg, Len, Les, let, Meg, Mel, men, mess, met, Ned, Nel, net, Peg, pen, pep pet, red, rep, Rex, sell, set, Ted, tell, ten, Tess, tet, Tex, yell, yen, yep, yes, yet, ebb, Ed, egg, jab, jam, Jag, Jan, job, jog, Jon, jot, jiff, jig, Jill, Jim, kid, kill, Kim, kin, kip, kiss, kit, yak, box, fax, fix, fox, lax, lox, Max, mix, nix, pox, sax, six, tax, yam, yap, yip, Bub, bud, buff, bug, bum, bun, bus, but, buzz, dub, dud, dug, dull, fuzz, gull, gum, gun, Gus, gut, hub, huff, hug, hull, hum, hut, jug, jut, lug, lull, mud, muff, mug, mull, mum, muss, mutt, nub, null, nun, nut, pub, puff, pug, pun, pup, pus, putt, rub, ruff, rug, rum, run, Russ, rut, sub, sum, sun, sup, tub, tug, tum, Tut, yum, yup, van, vat, vim, Von, yen, vet, vex, wag, wax, wig, will, win, wit, web, wed, Wes, wet, zag, zap, zen, zig, zip, zit,
Rimes
   an: tan, Nan, an, man, fan, can, ran, ban, Jan, van
   ap: tap, nap, map, cap, rap, Pap, bap, lap, sap, yap, zap
   am: tam, Pam, cam, ram, dam, gam, ham, barn, Sam, jam, yam
   at: tat, Nat, mat, fat, cat, rat, hat, vat
   ad: dad, had, bad, lad, sad, mad, cad, fad, pad
   ab: lab, cab, dab, fab, gab, nab, jab
   as(s): lass, mass, pass, gas
   ag: gag, hag, bag, lag, sag, Jag, wag, zag
   ax: fax, las, Max, sax, tax, wax
   ak: yak
   iff: Jiff
   ig: dig, fig, pig, rig, big, jig, wig, zig
   ib: bib, dib, fib
   ill: fill, Bill, mill, pill, nil, dill, gill, hill, sill, Lil, Jill, kill, will
   im: dim, him, rim, Jim, Kim, vim
   in: din, fin, tin, pin, bin, kin, win
   ip: dip, hip, nip, tip, rip, lip, sip, kip, yip, zip
   id: hid, rid, bid, Sid, lid, kid
   ill: Jill,
   it(t): fit, hit, mitt, kit, wit, zit
   is(s): miss, hiss, sis, kiss
   ix: fix, mix, nix, six
   ob: Bob, cob, fob, bog, lob, mob, rob, sob, job
   og: bog, cog, dog, hog, log, nog, jog
   op: bop, cop, hop, lop, mop, pop, top
   oss: boss, loss, toss, moss, Ross
   od(d): cod, mod, nod, pod, rod, sod, odd, Todd
   ot: bot, cot, dot, got, hot, lot, not, pot, rot, tot, jot
   on: Don, Ron, Jon, Von
   om: mom, Tom
   ox: box, fox, lox, pox
   Ed: bed, fed, Jed, led, Ned, red, Ed, wed
   Eg: beg, keg, leg, Meg, egg
   En: Ben, den, fen, hen, Jen, Ken, Len, men, pen, ten, yen, ven, zen
   Es(s): Bess, mess, Tess, Les, Wes
   Et: bet, get, jet, let, met, net, pet, set, tet, vet, wet
   Eb: ebb, Deb, Jeb, web
   El(l): Del, fell, jell, Mel, Nel, sell, tell, yell
   Ex: Dex, Rex, Tex, vex
   Em: hem
   Ep: hep, pep, rep, yep
   Eff: Jeff
   Ub: Bub, dub, hub, nub, pub, rub, sub, tub
   Ud: bud, dud, mud
   Uff: buff, huff, muff, puff, ruff
   Ug: bug, dug, jug, lub, mug, pug, rug, tug
   Um: burn, gum, hum, mum, rum, sum, turn, yum
   Un: bun, gun, nun, pun, run, sun
   Us(s): bus, Gus, muss, pus, Russ
   Ut(t): but, gut, hut, jut, mutt, nut, putt, rut, Tut
   Ull: dull, gull, hull, lull, mull
   Up: up, pup, sup, yup
   Uz: buzz, fuzz

### LEVEL 4 (8 Books)

### Main Concept: CVCe Words

### Additional Concepts Order of CVCe Phoneme Introduction

| | |
|---|---|
| a_e | (2 books) |
| i_e | (2 books) |
| o_e | (2 books) |
| u_e | (1 book) |
| u_e | (1 book) |
| e_e | (0 books) |

a_e stories
All simple consonants: b c d f g h j k l m n p r s t v w x y z
All short vowels: a e i o u
All regular a_e words
   bade, bake, bale, bane, base, bate, cake, came, cane, cape, case, cave, Dale, dame, Dane, date, Dave, daze, fade, fake, fame, fate, fave, Gabe, gale, game, gape, gate, gave, hale, hate, jade, Jake, Jane, kale, Kate, lake, lame, lane, late, made, make, male, Mame, mane, mate, name, nape, Nate, pale, pane, pate, pave, rake, rate, rave, safe, sake, sale, same sane, sate, save, take, tale, tame, tape, vale, vane, vase, wade, wake, wane, wave
Rimes
   -abe: Gabe
   -ade: bade, fade, jade, made, wade
   -ake: bake, cake, fake, Jake, lake, make, rake, sake, take, wake
   -ale: bale, Dale, gale, hale, kale, male, pale, sale, tale, vale
   -ame: came, dame, fame, game, lame, Mame, name, same, tame
   -ane: bane, cane, Dane, Jane, lane, mane, pane, sane, vane, wane
   -ape: cape, gape, tape
   -ase: base, case, vase
   -ate: bate, date, fate, gate, hate, Kate, late, mate, Nate, pate, rate, sate
   -ave: Dave, fave, gave, pave, rave, save, wave
   -aze: daze, faze, maze, raze
      i_e stories
All simple consonants: b c d f g h j k l m n p r s t v w x y z
All short vowels: a e i o u
All regular a_e words
All regular i_e words
   bide, bike, bile, bite, dike, dime, dine, dire, dive, file, fine, fire, five, hide, hike, hire, hive, ire, jibe, jive, kite, life, like, lime, line, live (long /i/ sound), Mike, mile, mime, mine, mire, mite, Nile, nine, pike, pile, pine, ride, rife, rile, ripe, rise, rite, side, sire, site, size, tide, tile, time, tine, tire, vibe, vile, vine, wide, wine, wipe, wire, wise, yike, yipe
Rimes
   -ide: bide, hide, side, tide, wide
   -ile: bile, file, mile, Nile, pile, rile, tile, vile
   -ite: bite, kite, mite, rite, site
   -ime: dime, lime, mime, time
   -ine: dine, fine, line, mine, tine, vine, wine
   -ire: dire, fire, hire, mire, sire, tire, wire, ire
   -ive: dive, five, hive
   -ike: hike, like, Mike, pike, yike
   -ibe: jibe, vibe
   -ife: life, rife
   -ipe: ripe, wipe, yipe
   -ise: rise, wise
   -ize: size
      o_e stories
All simple consonants: b c d f g h j k l m n p r s t v w x y z
All short vowels: a e i o u
All regular a_e words, i_e words
All regular o_e words
   bode, bone, bore, code, coke, cone, cope, core, cove, dole, dome, dope, dote, dove (long /o/ sound . . . not the bird), doze, hole, home, hone, hope, hose, joke, jove, lode, lone, lope, lore, mode, mole, mope, more, mote, node, nope, nose, note, ode, poke, pole, pope, pore, pose, robe, rode, role, rope, rose, rote, rove, sole, sore, toke, tole, tome, tone, tore, tote, vole, vote, woke, wore, wove, yoke, zone
Rimes:
   -ode: bode, code, lode, mode, node, rode, ode
   -one: bone, cone, hone, lone, tone, zone
   -ore: bore, core, lore, more, pore, sore, tore, wore
   -oke: coke, joke, poke, toke, woke, yoke
   -ope: cope, dope, hope, lope, mope, nope, pope, rope
   -ove: cove, dove, jove, rove, wove
   -ole: dole, hole, mole, pole, role, sole, tole, vole
   -ome: dome, home, tome
   -oze: doze
   -ose: hose, nose, pose, rose
   -ote: mote, note, rote, tote
   -obe: robe
      u_e stories
All simple consonants: b c d f g h j k l m n p r s t v w x y z
All short vowels: a e i o u
All regular a_e words, i_e words, o_e words
All regular u_e words
   There are two sounds for u_e
      as in flute: Duke, dune, dupe, Jude, juke, June, jute, lube, Luke, lure, lute, nude, nuke, rude, rule, rune, ruse, tube, tune, yule
      as in cute: cube, cure, cute, fume, fuse, muse, mute, puke, pure, uke, use,
         Rimes (sound 1)
      -uke: Duke, juke, Luke, nuke
      -une: dune, June, rune, tune
      -upe: dupe
      -ude: Jude, nude, rude
      -ute: jute, lute
      -ube: lube, tube
      -ure: lure
      -ule: rule, yule
      -use: ruse
         Rimes (sound 2)
-ube: cube
-ure: cure, pure
-ute: cute, mute
-ume: fume
-use: fuse, muse
-uke: puke, uke
-use: use
   e_e stories (not enough words to make a story!)
All simple consonants: b c d f g h j k l m n p r s t v w x y z
All short vowels: a e i o u
All regular a_e words, i_e words, o_e words, u_e words
All regular e_e words
   here, meme, mere, mete, Pete, Zeke, eke, eve
Rimes
   -ere: here, mere
   -eme: meme
   -ete: mete, Pete
   -eke: Zeke, eke
   -eve: eve

### LEVEL 5 (3 Books)

Main Concept: Consonant Blends (introduce strategy)

### Beginning Consonant Blend Story

All regular CVC words with beginning consonant blends
   br-, cr-, dr-, fr-, gr- pr-, tr-, bl-, cl-, fl-, gl-, pl-, sl-, tw-, sc-, sk-, sm-, sn-, sp-, st-, sw-, scr-, scr-, squ-, str-, spr-
All regular CVCe words with beginning consonant blends from above. I didn't list these here because it's possible that we will stick this lesson before CVCe words
Recommendation:
   Stick mainly with the two-letter blends
Words (Lots of words fall into this category. Here is a large (fairly complete) sampling to help out, but you are free to use any other words that fit the above criteria.)
   Brad, brag, bran, brat, brig, brim, crab, crag, cram, crib, drab, drag, drat, drip, drop, drug, drum, Fran, frog, grab, grad, gram, Gram, Gran, Greg, grd, grim, grin, grip, grit, grub, pram, prep, prig, prim, prod, prom, prop, tram, trap, trim, trip, trod, trot, blab, blip, blob, blog, blot, clam, clan, clap, clip, clod, clog, clop, clot, club, flab, flag, flap, flat, fled, flit, flop, flub, glad, glib, glob, glom, glop, glum, glut, plan, pled, plod, plop, plot, plug, plum, slab, slag, slam, slap, slat, sled, slid, slim, slip, slit, slob, slog, slop, slot, slub, slug, slum, twig, twin, twit, scab, scam, scan, scat, scum, skid, skim, skin, skip, smog, smug, snag, snap, snip, snit, snob, snot, snub, snug, spam, spat, sped, spin, spit, spot, spud, spun, stab, stag, Stan, stem, step, stop, stub, stud, stun, swag, swig, swim, scrap, strip, strum, strut, strap, sprig

### Ending Consonant Blend Story

All regular CVC words with ending consonant blends
   -ct, -ft -ld, -lp, -lt, -mp, -nd, -nk, -nt, -pt, -sk, -sp, -st.
Words
   Band, bask, belt, bend, bent, best, bond, bonk, bump, bunt, bust, camp, cask, cast, cost, cult, duct, daft, damp, deft, dent, desk, disk, dump, dusk, dust, dent, fact, fast, felt, fend, fist, fond, font, fund, gasp, gulp, gust, hand, heft, held, help, hemp, hilt, hint, hump, hunt, husk, jest, jump, just, lamp, last, left, lend, lent, lest, lift, lilt, limp, lint, lisp, list loft, lost, lump, mask, mast, meld, melt, mend, mint, mist, musk, must, nest, pact, pant, past, pelt, pent, pest, pond, pump, punt, quest, raft, ramp, rant, rapt, rasp, rend, rent, rest, rift, risk, romp, rump, runt, rust, sand, sect, send, sent, sift, silt, soft, sump, tact, tamp, task, tend, tent, test, tint, tuft, tusk, vamp, vast, vend, vent, vest, weft, weld, welt, went, wept, west, wilt, wimp, wind (breeze, not like wind something up), wisp, zest

### Beginning and Ending Consonant Blend Story (Mixed

These words will take the form CCVCC
Words
   Brand, Brent, brisk, brunt, craft, cramp, crept, crest, crimp, crisp, crust, draft, drift, frisk, frond, frost, frump, graft, Gramp, grand, grant, grasp, grist, grump, grunt, primp, print, tract, tramp, trend, tromp, trump, trust, bland, blast, blend, blimp, blond, blunt, clamp, clasp, cleft, clomp, clump, flask, flint, glint, plant, plump, slept, slump, twist, scamp, scant, skimp, spend, spent, stamp, stand, stilt, stint, stomp, stump, stunt, swift, scrimp, strand, strict

### LEVEL 6 (8 Books)

Main Concept: Consonant Digraphs (introduce phonemes)

Rule about when to use -ck, -dge, -tch

Order of Phoneme Introduction

| | | |
|---|---|---|
| sh | (2 books) | |
| ch | (1 book) | |
| th | (1 book) | (two sounds: voiced as in this; unvoiced as in think) |
| wh | (1 book) | |
| ph | (0 book) | |
| -ck | (1 book) | |
| -tch | (1 book) | |
| -dge | (1 book) | |

sh stories
All regular CVC words (with any consonant blends . . . at beginning of words . . . br-, cr-, dr-, fr-, gr- pr-, tr-, bl-, cl-, fl-, gl-, pl-, sl-, tw-, thr-, sc-, sk-, sm-, sn-, sp-, st-, sw-, scr-, scr-, squ-, str-, spr- . . . and at the end of words . . . -ct, -ft -ld, -lp, -lt, -mp, -nd, -nk, -nt, -pt, -sk, -sp, -st. Just make sure that they are “regular” words (e.g., cold or mild would be “irregular” because of the long vowel sound, but held would be ‘regular’ because of the short vowel sound)
All regular CVCe words (with any consonant blends)
All regular sh words
   bash, cash, dash, dish, fish, gash, gosh, gush, hash, hush, lash, lush, mash, mosh, mush, nosh, posh, rash, rush, sash, wish, shad, shed, shod, shaff, shag, sham, shin, shun, ship, shop, shot, shut, shade, shake, shale, shame, Shane, shine, shone, shape, share, shore, shave, brash, brush, crash, crush, fresh, trash, blush, clash, flash, flesh, flush, plush, slash, slosh, slush, smash, stash, swish, squish, splash, splish, shift, shaft, shrimp, shank, shrank, shrink, shrunk,
rimes
   -ash: bash, cash, dash, gash, hash, ash, mash, rash, sash, brash, crash, trash, clash, flash, slash, smash, stash, splash
   -ish: dish, fish, wish, splish, squish, swish
   -osh: gosh, mosh, nosh, posh, slosh
   -ush: gush, hush, lush, mush, brush, crush, blush, flush, plush, slush
      ch story
All regular CVC words (with any consonant blends . . . at beginning of words . . . br-, cr-, dr-, fr-, gr- pr-, tr-, bl-, cl-, fl-, gl-, pl-, sl-, tw-, thr-, xc-, sk-, sm-, sn-, sp-, st-, sw-, scr-, scr-, squ-, str-, spr- . . . and at the end of words . . . -ct, -ft -ld, -lp, -lt, -mp, -nd, -nk, -nt, -pt, -sk, -sp, -st. Just make sure that they are “regular” words (e.g., cold or mild would be “irregular” because of the long vowel sound, but held would be ‘regular’ because of the short vowel sound)
All regular CVCe words (with any consonant blends)
All regular sh words (with any consonant blends)
All regular ch words (with any consonant blends)
   Chad, chaff, chap, chat, chess, Chet, chill, chin, chip, chit, chop, chug, chum, chafe, chase, chide, chime, chive, choke, chore, chose, chimp, champ, chump, chunk, chest, bench, branch, bunch, clinch, crunch, hunch, inch, lunch, much, munch, pinch, punch, quench, ranch, rich, such, trench
Rimes
   -ench: bench, quench, trench
   -unch: bunch, crunch, hunch, lunch, munch, punch
   -inch: clinch, inch, pinch
   -uch: much, such
   -anch: branch, ranch
      th story
All regular CVC words (with any consonant blends . . . at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, scr-, squ-, str-, spr- . . . and at the end of words . . . -ct, -ft -ld, -lp, -lt, -mp, -nd, -nk, -nt, -pt, -sk, -sp, -st. Just make sure that they are “regular” words (e.g., cold or mild would be “irregular” because of the long vowel sound, but held would be ‘regular’ because of the short vowel sound)
All regular CVCe words (with any consonant blends)
All regular sh words (with any consonant blends)
All regular ch words (with any consonant blends)
All regular th words (with any consonant blends)
   /th/ as in this: than, that, them, then, this, thus, bathe, lathe, these, lithe, tithe
   /th/ as in thing: thin, Thad, thud, thug, theft, thrift, thump, thomp, think, thank, thrash, thrush, bath, Beth, math, moth, path, pith, with, broth, froth, cloth, sloth
Rimes
   -athe: bathe, lathe
   -ath: bath, math, path
   -ith: with, pith
   -oth: moth, broth, froth, cloth, sloth
      wh story
All regular CVC words (with any consonant blends . . . at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, scr-, squ-, str-, spr- . . . and at the end of words . . . -ct, -ft -ld, -lp, -lt, -mp, -nd, -nk, -nt, -pt, -sk, -sp, -st. Just make sure that they are “regular” words (e.g., cold or mild would be “irregular” because of the long vowel sound, but held would be ‘regular’ because of the short vowel sound)
All regular CVCe words (with any consonant blends)
All regular sh words (with any consonant blends)
All regular ch words (with any consonant blends)
All regular th words (with any consonant blends)
All regular wh words (with any consonant blends)
   Wham, whap, when, whet, whiff, whim, whip, whiz, whelp, whomp, whisk, whisp, while, whine, white, whale, which
Rimes
   None
      ph story (probably won't be one)
All regular CVC words (with any consonant blends . . . at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, scr-, squ-, str-, spr- . . . and at the end of words . . . -ct, -ft -ld, -lp, -lt, -mp, -nd, -nk, -nt, -pt, -sk, -sp, -st. Just make sure that they are “regular” words (e.g., cold or mild would be “irregular” because of the long vowel sound, but held would be ‘regular’ because of the short vowel sound)
All regular CVCe words (with any consonant blends)
All regular sh words (with any consonant blends)
All regular ch words (with any consonant blends)
All regular th words (with any consonant blends)
All regular wh words (with any consonant blends)
All regular ph words (with any consonant blends)
   Phase, phone, graph, staph, Steph
      -ck story
All regular CVC words (with any consonant blends . . . at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr-
All regular sh words
All regular ch words
All regular th words
All regular wh words
All regular ph words
All regular -ck words (with any consonant blends)
   Back, buck, Dick, dock, duck, hack, heck, hick, hock, Huck, Jack, jock, lack, lick, lock, luck, Mick, mock, muck, neck, Nick, pack, peck, pick, puck, quack, quick, rack, Rick, rock, sack, sick, sock, suck, tack, tick, tock, tuck, Vick, wick, yuck, Zack, brick, crack, crick, crock, frock, prick, track, trick, truck, black, block, clack, click, clock, cluck, flack, fleck, flick, flock, pluck, slack, slick, smack, smock, snack, snuck, speck, Spock, stack, stick, stock, stuck, thick, whack, chick, check, Chuck, chock, shack, shuck, shock
Rimes
   -ack: back, hack, Jack, lack, pack, quack, rack, sack, tack, crack, track, black, clack, flack, slack, smack, snack, stack, whack, shack
   -uck: buck, duck, Huck, luck, muck, puck, suck, tuck, yuck, cluck, pluck, snuck, stuck, schuck
   -ick: Dick, hick, lick, Mick, Nick, pick, quick, Rick, sick, tick, Vick, wick, brick, crick, prick, trick, click, flick, slick, stick, thick, chick
   -ock: dock, hock, jock, lock, mock, rock, sock, tock, crock, frock, clock, clock, flock, smock, Spock, stock, chock, shock
   -eck: heck, neck, peck, fleck, speck, check
      -tch story
All regular CVC words (with any consonant blends . . . at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr-
All regular sh words
All regular ch words
All regular th words
All regular wh words
All regular ph words
All regular -tch words (with any consonant blends)
   Batch, bitch, botch, catch, ditch, Dutch, fetch, hatch, hitch, hutch, latch, match, Mitch, notch, patch, pitch, witch, thatch, crotch, crutch, blotch, klatch, clutch, glitch, scratch, snatch, snitch, stitch, switch
Rimes
   -atch: batch, catch, hatch, latch, match, patch, thatch, scratch, snatch
   -itch: bitch, ditch, hitch, Mitch, pitch, witch, glitch, snitch, stitch, switch
   -otch: botch, notch, crotch, blotch
   -utch: Dutch, hutch, crutch, clutch
   -etch: fetch
      -dge story
All regular CVC words (with any consonant blends . . . at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr-
All regular sh words
All regular ch words
All regular th words
All regular wh words
All regular ph words
All regular -ck words
All regular -tch words
All regular -dge words (with any consonant blends at the beginning)
   Badge, budge, dodge, fudge, lodge, judge, Madge, Midge, nudge, wedge, bridge, dredge, drudge, fridge, trudge, pledge, sledge, sludge, smudge
Rimes
   -adge: badge, Madge
   -udge: budge, fudge, judge, nudge, drudge, trudge, sludge, smudge
   -odge: dodge, lodge
   -idge: Midge, bridge, fridge
   -edge: wedge, dredge, pledge, sledge

### LEVEL 7 (3 Books)

Main Concept: r-controlled vowels
Additional Concepts Concept of vowel /y/ in one syllable words

Order of Phoneme Introduction

| | |
|---|---|
| ar | (1 book) |
| or | (1 book) |
| ir | (introduce the remaining three together; 1 book with all three) |
| er | |
| ur | |

“ar” story
Any consonant blends . . . at beginning of words . . . br-, cr-, dr-, fr-, gr- pr-, tr-, bl-, cl-, fl-, gl-, pl-, sl-, tw-, thr-, sc-, sk-, sm-, sn-, sp-, st-, sw-, scr-, scr-, squ-, str-, spr- . . . and at the end of words . . . -ct, -ft -ld, -lp, -lt, -mp, -nd, -nk, -nt, -pt, -sk, -sp, -st.
The following digraphs: sh, ch, th, wh, ph
Single-syllable, open-syllable words with vowel /y/: by, cry, dry, fly, fry, my, pry, shy, sky, sly, spy, try, why
New phonemes
   For letter c: /s/ as in city
   For letter g: /j/ as in gem
   For letter s: /z/ as in has
All regular “ar” words
   bar, Barb, bard, barf, bark, barn, bar, Bart, card, Carl, carp, car, cart, carve, dark, darn, dart, farm, far, fart, garb, hard, hark, harm, harp, jar, Karl, lard, lark, Lars, mar, Mark, mark, mart, park, par, part, quark, tar, tarp, tart, yard, yarn, Clark, scarf, smart, snarl, spark, star, start, char, spar, shark, stark, arm, charm, sharp, chart
Rimes
   -ar: bar, car, far, jar, mar, par, tar, star, char, spar
   -arb: Barb, garb
   -ard: bard, hard, card, lard, yard
   -arf: arf, barf, scarf
   -ark: bark, dark, hark, lark, Mark, mark, park, quark, Clark, spark, shark
   -arn: barn, darn, yarn
   -arl: Carl, Karl, snarl
   -arp: carp, harp, tarp, sharp
   -art: cart, dart, fart, mart, part, tart, smart, start, chart
   -arm: farm, harm, charm, arm
      “or” story
Any consonant blends . . . at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, scr-, squ-, str-, spr- . . . and at the end of words . . . -ct, -ft -ld, -lp, -lt, -mp, -nd, -nk, -nt, -pt, -sk, -sp, -st.
The following digraphs: sh, ch, th, wh, ph
Single-syllable, open-syllable words with vowel /y/: by, cry, dry, fly, fry, my, pry, shy, sky, sly, spy, try, why
Second sounds for c, g, s
All regular “ar” words
All regular “or” words
   Born, cord, cork, corn, dork, dorm, ford, fork, form, for, fort, horn, lord, morn, Mort, norm, pork, port, sort, torn, tort, worn, York, scorn, snort, sport, shorn, short, porch, torch, scorch, morph, thorn, stork, storm
Rimes:
   -orn: bord, corn, horn, morn, torn, worn, scorn, shorn, thorn
   -ork: cork, dork, fork, pork, York, stork
   -orm: dorm, form, norm, storm
   -ort: fort, port, sort, snort, sport, short
   -ord: lord, cord, ford
   -orch: porch, torch, scorch
      “er, ir, ur” story (one story using all three)
Any consonant blends . . . at beginning of words . . . br-, cr-, dr-, fr-, gr- pr-, tr-, bl-, cl-, fl-, gl-, pl-, sl-, tw-, thr-, sc-, sk-, sm-, sn-, sp-, st-, sw-, scr-, scr-, squ-, str-, spr- . . . and at the end of words . . . -ct, -ft -ld, -lp, -lt, -mp, -nd, -nk, -nt, -pt, -sk, -sp, -st.
The following digraphs: sh, ch, th, wh, ph
Single-syllable, open-syllable words with vowel /y/: by, cry, dry, fly, fry, my, pry, shy, sky, sly, spy, try, why
Second sounds for c, g, s
All regular “ar” words
All regular “or” words
All regular “er” words
   Berg, berm, Bert, fern, Gert, her, Herb, herb, herd, Herm, jerk, nerd, nerf, perk, perm, pert, per, Serb, term, verb, Vern, clerk, germ, stern (I think you can also use nerve, serve, swerve, even though they have an e at the end)
All regular “ir” words
   Bird, Dirk, dirt, firm, mirth, quirk, twirp, birth, girth, flirt, shirt, skirt, squirt, girl, swirl, twirl, whirl, shirk, smirk, third, fir, sir, stir, whir, first, thirst
All regular “ur” words
   Fur, blur, slur, spur, curb, blurb, curl, furl, hurl, burn, turn, churn, spurn, lurk, murk, curt, hurt, blurt, spurt (I think you can also use curse, nurse, purse, even though they have an e at the end)
Rimes
   -erb: herb, Herb, verb
   -erk: jerk, clerk
   -erm: germ, term
   -em: fern stern
   -erve: nerve, serve, swerve
   -ir: fir, sir, stir, whir
   -ird: bird, third
   -irk: quirk, shirk, smirk
   -irl: girl, swirl, twirl, whirl
   -irst: first, thirst
   -irt: dirt, flirt, shirt, skirt, squirt
   -irth: birth, girth
   -ur: fur, blur, slur, spur
   -url: curl, furl, hurl
   -urn: burn, turn, churn, spurn
   -urk: lurk, murk
   -urse: purse, nurse, curse
   -urt: curt, hurt, blurt, spurt

### LEVEL 8 (4 Books)

Main Concepts: -Letter Combinations ing, ang, ong, ung
-Letter Combinations ink, ank, onk, unk
-Alternate sound of c
-Alternate sound of g
   “ing, ang, ong, ung” story
   word bank (organized in rimes)
Bing, ding, king, Ming, ping, ring, sing, ting, wing, zing, bring, cling, fling, sling, sting, swing, string, spring, thing
Bang, fang, hang, pang, rang, sang, clang, slang, twang, sprang
Bong, gong, Hong Kong, long, pong, song, tong, prong, thong
Hung, lung, rung, sung, clung, flung, slung, stung, swung, strung, sprung
   “ink, ank, onk, unk” story
   word bank (organized in rimes)
Fink, jink, kink, link, mink, pink, rink, sink, wink, brink, drink, blink, clink, plink, slink, stink, think, shrink
Bank, dank, Hank, rank, sank, tank, crank, drank, prank, blank, clank, flank, spank, thank, shank
Bonk, honk
Bunk, dunk, funk, gunk, hunk, junk, punk, sunk, drunk, trunk, clunk, flunk, slunk, plunk, skunk, spunk, stunk, chunk
   “Alternate sound for c” story (Since we are limited to one-syllable words, there are not that many . . . not sure about making books out of these, but they need to have practice with a few of them somehow)
   Word bank
Cell, cent, cinch, face, force, fence, glance, grace, ice, lace, mice, mince, pace, place, prince, race, rice, since, slice, space, spruce, trace, truce, twice
   “Alternate sound for g” story
   Word bank
Gem, age, cage, forge, fringe, hinge, huge, large, page, rage, stage, wage

### LEVEL 9 (12 Books)

### Main Concept: Complex Vowels

Additional Concepts: -Concept that ay is the most common way to make the long sound of /a/at the end of a one syllable word (e.g., day, hay, say)
-Concept that oy is the most common way to make /oi/ sound at the end of a one-syllable word (e.g., boy, toy, ploy)
-After children read the “ea” (as in meat) book, there should be a quick info-lesson on the fact that “ea” sometimes has a different sound: “ea” as in breath, lead, dead, etc.; no book necessary)

Order of Complex Vowel Introduction

| | | |
|---|---|---|
| ee | as in feet | (1 book) |
| ea | as in eat | (1 book) |
| ai | as in rain | (1 book) |
| ay | as in day | (1 book) |
| oa | as in boat | (1 book) |
| ou | as in ouch | (1 book) |
| oo | as in moon | (1 book) |
| oo | as in book | (1 book) |
| oi | as in coin | (1 book) |
| oy | as in boy | (1 book) |
| ow | as in cow | (1 book) |
| ow | as in low | (1 book) |

“ee” story
All phonemes, including second sound for c, g, s
Digraphs: sh, ch, th, wh, ph, -ck, -tch, -dge
All consonant blends (at beginning of words . . . br-, cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nk, -nt, -pt, -sk, -sp, -st.
All r-controlled vowels (ar, or, er, ir, ur)
All regular “ee” words
   Beef, beep, beer, bee, beet, deem, deep, deer, feed, feel, fee, feet, gee, geez, heed, heel, hee, jeep, jeer, keel, keen, keep, leek, leer, meek, meet, need, pee, peek, peel, peep, peer, queen, reed, reef, reek, seed, seek, seen, seep, teem, tee, teen, veer, weed, wee, week, weep
   Sheen, sheep, sheer, sheet, cheek, cheep (bird sound), cheer, beech (tree), teeth, wheel
   Breed, Bree, creed, creek, creel, creep, free, greed, Greek, green, greet, preen, tree, bleed, bleep, flee, fleet, glee, sleek, sleep, sleet, tweet, three, sneer, speed, steed, steep, steer, sweep, sweet, screech, screen, tweed
Rimes
   -eep: beep, deep, jeep, keep, peep, seep, weep, bleep, sleep, sweep, steep
   -eer: beer, deer, leer, peer, veer, sheer, cheer, steer
   -ee: bee, fee, gee, hee, pee, wee, tee, tree, flee, free, three
   -eet: beet, feet, meet, sheet, greet, fleet, sleet, tweet, sweet
   -eem: deem, teem
   -eed: feed, heed, need, reed, seed, weed, breed, creed, greed, bleed, speed, steed, tweed
   -eel: feel, heel, keel, peel, wheel, creel
   -een: keen, queen, seen, sheen, teen, green, preen, screen
   -eek: leek, meek, peek, reek, seek, week, cheek, creek, Greek, sleek
   -eef: beef, reef
      “ea” story
All phonemes, including second sound for c, g, s
Digraphs: sh, ch, th, wh, ph, -ck, -tch, -dge
All consonant blends (at beginning of words . . . br-, cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nk, -nt, -pt, -sk, -sp, -st.
All r-controlled vowels (ar, or, er, ir, ur)
All regular “ee” words
All regular “ea” words
   Beak, beam, bean, beat, deal, Dean, dear, fear, feat, heal, heap, hear, heat, lead, leaf, leak, lean, leap, meal, mean, meat, Neal, neap, near, neat, pea, peak, peat, read, real, ream, reap, rear, seal, seam, sear, seat, tea, teak, teal, team, tear, veal, weak, wean, year, zeal
   Shear, leash, cheap, wheat
   Cream, dream, treat, bleak, bleat, clean, clear, cleat, freak, glean, plead, pleat, tweak, sneak, speak, steal, steam, scream, squeal, squeak, streak, stream
Rimes
   -eak: beak, freak, leak, peak, teak, weak, bleak, freak, tweak, sneak, speak, squeak, streak
   -eam: beam, ream, seam, cream, dream, steam, scream, stream
   -ean: bean, Dean, lean, mean, wean, clean, glean
   -eal: deal, heal, meal, real, seal, teal, zeal
   -ear: dear, fear, hear, near, rear, sear, tear, shear
   -eat: feat, heat, meat, neat, peat, seat, wheat, treat, bleat, cleat, pleat
   -eap: heap, leap, neap, reap, cheap
   -ead: lead, read, plead
      “ai” story (Rachael already did this one)
      “ay” story
All phonemes, including second sound for c, g, s
Digraphs: sh, ch, th, wh, ph, -ck, -tch, -dge
All consonant blends (at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nk, -nt, -pt, -sk, -sp, -st.
All r-controlled vowels (ar, or, er, ir, ur)
All regular “ee” words
All regular “ea” words
All regular “ai” words
All regular “ay” words
   Bay, day, gay, hay, jay, Kay, lay, may, nay, pay, ray, say way, yay, bray, fray, gray, pray, tray, clay, flay, play, slay, stay, sway, stray, spray
Rimes
   They all rhyme because “ay” is the way we spell the long sound of /a/ at the end of one syllable words
      “oa” story
All phonemes, including second sound for c, g, s
Digraphs: sh, ch, th, wh, ph, -ck, -tch, -dge
All consonant blends (at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nk, -nt, -pt, -sk, -sp, -st.
All r-controlled vowels (ar, or, er, ir, ur)
All regular “ee” words
All regular “ea” words
All regular “ai” words
All regular “ay” words
All regular “oa” words
   Oat, oaf, oak, oar, Boat, boar, coal, coat, coax, foal, shoal, foam, goad, goal, goat, load, loaf, loam, loan, moan, moat, road, roam, roan, roar, soak, soap, soar, toad, croak, float, gloat, throat, boast, coast, roast, toast, coach, poach, roach, broach, cloak, Joan, whoa
Rimes
   -oat: oat, boat, coat, goat, moat, gloat, throat
   -oal: coal, foal, goal, shoal
   -oad: goad, load, road, toad
   -oam: foam, loam, roam
   -oan: Joan, loan, moan, roan
   -oar: oar, boar, roar, soar
   -oak: soak, croak, cloak
   -oast: boast, coast, roast, toast
   -oach: coach, poach, roach, broach
      “ou” (as in ouch) story
All phonemes, including second sound for c, g, s
Digraphs: sh, ch, th, wh, ph, -ck, -tch, -dge
All consonant blends (at beginning of words . . . br-, cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nk, -nt, -pt, -sk, -sp, -st.
All r-controlled vowels (ar, or, er, ir, ur)
All regular “ee” words
All regular “ea” words
All regular “ai” words
All regular “ay” words
All regular “oa” words
All regular “ou” words
   Our, out, bout, foul, gout, loud, lout, pout, rout, sour, tout, shout, crouch, grout, grouch, proud, trout, cloud, couch, pouch, vouch, flout, flour, slouch, scour, scout, snout, spout, stout, sprout, bound, found, hound, mound, pound, round, sound, wound, ground, fount, mount, roust, shout, mouth, south, count, noun, ouch
Rimes
   -our: our, sour, flour, scour
   -out: out, bout, gout, lout, pout, rout, tout, trout, flout, snout, spout, stout, sprout, shout
   -oud: loud, proud, cloud
   -ouch: ouch, crouch, grouch, couch, vouch, pouch, slouch
   -ound: bounch, found, hound, mound, pound, round, sound, wound, ground
   -cunt: fount, mount, count
   -outh: mouth, sout
      “oo” (2 sounds; 1 book—as in moon . . . as in book) story
All phonemes, including second sound for c, g, s
Digraphs: sh, ch, th, wh, ph, -ck, -tch, -dge
All consonant blends (at beginning of words . . . br-, cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
All r-controlled vowels (ar, or, er, ir, ur)
All regular “ee” words
All regular “ea” words
All regular “ai” words
All regular “ay” words
All regular “oa” words
All regular “ou” words
All regular “oo” words (as in moon)
   boob, boom, boon, boot, booth, cool, coop, coot, doom, food, fool, goof, goon, goop, hoop, hoot, loom, loon, loop, loot, mood, moon, moot, mooch, noon, poof, pool, poop, pooch, room, root, soon, tool, tooth, vroom, wool, zoom, zoot, shoot, whoop, whoosh, brood, broom, brooch, croon, droop, groom, gloom, scoop, scoot, smooch, smooth, snoop, spook, spool, spoon, spoof, stoop, swoon, swoop, boost, roost, stool, drool, boo, moo, woo, goo, poo, too, zoo, shoo, swoon, coon, sloop, troop, pool, bloom, toot
Rimes
   -oom: boom, doom, loom, room, vroom, zoom, broom, groom, gloom, bloom
   -oon: boon, goon, loon, moon, noon, soon, spoon, croon, swoon, coon
   -oot: boot, coot, hoot, loot, moot, root, zoot, shoot, scoot, toot
   -ool: cool, fool, tool, wool, spool, drool, stool, pool
   -oop: coop, goop, hoop, loop, poop, whoop, droop, scoop, snoop, stoop, swoop, sloop, troop
   -ood: food, brood, mood
   -oof: goof, poof, spoof
   -ooch: mooch, pooch, brooch, smooch
   -ooth: tooth, booth, smooth (don't rhyme perfectly)
   -oost: boost, roost
   -oo boo, moo, woo, goo, poo, too, zoo, shoo
All regular “oo” words (as in book)
   Book, cook, foot, good, hood, hook, look, nook, rook, soot, took, wood, shook, brook, crook, stood
Rimes
   -ook: book, cook, hook, look, nook, rook, took, shook, brook, crook
   -ood: good, hood, wood, stood
   -oot: foot, soot
      “oi” story
All phonemes, including second sound for c, g, s
Digraphs: sh, ch, th, wh, ph, -ck, -tch, -dge
All consonant blends (at beginning of words . . . br-, cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
All r-controlled vowels (ar, or, er, ir, ur)
All regular “ee” words
All regular “ea” words
All regular “ai” words
All regular “ay” words
All regular “oa” words
All regular “ou” words
All regular “oo” words (as in moon)
All regular “oi” words
   Boil, oil, coil, coin, foil, foist, hoist, join, joist, joint, loin, moist, point, roil, roil, toil, void, choice, broil, voice, spoil, groin, noise, poise
   Rimes
      -oil: oil, boil, coil, foil, soil, toil, broil, spoil
      -oin: coin, join, loin, groin
      -oint: point, joint
      -oise: noise, poise
      -oist: foist, hoist, moist
      -oice: choice, voice
         “oy” story
All phonemes, including second sound for c, g, s
Digraphs: sh, ch, th, wh, ph, -ck, -tch, -dge
All consonant blends (at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
All r-controlled vowels (ar, or, er, ir, ur)
All regular “ee” words
All regular “ea” words
All regular “ai” words
All regular “ay” words
All regular “oa” words
All regular “ou” words
All regular “oo” words (as in moon)
All regular “oi” words
All regular “oy” words
   Boy, joy, Roy, soy, toy, Troy, cloy, ploy
      “ow” (as in cow) story
All phonemes, including second sound for c, g, s
Digraphs: sh, ch, th, wh, ph, -ck, -tch, -dge
All consonant blends (at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
All r-controlled vowels (ar, or, er, ir, ur)
All regular “ee” words
All regular “ea” words
All regular “ai” words
All regular “ay” words
All regular “oa” words
All regular “ou” words
All regular “oo” words (as in moon)
All regular “oi” words
All regular “oy” words
All regular “ow” (as in cow) words
   Bow, cow, cowl, down, gown, fowl, jowl, town, how, howl, now, pow, sow, vow, wow, chow, brow, prow, prowl, plow, scow, owl, growl, crown, scowl, brown, clown, drown, frown
   Rimes
      -ow: bow, cow, how, now, sow, vow, brow, chow, plow, pow, wow, chow, prow, scow
      -owl: owl, fowl, howl, growl, prowl, scowl, jowl, cowl
      -own: down, gown, tow, brown, clown, crown, drown, frown
         “ow” (as in tow) story
All phonemes, including second sound for c, g, s
Digraphs: sh, ch, th, wh, ph, -ck, -tch, -dge
All consonant blends (at beginning of words . . . br-, cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
All r-controlled vowels (ar, or, er, ir, ur)
All regular “ee” words
All regular “ea” words
All regular “ai” words
All regular “ay” words
All regular “oa” words
All regular “ou” words
All regular “oo” words (as in moon)
All regular “oi” words
All regular “oy” words
All regular “ow” (as in cow) words
All regular “ow” (as in tow) words
   Bow, bowl, low, mow, mown, row, sow, sown, tow, show, crow, grow, blow, flow, flown, glow, slow, throw, thrown, snow, stow, blown, shown
   Rimes
      -ow: bow, low, row, sow, tow, show, crow, grow, blow, flow, know, glow, slow, throw, snow, stow
      -own: sown, shown, grown, blown, flown, thrown, shown, mown

### LEVEL 10 (8 Books)

### Main Concept: Polysyllabic Words

### Additional Concepts: Compound Words

Suffixes: -ed, -ing, -es, -er, -est (begin with vowels)
-ly, -less, -ful (don't begin with vowels)
Rules for adding suffixes that begin with a vowel
. . . to CVCe words (e.g., shake to shaking)
. . . to CVC words (e.g., tap to tapping)
Prefixes: un-, re-, dis-
Vowel “y” in polysyllabic words (e.g., candy)
Consonant-le words (e.g., -ple, -dle, -fle)

| | |
|---|---|
| Polysyllabic Words Overview | Compound, affixed, vowel y, consonant-le |
| | (6 syllable types) |
| Compound Words (1 book) | e.g., cowboy, cupcake, baseball |
| Suffixes (4 books: ed, ing; es, | -ed, -ing, -es, -er -est, -ly, less, -ful |
| and s (from Level 2); er, est; | |
| ly, less, ful | |
| Suffix Rules (1 book) | Adding VOWEL suffixes to CVCe words |
| | Adding VOWEL suffixes to CVC words |
| Prefixes (1 book) | Un-, re-, dis- |
| Consonant-le words (1 book) | -ble, -dle, -fle, -gle, -kle, -ckle, -ple, -sle, - |
| | tle, -zle |

Compound Word Book (1 book)
All phonemes, including second sound for c, g, s
Digraphs: sh, ch, th, wh, ph, -ck, -tch, -dge
All consonant blends (at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
All r-controlled vowels (ar, or, er, ir, ur)
All regular “ee” words
All regular “ea” words
All regular “ai” words
All regular “ay” words
All regular “oa” words
All regular “ou” words
All regular “oo” words (as in moon)
All regular compound words: There are SO many . . . too many for me to list. Here is a good start for you. If you need more, there are tons of lists online. Just be sure they are “regular” in pattern, and use just the skills listed above. Feel free to call me if you have questions:
   Lifetime, cannot, meantime, upside, fireworks, railroad, passport, skateboard, sometimes, schoolhouse, upstream, firefly, inside, plaything, footprint, uplift, homemade, without, backbone, scapegoat, southwest, meanwhile, nearby, seashore, keyboard, subway, horseback, sandstone, limestone, bootstrap, toothpick, township, toothbrush, cupcake, popcorn, pickup, bookcase, lukewarm, raincheck, weekend, hometown, backhand, backlog, backpack, bookend, bookshelf, bookstore, bookmark, forklift, lifeboat, lifeline, backspin, sidekick, backbite, backfire, background, textbook, keypad, pancake, daytime, upbeat, bedroom, blackout, uphill, upkeep, carpool, pinstripe, rainbow, update, upgrade, upheld, carload, carport, teacup, teamwork, dishcloth, dishpan, cardboard, carsick, fishnet, snowdrift, cartwheel, setback, mainland, caveman, raindrop, foothill . . .
      Suffix -ed/-ing book (1 book)
   All phonemes, including second sound for c, g, s
   Digraphs: sh, ch, th, wh, ph, -ck, -tch, -dge
   All consonant blends (at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
   All r-controlled vowels (ar, or, er, ir, ur)
   All regular “ee” words
   All regular “ea” words
   All regular “ai” words
   All regular “ay” words
   All regular “oa” words
   All regular “ou” words
   All regular “oo” words (as in moon)
   All regular compound words
   Suffix -ed, -ing words
      All words from all above lists that can take the -ed or -ing suffix . . . EXCEPT words that involve special rules, such as changing a y to i, doubling a consonant, or dropping an e.
      Examples of good choices: jumping/jumped, asking/asked, cleaning/cleaned, floating/floated, looking/looked
      Examples of bad choices: fried (change y to i), running (doubling consonant), riding (drop e)
         Suffix -es, -s book (1 book)
   All phonemes, including second sound for c, g, s
   Digraphs: sh, ch, th, wh, ph, -ck, -tch, -dge
   All consonant blends (at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
   All r-controlled vowels (ar, or, er, ir, ur)
   All regular “ee” words
   All regular “ea” words
   All regular “ai” words
   All regular “ay” words
   All regular “oa” words
   All regular “ou” words
   All regular “oo” words (as in moon)
   All regular compound words
   Suffix -ed, -ing words
   Suffix -es, -s words
      Important note: The suffixes -es and -s are used in two ways: (1) to change a verb (jump/jumps . . . and . . . catch/catches), and (2) to make a noun plural. I believe we are just explaining the plural use, but please check with Sarina beforehand to make sure.
      Use any noun from above word lists EXCEPT those with any added rule such as changing a y to i, doubling a consonant, or dropping an e
      use a good mix of words that take -es (nouns that end in s, z, ch, sh, and x) . . . and words that take -s (nouns ending in all other consonants).
      Examples of good choices for -es: bus(es), wish(es), beach(es), fox(es). I don't think there are any good words ending in “z” because you almost always double the “z” (quizzes, whizzes) and we don't want to confuse things with that
      Examples of bad choices for -es: fry/fries, house/houses
      Examples of good choices for -s: dog, cat, crib, plan
         Suffix -er/-est book (1 book)
   All phonemes, including second sound for c, g, s
   Digraphs: sh, ch, th, wh, ph, -ck, -tch, -dge
   All consonant blends (at beginning of words . . . br-, cr-, dr-, fr-, gr- pr-, tr-, bl-, cl-, fl-, gl-, pl-, sl-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
   All r-controlled vowels (ar, or, er, ir, ur)
   All regular “ee” words
   All regular “ea” words
   All regular “ai” words
   All regular “ay” words
   All regular “oa” words
   All regular “ou” words
   All regular “oo” words (as in moon)
   All regular compound words
   Suffix -ed, -ing words
   Suffix -es, -s words
   Suffix -er, -est words
      Important note: The suffix -er is used in two ways: (1) to change a verb (jump) to the “doer” of that verb (jumper), and (2) as a comparative (fast/faster). Our lesson teaches only way #2, so our book should be limited to that usage, in my opinion.
      Any adverb from above lists, but use same ground rules as used for -ed/-ing (i.e., use only regular words that won't involve any added rule such as changing a y to i, doubling a consonant, or dropping an e)
      Examples of good choices: faster/fastest; smarter/smartest; slower/slowest; harder/hardest
         Other good possibilities: loud, short, soon, cool, thick, long, soft, strong, dark, weak, sweet
      Examples of bad choices: shier/shiest; thinner/thinnest; tamer/tamest
         Suffix -ly/-less/-ful book (1 book)
   All phonemes, including second sound for c, g, s
   Digraphs: sh, ch, th, wh, ph, -ck, -tch, -dge
   All consonant blends (at beginning of words . . . br-, cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
   All r-controlled vowels (ar, or, er, ir, ur)
   All regular “ee” words
   All regular “ea” words
   All regular “ai” words
   All regular “ay” words
   All regular “oa” words
   All regular “ou” words
   All regular “oo” words (as in moon)
   All regular compound words
   Suffix -ed, -ing words
   Suffix -es, -s words
   Suffix -er, -est words
   Suffix -ly, -less, -ful
      Only use one-syllable words as the root
      Examples of good “ly” words: quickly, slowly, sadly, softly, hardly, safely, soundly, strongly, weakly, loudly, shortly, sweetly, mainly, mostly, nearly, lonely, badly, clearly
      Examples of bad “ly” words: happily, suddenly, surely, truly, easily, friendly
      Examples of good “ful” words: harmful, playful, thankful, useful, hopeful, joyful, helpful, bashful, stressful
      Examples of bad “ful” words: beautiful, powerful, wonderful
      Examples of good “less” words: aimless, armless, artless, boneless, bootless, barkless, cordless, harmless, jobless, joyless, legless, lifeless, luckless, painless
      Examples of bad “less” words: motherless, mindless, heartless, friendless
         Vowel suffix rules book
   All phonemes, including second sound for c, g, s
   Digraphs: sh, ch, th, wh, ph, -ck, -tch, -dge
   All consonant blends (at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
   All r-controlled vowels (ar, or, er, ir, ur)
   All regular “ee” words
   All regular “ea” words
   All regular “ai” words
   All regular “ay” words
   All regular “oa” words
   All regular “ou” words
   All regular “oo” words (as in moon)
   All regular compound words
   Vowel Suffix Rule (1 book)
      This rule uses “CVCe words” (drop the e) and “single syllable words ending in one consonant after one vowel” (double final consonant) Previous books will have shown kids the suffixes -ing, -ed, -er, -est, and how they are just added to most words. Now, they've had a lesson telling them that when they add one of these vowel suffixes to CVCe words, they need to drop the e first
      Your word bank is
         all CVCe words that can take these suffixes (they need to drop the final e when adding a vowel suffix)
         Good examples: bake, shake, time, glide
         And single syllable words (CVC or CCVC), ending in one consonant, after one vowel (they need to double the final consonant when adding a vowel suffix)
         Good examples:
         CVC: Pop/popped/popping; run/running; bet/betting; nod/nodded/nodding; big/bigger/biggest
         CCVC: step/stepped/stepping; shop/shopped/shopping; blot/blotted/blotting; Good examples: run/running; flap/flapped.
            Prefix book: un, mis, dis, re (1 book)
   All phonemes, including second sound for c, g, s
   Digraphs: sh, ch, th, wh, ph, -ck, -tch, -dge
   All consonant blends (at beginning of words . . . br-, Cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
   All r-controlled vowels (ar, or, er, ir, ur)
   All regular “ee” words
   All regular “ea” words
   All regular “ai” words
   All regular “ay” words
   All regular “oa” words
   All regular “ou” words
   All regular “oo” words (as in moon)
   All regular compound words
   Prefix words: your domain is all regular one-syllable words that fit with these prefixes
      Good choices
         Un: unbolt, unclean, unclip, unripe, unreal, unsafe, unplug, unjust, unpack, unreal, unwell, unlock, unfit, undress, unlike, unblock, unpaid, unload, unhook, unwise, uncut,
         Mis: misuse, misplace, mistake, mislead, mistreat, mishap, misprint, misjudge, misfire, misread, misled
         Dis: display, discard, disdain, disturb, dispute, disarm, dislike, displace, disband
         Re: repeat, recheck, refresh, reject, relax, return, restrain, rewrite, repay, refuse
            Consonant-le words (1 book)
   All phonemes, including second sound for c, g, s
   Digraphs: sh, ch, th, wh, ph, -ck, -tch, -dge
   All consonant blends (at beginning of words . . . br-, cr-, dr-, fr-, gr- pr-, tr-, bl-, cl-, fl-, gl-, pl-, sl-, tw-, thr-, sc-, sk-, sm-, sn-, sp-, st-, sw-, scr-, squ-, str-, spr- . . . and at the end of words . . . -ct, -ft -ld, -lp, -lt, -mp, -nd, -nt, -pt, -sk, -sp, -st.
   All r-controlled vowels (ar, or, er, ir, ur)
   All regular “ee” words
   All regular “ea” words
   All regular “ai” words
   All regular “ay” words
   All regular “oa” words
   All regular “ou” words
   All regular “oo” words (as in moon)
   All regular compound words
   Consonant -le words
      These will all be two-syllable words. Only use words where the first syllable is “closed” by a consonant . . . for example spark-kle, dim-ple, pur-ple are fine . . . but not ta-ble)
         -ble words: marble, crumble, shamble, thimble, mumble, jumble, ramble, tumble, nimble, gamble, rumble, stumble, bumble, garble, dribble
         -dle words: bundle, candle, dwindle, curdle, coddle, fiddle, girdle, griddle, huddle, hurdle, kindle, muddle, paddle, puddle, riddle, spindle, swindle
         -fle words: baffle, duffle, muffle, raffle, shuffle, sniffle, truffle, whiffle
         -gle words: angle, boggle, eagle, gargle, giggle, goggle, haggle, smuggle, snuggle, struggle, toggle, wiggle, wriggle . . . (there are a bunch of words that use ‘ing’ ‘ang’ and ‘ung’ with -gle that you probably shouldn't use, like single, spangle, strangle, tangle, tingle . . . because the “g” does double duty . . . too confusing)
         -kle: sparkle (the rest should not be used because they involve a ‘ck’ . . . shackle . . . where the “k” is doing double duty . . . or they involve “ink, ank” . . . ankle, tinkle . . . where the “k” is doing double duty again)
         -ckle: don't use these
         -ple: purple, ample, apple, cripple, dapple, dimple, pimple, sample, ripple, rumple, supple, temple, tipple, topple, trample, wimple
         -sle: don't use these
         -tle: battle, bottle, brittle, cattle, chortle, gentle, hurtle, kettle, little, mettle, mottle, rattle, scuttle, settle, shuttle, skittle, spittle, startle, throttle, turtle (don't use words like castle, rustle, thistle . . . where you don't hear the /t/)
         -zle: fizzle, drizzle, dazzle, frazzle, grizzle, muzzle, nozzle, sizzle, puzzle, swizzle

### LEVEL 11 (3 Books)

Main Concept: Two main reasons for using apostrophe
Contractions
Possessive's

| | |
|---|---|
| Contractions (1 book) | with am (e.g. I'm) |
| | with is/has (e.g., he's, that's) |
| | with would/had (e.g., I'd, you'd) |
| | with have (e.g., I've, you've) |
| | with will/shall (e.g., I'll, you'll, we'll) |
| | with not (e.g. can't, don't, won't) |
| | with us (e.g., let's) |
| Possesive's (1 book) | Mike's, Heather's, Rachael's, the dog's, |
| | etc. |
| Possessive Pronouns | My/mine; his/her, hers, your/s, our/s, |
| (0 or 1 book) | their/s |

Contraction Book (1 book)
Story can use any words/concepts taught up to this point
Contractions to use (have, am, is, are, will, not . . . are the contractions that the kids used in their lesson. Sarina used to the following contractions in her lesson
   he's, you'll, I've, they've, it's, Sam's, we're, they're, isn't, hasn't, I'm, we'll, they'll
Contractions word bank: You can use any of the words Sarina used, and others that are made with “have, am, is, are, will, not” to round out your story.
We need to make sure that the words “have” and “are” have been taught as sight words in earlier stories.
   Possessive Book (1 book)
I would make this book using only 's possessives (e.g., the dog's dish), NOT possessive pronouns (e.g., my, hers, our), which will be used throughout the books and don't need to be isolated
Possessive word bank: any noun that is “regular” . . . (avoid nouns that end in ‘s’)
   Examples of good choices: dog's, Mike's, dad's, pet's, rat's, man's, girl's

Most Frequent Words * (to be taught at every level)

| 1-25 | 26-50- | 51-75 | 76-100 | 101-125 | 126-150 | 151-175 | 176-200 | 201-225 | 226-250 | 251-275 | 276-300 |
|---|---|---|---|---|---|---|---|---|---|---|---|
| The² | Or | Will | Number | Over² | Say | Set | Try | High² | Saw² | Important | Miss |
| Of | One² | Up | No² | New² | Great² | Put² | King | Every | Left | Until | Idea² |
| And | Had | Other² | Way | Sound | Where² | End | Hand | Near | Don't² | Children | Enough² |
| A² | By | About² | Could² | Take | Help | Does² | Picture² | Add | Few² | Side | Eat |
| To² | Word² | Out | People² | Only² | Through² | Another² | Again² | Food | While | Feet | Facet² |
| In | But | Many² | My | Little | Much | Well | Change² | Between² | Along² | Car | Watch² |
| Is | Not | Then | Than | Work² | Before² | Large | Off | Own | Might² | Mile | Far |
| You² | What² | Them | First | Know² | Line | Must | Play | Below² | Close | Night² | Indian² |
| That | All² | These | Water² | Place | Right² | Big | Spell | County | Something² | Walk² | Really² |
| It | Were² | So² | Been² | Year | Too | Even² | Air² | Plant | Seem | White | Almost² |
| He | We | Some² | Call² | Live² | Mean | Such | Away² | Last | Next | Sea | Let |
| Was² | When | Her | Who² | Me² | Old² | Because² | Animal² | School² | Hard | Began² | Above² |
| For | Your² | Would² | Am | Back | Any² | Turn | House | Father² | Open² | Grow | Girl |
| On | Can | Make | Its | Give² | Same | Here | Point | Keep | Example | Took | Sometimes² |
| Are² | Said² | Like | Now | most² | Tell | Why | Page | Tree | Begin² | River² | Mountain² |
| As | There² | Him | Find² | Very² | Boy | Ask | Letter | Never | Life | Four² | Cut |
| With | Use | Into² | Long | After | Follow | Went | Mother² | Start | Always² | Carry² | Young² |
| His | An | Time | Down | Thing | Came | Men | Answer² | City | Those | State | Talk² |
| They² | Each | Has | Day | Our | Want² | Read | Found | Earth² | Both² | Once² | Soon |
| I | Which | Look | Did | Just | Show | Need | Study | Eye² | Paper² | Book | List |
| At | She² | Two² | Get | Name | Also² | Land | Still | Light² | Together² | Hear | Song |
| Be² | Do² | More | Come² | Good | Around² | Different | Learn² | Thought² | Got | Stop | Being² |
| This | How | Write² | Made | Sentence | Farm | Home | Should² | Head | Group² | Without | Leave |
| Have² | Their² | Go² | May | Man | Three | Us | America² | Under | Often² | Second² | Family |
| from² | If | see | part | think | small² | move² | world² | story | run | later² | It's |

* ²Items marked with superscript ² are “sight words” (i.e., they don't follow a pattern that we will have taught the kids in our curriculum, or there is no pattern). The others will be “sight words” only until the children have learned the letter sound correspondences contained within.
Note:
Read down the columns for proper order
Note:
The first 25 words make up about ⅓ of all printed material; the first 100 words make up about ½ of all printed material; the first 300 make up about ⅔ or all printed material.

### CONCLUSION

Unless otherwise indicated, all numbers expressing quantities used in the specification and claims are to be understood as being modified in all instances by the term “about” or “approximately.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. If specific results of any tests are reported in the technical disclosure, any numerical value inherently can contain certain errors necessarily resulting from the standard deviation found in the respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”, “in the case”, “by way of example”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Preferred aspects have described herein, including the best mode known for carrying out the computer-implemented method. Of course, variations will become apparent to those of ordinary skill in the art upon reading the foregoing description. It is expected that skilled artisans can employ such variations as appropriate, and it is intended for the computer-implemented method to be practiced otherwise than specifically described herein. Accordingly, the scope of the present disclosure encompasses all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

Furthermore, if any references have been made to patents and printed publications in this specification, then each of the above cited references and printed publications, if any, are herein individually incorporated by reference in their entirety.

In closing, it is to be understood that the various aspects of the computer-implemented method disclosed herein are illustrative of the principles associated therewith. Other modifications that may be employed are within the scope of the present disclosure. Thus, by way of example, but not of limitation, alternative configurations of the various aspects of the computer-implemented method may be utilized in accordance with the teachings herein. Accordingly, the computer-implemented method is not limited to that precisely as shown and described.

1-30. (canceled)

31. An interactive system for learning, comprising:
a computer comprising a processor, a memory, a storage device, a display device for displaying information to a user, an audio device for communicating audio information to the user, and an input device for receiving information and commands from the user, the computer provides an interactive learning environment, wherein the computer is operative to:
present a structured curriculum to a user via the display device, wherein the structured curriculum comprises a linear progression of educational topics divided into a plurality of levels, wherein each of the plurality of levels represents a specific topic of educational content, wherein each of the plurality of levels is further divided into the plurality of lessons;
present a lesson to the user via the display device in a current mode selected from a plurality of modes, wherein each of the plurality of lessons represents a sub portion of the specific topic of the educational content and wherein each of the plurality of modes comprises specific challenges to accomplish;
receive feedback from the user via the input device in an interactive manner until a challenge associated with the current mode is accomplished; and
advance to a subsequent mode when the challenge of the current mode is accomplished by the user.

32. The interactive system for learning of claim 31, wherein the computer is operative to provide educational content directed to learning a language.

33. The interactive system for learning of claim 32, wherein the computer is operative to provide at least one level of the structured curriculum directed to learning an alphabet associated with learning the language.

34. The interactive system for learning of claim 33, wherein the computer is operative to provide at least one level of the structured curriculum directed to learning words associated with learning the alphabet.

35. The interactive system for learning of claim 34, wherein the computer is operative to provide the plurality of modes to:
learn one or more specific phonemes associated with the alphabet;
build one or more buildable words with the one or more specific phonemes;
rhyme the one or more buildable words; and
identify on sight the one or more buildable words.

36. The interactive system for learning of claim 35, wherein to assist the user to learn one or more specific phonemes associated with the alphabet, the computer is operative to:
present on the display device a visual representation of at least one letter associated with a phoneme, the at least one letter forming a subset of letters for building a set of words to be learned at the at least one level of the structured curriculum;
generate by the audio device an audible representation of the phoneme associated with at least one letter;
select with the input device the visual representation of at least one letter that the user believes is associated with the audible representation of the phoneme;
track the selected responses provided by the user; and
advance to a subsequent mode when the selected responses provided by the user correspond to a predetermined number of correct answers.

37. The interactive system for learning of claim 35, wherein to assist the user to build one or more buildable words with the one or more specific phonemes, the computer is operative to:
present on the display device a visual representation of at least one letter selected from a set of letters learned by association with one or more phonemes;
generate by the audio device an audible representation associated with at least one word;
select with the input device the visual representation of at least one or more letters that the user believes is associated with the audible representation of the at least one word;
track the selected responses provided by the user; and
advance to a subsequent mode when the selected responses provided by the user correspond to a predetermined number of correct answers.

38. The interactive system for learning of claim 35, wherein to assist the user to rhyme the one or more buildable words, the computer is operative to:
present on the display device a visual representation of at least one word selected from the group of words learned by building one or more buildable words using the one or more specific phonemes;
generate by the audio device an audible representation of a sound that rhymes with the at least one word;
select with the input device at least one word that the user believes is associated with the audible sound that rhymes with the at least one word;
track the selected responses provided by the user; and
advance to a subsequent mode when the selected responses provided by the user correspond to a predetermined number of correct answers.

39. The interactive system for learning of claim 35, wherein to enable the user to identify on sight the one or more buildable words, the computer is operative to:
present on the display device a visual representation of at least one word selected from the group of words learned by rhyming the one or more buildable words;
generate by the audio device an audible representation of the at least one word;
select with the input device at least one word that the user believes associates the visual representation of the at least one word with the audible representation of the at least one word;
track the selected responses provided by the user; and
advance to a subsequent mode when the selected responses provided by the user correspond to a predetermined number of correct answers.

40. The interactive system for learning of claim 35, wherein the computer is operative to present at least one mode in a virtual activity context that is engaging and interactive with the user and enables the user to participate in various engaging activities using the input device and the display device.

41. The interactive system for learning of claim 40, wherein the computer is operative to provide a virtual physical activity to interact with phonemes, letters, or words using the input device, wherein the virtual physical activity includes any one of scaling a climbing wall, running on a treadmill, diving into a swimming pool.

42. The interactive system for learning of claim 34, wherein the computer is operative to enable the user to build a story or a song using only the buildable words associated with the one or more phonemes learned in the at least one level by completion of the associated modes.

43. The interactive system for learning of claim 34, comprising:
a plush appliance coupled to the computer, wherein the computer comprises:
a communication interface for communicating with the plush appliance to enhance the interactive learning when the computer is coupled to the plush appliance;
wherein the plush appliance comprises a chassis resembling an identifiable object in everyday life, a memory for storing information received from the computer, and a medium for communicating with one or more computers to receive information from the computer;
wherein the computer is operative to:
communicate information to the plush appliance;
store the information in the memory of the plush appliance; and
use the information stored in the plush appliance to enhance the interactive learning experience of the user.

44. The interactive system for learning of claim 43, wherein the plush appliance comprises a control switch.

45. The interactive system for learning of claim 44, wherein the computer is operative to initiate an interactive learning session when the control switch is activated.

46. The interactive system for learning of claim 45, wherein the computer is operative to initiate an interactive learning session with the plush appliance, wherein the interactive learning session comprises either one of:
initiating a storytelling session by the plush appliance using the buildable words associated with the one or more phonemes learned in the at least one level by completion of the associated modes words, wherein the interactive learning action is telling the story by the plush appliance to enhance the interactive learning experience of the user; and
initiating a singing session by the plush appliance using the buildable words associated with the one or more phonemes learned in the at least one level by completion of the associated modes, wherein using the words built with the one or more phonemes and the interactive learning action is singing the song by the plush appliance to enhance the interactive learning experience of the user.

47. The interactive system for learning of claim 43, wherein the medium for communicating with one or more computers is a USB port.

48. The interactive system for learning of claim 31, wherein the computer is a server connected to one or more clients over a distributed network, wherein the server is operative to present the structured curriculum to a plurality of users over the clients in the distributed network.

49. The interactive system for learning of claim 31, wherein the computer is operative to assist the user learn the plurality of levels, lessons, or modes in a predetermined sequence.

50. The interactive system for learning claim 31, wherein the computer is operative to receive input commands from the input device to manipulate an avatar that represents the user.

51. The interactive system for learning of claim 36, wherein the computer is operative to provide one or more non-player characters to assist the user in making an appropriate selection.

52. The interactive system for learning of claim 51, wherein the computer is operative to provide the one or more non-player characters in any one of or any combination of a coach, a dog, a peer avatar, a photographer.

53. The interactive system for learning of claim 31, wherein the computer is operative to communicate achievements of the user to a relative of the user.

54. The interactive system for learning of claim 36, wherein the computer is operative to provide hints and clues to assist the user when the user makes a wrong selection in a positive manner.

55. The interactive system for learning of claim 54, wherein computer is operative to provide the hints and clues at any level.

56. The interactive system for learning of claim 54, wherein when the user makes an incorrect selection, the computer is operative to:
present on the display device the incorrectly selected letter, phoneme, or word; and
provide the user another opportunity to make the correct selection using visual clues to remind the user of the appropriate selection by illuminating the appropriate letter, phoneme, or word.

57. The interactive system for learning of claim 56, wherein when the user makes an incorrect selection and additional clues are required, the computer is operative to
generate by the audio device an audible reminder of the incorrect selection and an audible reminder of the correct letter, phoneme, or word that should be selected.

58. The interactive system for learning of claim 57, wherein when the user makes an incorrect selection and additional clues are required, the computer is operative to display a visual message in a message area on the display device of the correct letter, phoneme, or word.

59. The interactive system for learning of claim 58, wherein when the user makes an incorrect selection and additional clues are required, the computer is operative to provide a form of interaction with the correct letter, phoneme, or word.

60. The interactive system for learning of claim 59, wherein the computer is operative to present a video to enable the user to interact with the correct letter, phoneme, or word as a form of interaction.

61. (canceled)
